(19) United States
(12) Patent Application Publication
(10) Pub. No.: US 2026/0350427 A1
(43) Pub. Date: Nov. 5, 2026

(54) SYSTEM AND METHOD FOR CAPTURING AND AUDITING WEB-BASED AI AGENT INTERACTIONS

(71) Applicant: RedBlock Security, Inc., San Ramon, CA (US)

(72) Inventors: Indus KHAITAN, Dublin, CA (US); Rajvardhan KHAITAN, Dublin, CA (US); Basem RIZK, Pleasant Hill, CA (US); Aviral SRIVASTAVA, Bengaluru (IN)

(73) Assignee: RedBlock Security, Inc., San Ramon, CA (US)

(21) Appl. No.: 19/666,232

(22) Filed: May 2, 2026

Related U.S. Application Data
(60) Provisional application No. 63/799,167, filed on May 2, 2025.
(60) Provisional application No. 63/799,176, filed on May 2, 2025.
(60) Provisional application No. 63/799,184, filed on May 2, 2025.
(60) Provisional application No. 63/799,188, filed on May 2, 2025.
(60) Provisional application No. 63/799,193, filed on May 2, 2025.
(60) Provisional application No. 63/799,199, filed on May 2, 2025.
(60) Provisional application No. 63/810,356, filed on May 22, 2025.
(60) Provisional application No. 63/837,276, filed on Jul. 2, 2025.
(60) Provisional application No. 63/872,640, filed on Aug. 29, 2025.
(60) Provisional application No. 63/872,656, filed on Aug. 29, 2025.
(60) Provisional application No. 63/872,665, filed on Aug. 29, 2025.
(60) Provisional application No. 63/878,629, filed on Sep. 9, 2025.
(60) Provisional application No. 63/880,059, filed on Sep. 11, 2025.
(60) Provisional application No. 63/881,837, filed on Sep. 15, 2025.
(60) Provisional application No. 63/887,721, filed on Sep. 25, 2025.

(51) Int. Cl. G06N 5/022; G06F 11/30; G06F 11/34

(52) U.S. Cl. CPC G06N 5/022; G06F 11/3086; G06F 11/3438

(57) ABSTRACT

A system, method, and non-transitory computer-readable medium are disclosed for capturing interaction traces of an artificial intelligence (AI) agent during execution of an automated task on a graphical user interface of a software application. An observational record of interactions performed by the AI agent with the graphical user interface is captured from a rendered graphical output of the graphical user interface. A log of an internal decision-making process of the AI agent corresponding to the interactions is generated concurrently with the capturing and is temporally aligned with the observational record at a segment level. The log includes, for the interactions, a semantic interpretation of a graphical user interface element, a decision criterion applied to select the interaction, and a verification outcome. The observational record and the log are associated with an initiating event that initiated the execution.

### PRIORITY DATA

This application claims the benefit of U.S. Provisional Patent Application No. 63/799,167, filed on May 2, 2025, titled “SYSTEM AND METHOD FOR AGGREGATING API KEYS FROM APPLICATIONS USING ARTIFICIAL INTELLIGENCE” (Atty. Docket No. RDBL1000USP01); U.S. Provisional Patent Application No. 63/799,176, filed on May 2, 2025, titled “SYSTEM AND METHOD FOR UPDATING AND PROPAGATING API KEYS USING ARTIFICIAL INTELLIGENCE” (Atty. Docket No. RDBL1001USP01); U.S. Provisional Patent Application No. 63/799,184, filed on May 2, 2025, titled “SYSTEM FOR REPORTING AND ACTIONING OF USER ROLES IN IDENTITY GOVERNANCE CONTEXT USING ARTIFICIAL INTELLIGENCE” (Atty. Docket No. RDBL1002USP01); U.S. Provisional Patent Application No. 63/799,188, filed on May 2, 2025, titled “SYSTEM FOR DETECTION AND REMEDIATION OF SECURITY CONFIGURATION DRIFTS IN WEB APPLICATIONS USING INTERFACE-CENTRIC AI AGENTS” (Atty. Docket No. RDBL1003USP01); U.S. Provisional Patent Application No. 63/799,193, filed on May 2, 2025, titled “SYSTEM AND METHOD FOR CAPTURING AND AUDITING WEB-BASED AI AGENT INTERACTIONS” (Atty. Docket No. RDBL1004USP01); U.S. Provisional Patent Application No. 63/799,199, filed on May 2, 2025, titled “SYSTEM AND METHOD FOR AUTOMATED CREDENTIAL GENERATION AND PROPAGATION BASED ON ARTIFICIAL INTELLIGENCE AGENTS” (Atty. Docket No. RDBL1005USP01); U.S. Provisional Patent Application No. 63/810,356, filed on May 22, 2025, titled “System and Method for Deterministic Validation of Automation Workflows Guided by Large Language Models” (Atty. Docket No. RDBL1006USP01); U.S. Provisional Patent Application No. 63/837,276, filed on Jul. 2, 2025, titled “SYSTEM AND METHOD FOR AUTOMATED EXPLORATION OF APPLICATION SOFTWARE” (Atty. Docket No. RDBL1007USP01); U.S. Provisional Patent Application No. 63/880,059, filed on Sep. 11, 2025, titled “SYSTEM AND METHOD FOR AUTOMATED EXPLORATION OF APPLICATION SOFTWARE” (Atty. Docket No. RDBL1007USP02); U.S. Provisional Patent Application No. 63/872,640, filed on Aug. 29, 2025, titled “SYSTEM AND METHOD FOR INTEGRATING NON-API APPLICATIONS WITH IDENTITY PLATFORMS BASED ON ARTIFICIAL INTELLIGENCE” (Atty. Docket No. RDBL1008USP01); U.S. Provisional Patent Application No. 63/878,629, filed on Sep. 9, 2025, titled “SYSTEM AND METHOD FOR INTEGRATING NON-API APPLICATIONS WITH IDENTITY PLATFORMS BASED ON ARTIFICIAL INTELLIGENCE” (Atty. Docket No. RDBL1008USP02); U.S. Provisional Patent Application No. 63/887,721, filed on Sep. 25, 2025, titled “HIERARCHICAL STRUCTURING OF GRAPHICAL USER INTERFACE ELEMENTS IN APPLICATION SOFTWARE PAGES” (Atty. Docket No. RDBL1009USP01); U.S. Provisional Patent Application No. 63/872,656, filed on Aug. 29, 2025, titled “SYSTEM AND METHOD FOR IDENTITY-CENTRIC ACTIVITY LOG CAPTURE FROM APPLICATIONS LACKING PROGRAMMATIC INTERFACES” (Atty. Docket No. RDBL1010USP01); U.S. Provisional Patent Application No. 63/872,665, filed on Aug. 29, 2025, titled “AGENTIC ARTIFICIAL INTELLIGENCE FOR AUTOMATED CONNECTOR CONFIGURATION AND APPLICATION ONBOARDING IN IDENTITY PLATFORMS” (Atty. Docket No. RDBL1011USP01); and U.S. Provisional Patent Application No. 63/881,837, filed on Sep. 15, 2025, titled “TASK-SPECIFIC HIGH-LEVEL LANGUAGE FRAMEWORK FOR STRUCTURED INTERACTION WITH LARGE LANGUAGE MODELS” (Atty. Docket No. RDBL1012USP01). All of the foregoing provisional applications are hereby incorporated by reference for all purposes.

### TECHNICAL FIELD

The technology disclosed relates to artificial intelligence type computers and digital data processing systems and corresponding data processing methods and products for emulation of intelligence (i.e., knowledge based systems, reasoning systems, and knowledge acquisition systems); and including systems for reasoning with uncertainty (e.g., fuzzy logic systems), adaptive systems, machine learning systems, and artificial neural networks. Specifically, the technology relates to artificial intelligence agent observability and audit systems and, more particularly, to a system and method for capturing, auditing, and analyzing web-based interactions performed by an artificial intelligence agent using video-based observability and synchronized semantic reasoning logs.

### BACKGROUND OF THE INVENTION

Modern enterprises operate across hundreds of software applications spanning cloud-native platforms, legacy on-premises systems, and disconnected enterprise tools, and have begun to deploy autonomous agents powered by artificial intelligence within these software ecosystems for the purposes of configuration management, workflow execution, and system integration. An artificial intelligence agent functions by perceiving graphical user interface elements rendered on screen by a web-based application, by interpreting the semantic meaning of those interface elements through computer vision and language model reasoning, and by executing simulated user actions on the rendered interface to navigate and manipulate application states. The scope of such automation extends to tasks including updating security settings, rotating access credentials, modifying user roles, and initiating business transactions, each performed by the artificial intelligence agent interacting directly with a graphical user interface rather than through a programmatic interface.

Conventional audit logging frameworks for enterprise software capture structured metadata associated with programmatic actions, including a timestamp, a function name, an application programming interface endpoint, input parameters, and a response status, and presume a deterministic control path mediated by structured access protocols. The artificial intelligence agent operating on a graphical user interface does not interact with the web-based application through such programmatic interfaces, and conventional log files therefore do not reflect the visual observations made by the artificial intelligence agent or the internal decision-making rationale that produced each executed action. The coverage gap is consequential under regulatory frameworks such as the Sarbanes-Oxley Act (SOX), the Health Insurance Portability and Accountability Act (HIPAA), and the General Data Protection Regulation (GDPR), each of which requires demonstrable proof of automated actions taken on regulated data and systems. Accordingly, a need exists for a logging and observability framework suited to the operational profile of an artificial intelligence agent that perceives and acts on a graphical user interface.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a system architecture for implementing an agentic artificial intelligence (AI) platform for enterprise credential automation, according to certain embodiments.

FIG. 1B illustrates an exemplary system architecture of the AI agent system deployed within a network environment including multiple enterprise users and application interfaces, according to certain embodiments.

FIG. 1C illustrates an alternate embodiment of the system architecture showing decentralized deployment of the AI agent system across diverse enterprise infrastructure, according to certain embodiments.

FIG. 2A is an architectural diagram illustrating the evolution of enterprise infrastructure models from network-centric to application- and data-centric paradigms, according to certain embodiments.

FIG. 2B is a block diagram of an AI agent-based identity and credential automation system for enterprise environments, according to certain embodiments.

FIG. 2C is an architectural diagram illustrating the integration of AI-based identity governance across connected and disconnected applications within a hybrid enterprise infrastructure, according to certain embodiments.

FIG. 2D illustrates an exemplary connectivity framework between enterprise users, identity control systems, and a plurality of applications integrated with an AI agent system, according to certain embodiments.

FIG. 2E is a system workflow diagram showing an AI-driven remediation process initiated by contextual security signals and executed across enterprise applications, according to certain embodiments.

FIG. 2F is a conceptual diagram depicting AI agent behavioral learning for autonomous execution of identity lifecycle tasks in enterprise applications, according to certain embodiments.

FIG. 3A illustrates an exemplary internal architecture of an agentic AI platform including a perception module, a planning module, an execution module, and supporting identity governance modules deployed within an enterprise network infrastructure, according to certain embodiments.

FIG. 3B illustrates a system architecture of a graphical user interface (GUI)-based agentic AI credential automation system configured to interface with producer applications, consumer applications, and a credential vault via GUI-based interactions, according to certain embodiments.

FIG. 4 illustrates a system for capturing interaction traces of an artificial intelligence (AI) agent during execution of an automated task on a graphical user interface of a software application, according to certain embodiments.

FIG. 5 illustrates a flowchart depicting a method for capturing interaction traces of an artificial intelligence (AI) agent during execution of an automated task on a graphical user interface of a software application, according to certain embodiments.

FIG. 6 is a schematic representation of a temporal pairing architecture depicting segment-level alignment between an observational record and a log of an AI agent's internal decision-making process during execution of an automated task, according to certain embodiments.

FIG. 7 illustrates a vision-language reasoning architecture of the AI agent comprising a visual perception module, a semantic interpretation module, and an action selection module, according to certain embodiments.

FIG. 8 illustrates a semantic interpretation record structure generated by the semantic interpretation module for a detected user interface element, according to certain embodiments.

FIG. 9 illustrates a verification step architecture depicting comparison of a predicted post-action interface state against an actual post-action interface state following an action executed by the AI agent, according to certain embodiments.

FIG. 10 illustrates an initiating event architecture depicting three types of initiating events that cause the AI agent to begin execution of an automated task on a graphical user interface of a target software application, according to certain embodiments.

FIG. 11 illustrates a session record schema depicting a structure of a session record generated by an association module and a relationship between the session record and stored artifacts in a storage layer, according to certain embodiments.

FIG. 12 illustrates a tamper-resistant logging repository architecture depicting integrity verification, cryptographic hash generation, and immutable storage of session records, according to certain embodiments.

FIG. 13 illustrates a training feedback architecture depicting a closed-loop model improvement cycle using the observational record and the log as labeled training samples for supervised fine-tuning of a machine learning model of the AI agent, according to certain embodiments.

FIG. 14 illustrates an audit retrieval and compliance verification architecture depicting generation of a composite audit artifact with bidirectional navigation between the observational record and the log for an authorized entity, according to certain embodiments.

FIG. 15 illustrates a dynamic GUI resilience architecture depicting continuous capture of the observational record across changes in the graphical user interface occurring during execution of the automated task, according to certain embodiments.

FIG. 16 illustrates a data source architecture depicting capture of the observational record from a rendered graphical output of the graphical user interface independent of an application programming interface of the software application, according to certain embodiments.

FIG. 17 illustrates a log content structure depicting four content sections recorded by the reasoning capture module for a single interaction performed by the AI agent during execution of the automated task, according to certain embodiments.

FIG. 18 illustrates a multi-application execution architecture depicting capture and association of observational records and logs across a plurality of sequential agent sessions initiated by a single initiating event, according to certain embodiments.

FIG. 19 is a schematic representation of an encoder-decoder architecture.

FIG. 20 shows an overview of an attention mechanism added onto an RNN encoder-decoder architecture.

FIG. 21 is a schematic representation of the calculation of self-attention showing one attention head.

FIG. 22 is a depiction of several attention heads in a Transformer block.

FIG. 23 is an illustration that shows how one can use multiple workers to compute the multi-head attention in parallel, as the respective heads compute their outputs independently of one another.

FIG. 24 is a portrayal of one encoder layer of a Transformer network.

FIG. 25 shows a schematic overview of a Transformer model.

FIG. 26 is a depiction of a Vision Transformer (ViT).

FIG. 27 illustrates a processing flow of the Vision Transformer (ViT).

FIG. 28 shows example software code that implements a Transformer block.

FIG. 29 illustrates an example configuration of a computing device that can be used to implement the systems and techniques described herein.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

### Overview

The implementations described herein introduce systems and methods for capturing interaction traces of an artificial intelligence (AI) agent during execution of an automated task on a graphical user interface (GUI) of a software application. In some implementations, the system captures, from a rendered graphical output of the GUI, an observational record of interactions performed by the AI agent with the GUI during the execution. Concurrently with the capturing of the observational record, the system generates a log of the AI agent's internal decision-making process corresponding to the interactions. The capturing and the generating are temporally aligned such that each segment of the observational record corresponds to a segment of the log produced during the same portion of the execution. The system associates both the observational record and the log with an initiating event that caused the AI agent to begin the execution. The system stores the resulting session record in a tamper-resistant logging repository as an immutable record. An integrity verification module generates, for each segment pair comprising a segment of the observational record and a corresponding segment of the log, a cryptographic hash value computed over combined contents of the segment pair. The system further generates a composite audit artifact in which entries of the log structurally index segments of the observational record, enabling bidirectional navigation between recorded visual states and recorded reasoning entries.

### Indicia of Novelty, Inventiveness, Non-Obviousness, and Subject-Matter Eligibility

The following description identifies technical effects and concrete improvements to computer functionality produced by the technology disclosed. The technology disclosed is rooted in specific technical mechanisms that operate on defined data structures, execute through processor instructions, and produce tangible improvements to the system for capturing and auditing artificial intelligence agent interactions during web-based automation tasks and to the functioning of the underlying computing system. The technical mechanisms operate on the rendered pixel output of a web-based application, on a structured log of internal decisions of an artificial intelligence agent, and on a task trigger that initiated the automation, and produce a tamper-resistant session record that did not exist in conventional logging systems and that cannot be produced by mental activity, by manual observation of the artificial intelligence agent, or by automation of acts otherwise performed by a human.

### Concrete Improvement to a Technological Process

The system is directed to a concrete technological process. The web interaction recording engine receives the rendered pixel output of one or more web-based applications and captures, in real time, a visual representation of user interface interactions performed by the artificial intelligence agent within the web-based applications, the captured interactions comprising mouse clicks, navigation transitions, input field entries, element selections, and cursor movements. The reasoning trace generator, communicatively coupled to the web interaction recording engine, records, concurrently with and synchronized to the visual representation capture, a structured log of the internal decisions made by the artificial intelligence agent during the task execution, the structured log comprising semantic interpretations of interface elements, decision sequences, verification steps, and fallback actions produced by the artificial intelligence agent. The signal association module receives the visual representation from the web interaction recording engine and the structured log from the reasoning trace generator and associates both the visual representation and the structured log with a task trigger that initiated the automation, the task trigger comprising a security signal, a policy-based instruction, or an application-level automation event. The tamper-resistant logging repository receives the visual representation, the structured log, and the task trigger association from the signal association module and stores the received artifacts as an immutable session record together with metadata comprising a task identifier, a timestamp, a target application identifier, an action summary, and an audit status. The training feedback interface reads classified session records from the tamper-resistant logging repository and provides labeled visual representations and structured logs to a model training pipeline for supervised fine-tuning of the underlying machine learning model of the artificial intelligence agent. The audit retrieval interface receives a request from an authorized requesting entity and retrieves, from the tamper-resistant logging repository, the visual representation and the structured log associated with the requested session for transparency review, regulatory audit, or model improvement. The technology disclosed therefore improves a concrete technological process by replacing the structured-metadata logging approach of conventional observability tools, which is unable to capture the visual observations or internal reasoning of an artificial intelligence agent operating on a graphical user interface, with an integrated real-time visual capture, synchronized internal decision logging, dedicated trigger association, tamper-resistant immutable storage, supervised training feedback, and authorized audit retrieval system that performs specific computational operations on defined data structures.

Real-Time Visual Capture of Artificial Intelligence Agent Interface Activity without Programmatic Instrumentation

Existing observability tools for enterprise software capture structured metadata associated with programmatic actions, including a timestamp, a function name, an application programming interface endpoint, input parameters, and a response status, and presume a deterministic control path mediated by application programming interfaces, document object model access, accessibility application programming interfaces, or operating system level hooks. An artificial intelligence agent operating on a graphical user interface does not interact with the web-based application through such programmatic interfaces and instead perceives visual stimuli rendered on screen and executes simulated user actions on the rendered interface. The structured metadata captured by existing observability tools therefore does not reflect the visual observations made by the artificial intelligence agent, the interface elements perceived by the artificial intelligence agent, or the temporal sequence of actions executed by the artificial intelligence agent on the rendered interface, and existing observability tools are inoperative against legacy, disconnected, or third-party web-based applications that do not expose programmatic instrumentation.

The technology disclosed captures, through the web interaction recording engine, a visual representation of user interface interactions performed by the artificial intelligence agent within the web-based applications in real time and without reliance on application programming interfaces, document object model access, structured input-output payloads, or backend telemetry hooks of the web-based applications. The web interaction recording engine derives the visual representation from the rendered pixel output of the web-based applications and encodes the rendered pixel output as a continuous time-stamped video recording that preserves the chronological sequence of interface states, cursor positions, element selections, and navigation transitions performed by the artificial intelligence agent from the initiation to the completion of the automated task. The web interaction recording engine maintains uninterrupted capture when the graphical user interface of the web-based applications undergoes changes during the task execution, including repositioned user interface controls, updated visual styling, renamed element labels, dynamically loaded interface sections, or rendering updates caused by application state transitions, without requiring reconfiguration or retraining. This mechanism eliminates the dependence on programmatic instrumentation that constrains existing observability tools and produces a visual representation of artificial intelligence agent interface activity that is captured exclusively from the graphical output rendered on screen, that is captured during live task execution rather than reconstructed after the fact, and that is operable across web-based applications exposing only a graphical user interface.

Synchronized Capture of an Internal Decision Log Concurrent with Visual Representation Capture

Existing approaches to recording the behavior of an autonomous artificial intelligence agent treat the visual record and the decision record as separable artifacts produced by separate processing stages. Action evaluation frameworks for autonomous artificial intelligence agents compare a proposed action set against an expected action set in advance of execution and produce no live record of the actions actually performed during execution. Conversational artificial intelligence testing systems record agent responses to simulated inputs and analyze the recorded responses for coherency in a separate post-hoc step, and such systems do not capture the visual interface state observed by the agent or the perceptual reasoning applied to that interface state. Robotic process automation feedback loggers monitor task-level performance outcomes and re-ingest interaction outcomes into the model training pipeline, but capture neither the per-step internal decision sequence nor the visual interface state on which each decision was based. The result is that the visual record and the decision record, when produced at all by existing approaches, are produced by separate processing stages, are not aligned on a common timeline, and cannot be jointly interpreted to verify that an action executed at a particular moment followed from a particular reasoning step at the same moment.

The technology disclosed records, through the reasoning trace generator, a structured log of the internal decisions made by the artificial intelligence agent during the task execution concurrently with and synchronized to the capture of the visual representation by the web interaction recording engine. The reasoning trace generator receives, for each interface state observed by the artificial intelligence agent during the task execution, an output of a vision-language reasoning architecture employed by the artificial intelligence agent, the vision-language reasoning architecture comprising a visual perception module configured to detect and classify user interface elements rendered on the web-based applications using computer vision, a semantic interpretation module configured to generate textual interpretations of the detected user interface elements and their associated labels and content using a language model, and an action selection module configured to determine and record the sequence of actions to be executed based on the outputs of the visual perception module and the semantic interpretation module. For each user interface element observed during the task execution, the reasoning trace generator records a primary natural language description of the element's identity and function, a classification confidence level, at least one alternative interpretation considered by the language model, the criteria by which the primary interpretation was selected over the alternative interpretations, the available actions considered by the artificial intelligence agent at the corresponding interface state, the action selected by the artificial intelligence agent and the evaluative criteria applied in the selection, the predicted post-action interface state, the actual post-action interface state detected by the visual perception module after the action was executed, and any fallback action invoked by the artificial intelligence agent when the actual post-action interface state did not correspond to the predicted post-action interface state. The structured log produced by the reasoning trace generator carries, for each entry, a timestamp aligned to the chronological sequence of the visual representation produced by the web interaction recording engine. This mechanism eliminates the separation between the visual record and the decision record that characterizes existing approaches and produces a substrate in which the visual representation and the structured log advance together on a shared timeline, such that an action depicted at a particular moment of the visual representation is jointly interpretable with the corresponding internal decision recorded at the same moment of the structured log.

### Three-Way Causal Association of Visual Representation, Structured Log, and Task Trigger

Existing approaches associate a recorded artifact with the operational signal that initiated recording in a manner specific to a single artifact type. A compliance audit recording system associates a screen recording with a work request that initiated monitoring, but the artifact set is limited to the screen recording and no internal decision log is associated with the work request. An authorization log generator produces an audit log entry for an authorization request, but no visual record of the actions taken in response to the request is associated with the audit log entry. A task-level outcome logger associates a task-level performance result with the input that triggered the task, but no per-step internal decision sequence and no visual record of the interface activity are associated with the input. Existing approaches therefore lack a mechanism that binds a visual record of artificial intelligence agent activity, an internal decision log of the same artificial intelligence agent activity, and the task trigger that initiated the activity into a single structured association from which any of the three can be retrieved through any of the others.

The technology disclosed associates, through the signal association module, both the visual representation produced by the web interaction recording engine and the structured log produced by the reasoning trace generator with the task trigger that initiated the automation. The signal association module generates, for each task execution by the artificial intelligence agent, a session record comprising a task identifier uniquely identifying the task execution, an originating system identifier specifying the enterprise system or platform that generated the task trigger, a trigger classification identifying the type of task trigger, a session initiation timestamp, a session completion timestamp, and a storage reference linking the task identifier to both the stored visual representation and the stored structured log. The task trigger comprises a security signal generated by an enterprise security monitoring system upon detection of a non-compliant configuration state in the web-based applications, a policy-based instruction generated by an enterprise governance or compliance platform specifying a corrective action to be performed by the artificial intelligence agent within the web-based applications, or an application-level automation event specifying a workflow step or configuration change to be executed by the artificial intelligence agent within the web-based applications. The session record is delivered to the tamper-resistant logging repository and is retrievable by querying the task identifier alone, with the result that the visual representation, the structured log, and the originating task trigger are jointly retrievable through a single identifier. This mechanism produces a three-way causal record that ties the operational signal initiating the automation to both the visual record of the actions performed in response and the internal decision log explaining why those actions were performed, eliminating the single-artifact-per-trigger constraint of existing approaches and supporting joint forward and backward traversal across the trigger, the visual record, and the decision record.

Tamper-Resistant Immutable Session Record with Structured Metadata Schema

Existing observability tools store recorded artifacts in mutable repositories accessible through ordinary file system operations, and existing audit logging tools store metadata records in tabular databases without an architecturally enforced immutability guarantee. The recorded artifacts and metadata records produced by existing tools are subject to modification or deletion after the fact, with the result that an authorized requesting entity reviewing a recorded session has no architectural assurance that the visual record retrieved at audit time is the visual record produced at execution time, and no architectural assurance that the metadata record describing a recorded session is the metadata record generated at the time the recording was made. Existing approaches therefore do not produce a session record suitable for evidentiary use under regulatory frameworks that require demonstrable, reproducible, and verifiable records of automated actions taken on regulated data and systems.

The technology disclosed stores, through the tamper-resistant logging repository, the visual representation, the structured log, and the task trigger association produced by the signal association module as an immutable session record. The tamper-resistant logging repository maintains the immutable session record together with structured metadata comprising the task identifier uniquely associating the stored visual representation and structured log with the task execution, a timestamp identifying the initiation time and the completion time of the task execution, a target application identifier specifying the web-based application in which the artificial intelligence agent performed the task, an action summary identifying the actions performed by the artificial intelligence agent during the task execution, and an audit status indicating whether the task execution was completed, partially completed, or failed. The audit retrieval interface receives a request from an authorized requesting entity for a recorded session and retrieves, from the tamper-resistant logging repository, the visual representation and the structured log of the requested session, and presents the retrieved visual representation and the retrieved structured log in a synchronized replay format in which textual annotations derived from the structured log are displayed in temporal alignment with the corresponding interface states in the visual representation. This mechanism produces a session record whose integrity is architecturally enforced from the moment of capture through the moment of retrieval, eliminating the post-hoc modification exposure of existing observability and audit logging tools and producing a session record suitable for evidentiary use under regulatory frameworks including the Sarbanes-Oxley Act (SOX), the Health Insurance Portability and Accountability Act (HIPAA), and the General Data Protection Regulation (GDPR).

Closed-Loop Training Feedback from Captured Visual Representation and Structured Log

Existing training data pipelines for artificial intelligence agents draw on synthetic data sets, on demonstrations recorded from a human operator, or on outcome-level performance data that records whether a task was completed but does not record the per-step internal reasoning that produced the outcome. A training data set drawn from synthetic sources does not reflect the operational conditions encountered by the artificial intelligence agent in production. A training data set drawn from human demonstrations does not reflect the perceptual and reasoning behavior of the artificial intelligence agent itself. A training data set drawn from outcome-level performance data does not localize an error to the specific reasoning step at which the artificial intelligence agent's interpretation of a particular user interface element diverged from a correct interpretation. Existing pipelines therefore cannot use the operational behavior of a deployed artificial intelligence agent to produce labeled training samples that target the specific reasoning step at which an error occurred.

The technology disclosed provides, through the training feedback interface, the visual representation captured by the web interaction recording engine and the structured log captured by the reasoning trace generator as labeled training samples to a model training pipeline for supervised fine-tuning of the underlying machine learning model of the artificial intelligence agent. The training feedback interface classifies each captured session as a successful execution or a failed execution based on whether the artificial intelligence agent achieved the intended outcome of the automated task as determined from the visual representation and the structured log. For each session classified as a failed execution, the training feedback interface analyzes the structured log to identify the specific reasoning step at which the artificial intelligence agent's interpretation of a user interface element diverged from a correct interpretation and generates a targeted training annotation specifying the incorrectly interpreted user interface element, the artificial intelligence agent's incorrect semantic interpretation of that element, the correct semantic interpretation of the element, and a corrective training signal for fine-tuning the underlying machine learning model. The fine-tuned underlying machine learning model is deployed for subsequent task executions, and the web interaction recording engine and the reasoning trace generator capture visual representations and structured logs of the subsequent task executions, with the result that each generation of task executions generates training data that iteratively improves the artificial intelligence agent's performance on future task executions. This mechanism produces a closed-loop training architecture in which the operational behavior of the deployed artificial intelligence agent itself supplies labeled training data that targets the specific reasoning step at which an error occurred, eliminating the disconnection between operational deployment and model improvement that characterizes existing training data pipelines.

### System Architecture

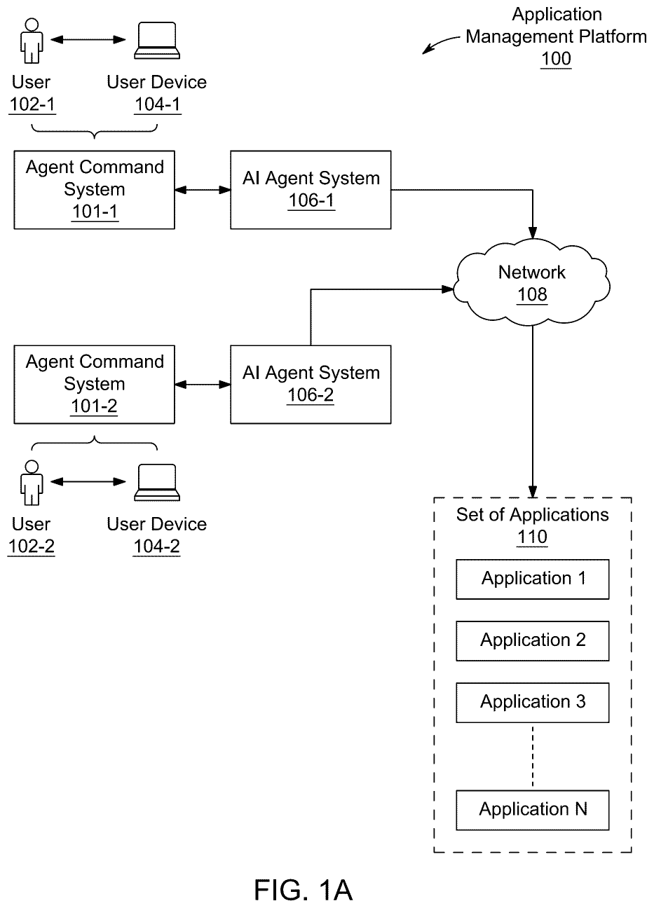

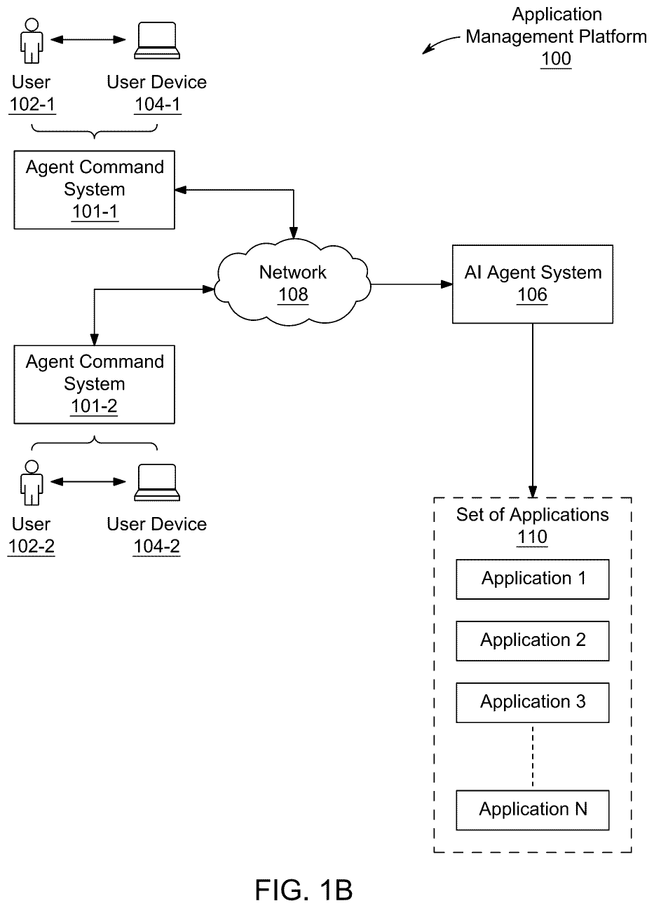

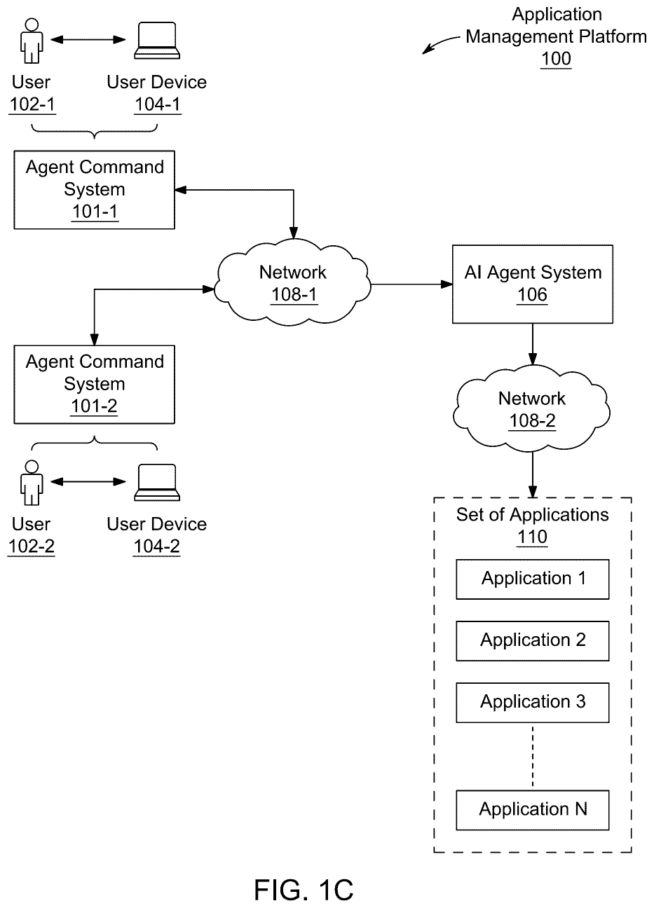

FIG. 1A illustrates an exemplary network diagram depicting an overall system architecture for deploying the application management platform 100, according to various embodiments. FIG. 1A depicts interaction among a plurality of enterprise users, a plurality of user devices, a plurality of agent command systems, a plurality of AI agent systems, and a set of applications over a communication network.

The application management platform 100 includes a plurality of users 102-1 and 102-2, each operating a respective user device 104-1 and 104-2. The user devices 104-1 and 104-2, collectively referred to as user devices 104, may be any computing devices capable of initiating or supporting interaction with components of the application management platform 100. The user devices 104 may include desktop computers, laptops, tablets, smartphones, or other network-enabled terminals. The user devices 104-1 and 104-2 are communicatively linked to other components of the application management platform 100 via a network 108. The network 108 may include any combination of communication technologies, including wired connections, wireless protocols, cellular networks, local area networks (LANs), wide area networks (WANs), metropolitan area networks (MANs), the Internet, or any suitable data transmission medium.

The agent command systems 101-1 and 101-2, collectively referred to as agent command systems 101 and as illustrated in FIG. 1A, refer to command-initiating modules that trigger task execution requests within the AI agent systems 106. The agent command systems 101 operate as entry points into an AI agent execution layer and may originate from a variety of operational contexts within the enterprise environment. Functionally, each agent command system 101 is configured to broker identity and access management instructions, including credential creation, access revocation, entitlement modification, or credential verification, by transmitting structured or unstructured commands to a corresponding AI agent system 106.

In one exemplary embodiment, an agent command system 101 may be realized as an enterprise human resources platform, such as Workday or SuccessFactors, which automatically triggers a new-user provisioning task upon successful onboarding of an employee. Alternatively, an agent command system 101 may be a cloud identity orchestration platform or identity governance solution, such as Okta Workflows or SailPoint, which detects a status change and delegates an appropriate downstream action to an agentic automation layer.

In another scenario, an agent command system 101 may comprise an enterprise-grade ticketing or service desk tool, such as ServiceNow or Jira, where an administrator raises a request for access removal or a credential reset. Once the ticket receives approval, the agent command system 101 generates a task trigger, which an AI agent system 106 receives for execution across relevant applications.

Additionally, an agent command system 101 may be embodied as a Python script or a lightweight command-line utility maintained by enterprise information technology teams. The agent command system 101 may invoke credential management tasks based on custom logic, policy thresholds, or compliance audit findings. For example, a script may be scheduled to review stale accounts, or trigger revocation flows for temporary users whose access is due to expire.

The scope of the agent command systems 101 also extends to externally hosted platforms. For example, a partner organization operating an integration gateway may initiate access modification workflows through representational state transfer (RESTful) callbacks or secure webhooks when a role matrix of a joint project is updated. Similarly, identity-centric middleware, such as Active Directory Federation Services (AD FS) or Azure Conditional Access policies, may initiate dynamic policy enforcement actions through integration with the application management platform 100.

Furthermore, websites that serve as operational hubs for user provisioning, including custom-built contractor registration portals or partner self-service applications, may function as instances of the agent command systems 101. These web portals collect user metadata, roles, and authorization preferences and transmit the metadata, the roles, and the authorization preferences as task directives to the agentic execution layer for automated credential provisioning.

The AI agent systems 106-1 and 106-2, collectively referred to as AI agent systems 106, serve as intermediary execution and orchestration layers between the agent command systems 101 and the set of applications 110. In the embodiment of FIG. 1A, the plurality of AI agent systems 106 may be deployed to manage tasks across various application domains, organizational units, or enterprise environments. Each AI agent system 106 receives task instructions or event triggers from a corresponding agent command system 101 and performs operations with respect to one or more applications in the set of applications 110.

A set of applications 110 is denoted as application 1, application 2, application 3, and continuing through application N. The applications within the set of applications 110 represent tools, platforms, and services utilized by enterprises in operational workflows. Illustrative examples include customer relationship management platforms such as Salesforce, regulatory filing portals such as Securities and Exchange Commission (SEC) submission websites, internal field service management systems, and partner-managed applications hosted on third-party infrastructure. Within the set of applications 110, some applications may be sanctioned enterprise applications that have been vetted and formally approved for use within the enterprise environment. However, not all sanctioned applications are programmatically integrated with enterprise identity systems. For example, Salesforce may be both sanctioned and programmatically connected through secure application programming interfaces (APIs), whereas other sanctioned tools, including a field service application hosted in a partner cloud, may lack programmatic integrations entirely and may be accessible through graphical user interfaces.

In cases of applications lacking programmatic integration, an AI agent system 106 is positioned to bridge the integration gap by executing graphical user interface (GUI)-based workflows. The AI agent system 106 functions across both API-enabled and GUI-only applications without requiring custom connectors for every application, thereby supporting a wide spectrum of use cases. The applications denoted by reference numeral 110, including application 1 through application N, represent the diversity in application connectivity and accessibility.

The application management platform 100 provides an operational control plane for deployment, configuration, and update management of the AI agent systems 106 across the enterprise environment. The application management platform 100 may further serve as an interface through which deployment packages, including deployment application template (DAT) files containing task templates and user interface locators, are delivered and version controlled. Version-controlled deployment ensures that application-specific logic can be updated without requiring modification to enterprise systems or target applications.

Operationally, when a task is initiated, including onboarding a new employee or revoking access for a departing contractor, the AI agent system 106 identifies relevant applications, determines whether the relevant applications are sanctioned or unsanctioned, and further determines whether programmatic access is available. Where APIs exist, the AI agent system 106 may utilize the APIs. Where no APIs are exposed, the AI agent system 106 performs interface-based automation by identifying credential fields, invoking generation elements, interacting with application controls, and confirming task completion through visual confirmation or response logging.

FIG. 1B illustrates an exemplary architecture of the AI agent system 106 deployed in a network environment. As depicted in FIG. 1B, a plurality of users 102-1 through 102-N operate respective user devices 104-1 through 104-N, the user devices being communicatively connected to the AI agent system 106 via the network 108. In the embodiment of FIG. 1B, a single AI agent system 106 serves the plurality of users 102-1 through 102-N and coordinates task execution across the set of applications 110.

The users 102 represent individuals or entities that require interaction with the AI agent system 106 for accessing enterprise functionalities or initiating enterprise workflows. The users 102 may include enterprise employees, external customers, partners, vendors, and contractors. Within an enterprise, the users 102 may take the form of managers, analysts, administrative staff, or compliance officers. For example, a marketing manager may request insights into sales performance metrics, while a data analyst may query historical usage patterns to train predictive models. Each interaction is facilitated through the user devices 104, which may include desktop computers, laptops, mobile phones, or tablets configured to transmit queries or task instructions to the AI agent system 106.

The AI agent system 106 functions as an intelligent middleware layer, interfacing with user instructions or task directives and performing corresponding task executions within the enterprise infrastructure. Upon receiving requests from the user devices 104-1 through 104-N or task directives from the agent command systems 101, the AI agent system 106 interprets an objective of the request or directive, references one or more semantic models, and orchestrates an execution strategy. The execution may involve data extraction from enterprise databases, task automation across enterprise applications, generation of alerts and recommendations, or credential and entitlement management operations.

An underlying semantic model employed by the AI agent system 106 maps concepts, relationships, and terminologies specific to the enterprise and an operational domain of the enterprise. The semantic model may incorporate language-specific and language-independent elements and may maintain a knowledge graph that encapsulates industry-specific vocabularies, inter-entity relationships, and organizational hierarchies. The semantic model allows the AI agent system 106 to provide meaningful and contextually accurate responses, even when user inputs are ambiguous, multilingual, or incomplete. For example, the AI agent system 106 may infer that a query about “partner logins” likely pertains to privileged account access in partner-facing systems and may respond accordingly.

The AI agent system 106 is capable of initiating omni-channel communication, providing task updates, delivering alerts, recommending actions, and handling real-time queries via chat, voice, or system notification interfaces. The AI agent system 106 may also proactively interact with the users 102 to suggest workflow improvements or to flag policy violations. For example, if a departing employee retains access to sensitive systems, the AI agent system 106 may initiate a revocation task and notify a security team.

The architecture is adaptable to various industry verticals including manufacturing, financial services, healthcare, oil and gas, and telecommunications. The AI agent system 106 is designed to accommodate industry-specific models, allowing the AI agent system 106 to process domain-relevant queries and execute tasks with high specificity and compliance.

The network 108 facilitates data transfer between the user devices 104-1 through 104-N and the AI agent system 106. In some embodiments, multiple interconnected networks 108 may be present between the user devices 104-1 through 104-N and the AI agent system 106. The network 108 may be a private network, a public network, or a hybrid network. The network 108 may be a local area network (LAN) or a wide area network (WAN).

The network 108 may be connected via wired or wireless links. Wired links may include digital subscriber line (DSL), coaxial cable lines, Ethernet, fiber optic links, or other links used for network infrastructure. Wireless links may include cellular, BLUETOOTH, Wi-Fi, Worldwide Interoperability for Microwave Access (WiMAX), infrared channels, satellite bands, or other wireless networking technologies. Wireless links may also include any cellular network standards used to communicate among mobile devices, including standards that qualify as 1G, 2G, 3G, 4G, 5G, or Long Term Evolution (LTE). Network standards may qualify as one or more generations of mobile telecommunication standards by fulfilling a specification or standards including specifications maintained by the International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include Advanced Mobile Phone System (AMPS), Global System for Mobile Communications (GSM), General Packet Radio Service (GPRS), Universal Mobile Telecommunications System (UMTS), High Speed Packet Access (HSPA), LTE, LTE Advanced, Mobile WiMAX, and WiMAX Advanced. Cellular network standards may use various channel access methods, including frequency division multiple access (FDMA), time division multiple access (TDMA), code division multiple access (CDMA), or space division multiple access (SDMA). In some embodiments, different types of data may be transmitted via different links and standards. In other embodiments, the same types of data may be transmitted via different links and standards.

The network 108 may be any type and form of network. The geographical scope of the network 108 may vary widely. The network 108 can be a body area network (BAN), a personal area network (PAN), a LAN including an Intranet, a metropolitan area network (MAN), or a WAN including the Internet. The topology of the network 108 may be of any form and may include point-to-point, serial, bus, star, ring, mesh, or tree topologies. The network 108 may be an overlay network that is virtual and sits on top of one or more layers of other networks. The network 108 may be of any network topology capable of supporting the operations described herein. The network 108 may utilize different techniques and layers or stacks of protocols, including the Ethernet protocol, the Internet protocol suite including Transmission Control Protocol over Internet Protocol (TCP/IP) and User Datagram Protocol over Internet Protocol (UDP/IP), the Asynchronous Transfer Mode (ATM) technique, the Synchronous Optical Networking (SONET) protocol, or the Synchronous Digital Hierarchy (SDH) protocol. The TCP/IP Internet protocol suite may include an application layer, a transport layer, an Internet layer including IPv6, or a link layer. The network 108 may be a type of broadcast network, telecommunications network, data communication network, or computer network.

In some implementations, one or more of the users 102-1 through 102-N may access the AI agent system 106 using one or more of the user devices 104-1 through 104-N. The AI agent system 106 may include one or more user interfaces, including browsers and textual or graphical user interfaces, through which the users 102-1 through 102-N may access the AI agent system 106.

The user devices 104-1 through 104-N and the AI agent system 106 may exist on a shared or segmented network. In some embodiments, the users 102 may access the AI agent system 106 remotely via virtual private networks (VPNs) or federated identity mechanisms, while in other embodiments, the users 102 may be co-located within an enterprise premise. The AI agent system 106 may access one or more databases communicatively coupled to the user devices 104-1 through 104-N through the network 108.

The database may be persistent storage that is capable of storing data. The persistent storage may be a local storage unit or a remote storage unit. The persistent storage may be a magnetic storage unit, an optical storage unit, a solid-state storage unit, an electronic storage unit including main memory, or a similar storage unit. The persistent storage may also be a monolithic single device or a distributed set of devices. Each component may include hardware including processing devices, including processors, central processing units (CPUs), and graphics processing units (GPUs), memory including random access memory (RAM), storage devices including a hard disk drive (HDD) and a solid-state drive (SSD), and other hardware devices including a sound card and a video card. The computing system may comprise any suitable type of computing device or machine that has a programmable processor including server computers, desktop computers, laptop computers, tablet computers, smartphones, and set-top boxes. In some examples, the computing system may comprise a single machine or may include multiple interconnected machines including multiple servers configured in a cluster. The computing system may be implemented by a common entity or organization or may be implemented by different entities or organizations.

FIG. 1C illustrates an alternative embodiment of the application management platform 100 depicting a distributed deployment environment of the AI agent system 106 in connection with an enterprise infrastructure. The architecture reflects system elements distributed across a plurality of communication networks 108-1 and 108-2 and demonstrates interactions between enterprise users, agent command systems, and applications.

As depicted in FIG. 1C, the enterprise users 102-1 and 102-2 operate corresponding user devices 104-1 and 104-2, respectively. The user devices 104-1 and 104-2 may include any computing device capable of establishing a network connection and interfacing with enterprise systems, including desktop computers, laptops, mobile phones, or tablet devices. Each user device may interact with a corresponding agent command system 101-1 or 101-2. The agent command systems 101-1 and 101-2 may be communicatively coupled to the AI agent system 106 through a first network 108-1, and the AI agent system 106 may be communicatively coupled to the set of applications 110 through a second network 108-2.

The AI agent system 106 interfaces with the agent command systems 101 and the set of applications 110 across the plurality of networks 108-1 and 108-2 and acts as an intermediary that facilitates intelligent, automated task execution based on enterprise identity controls. The AI agent system 106 may be communicatively coupled with the application management platform 100 that oversees and orchestrates deployment, access provisioning, and lifecycle management of AI-agent-based automation. The applications form a collective set of applications 110 of enterprise-deployed software systems, comprising commonly used platforms including Salesforce, customer relationship management systems, regulatory filing portals, or internally hosted operational tools. The set of applications 110 varies in accordance with each enterprise. The set of applications 110 is a customized set tailored to address the specific requirements of each enterprise.

The architecture of FIG. 1C emphasizes the role of distributed user interactions wherein different users, command-originating systems, and applications may be connected over different network interfaces. Unlike monolithic enterprise systems, the arrangement of FIG. 1C represents the practical reality of hybrid information technology environments where not all applications are uniformly connected or orchestrated under a single identity governance mechanism.

The AI agent system 106 mediates communication and operational requests between command-originating enterprise systems and the managed application ecosystem. The AI agent system 106 may incorporate logic for parsing user instructions or task directives, orchestrating task flows, validating access policies, updating credential states, and sending execution notifications. The AI agent system 106 enables agentic automation even in cases where application integration is incomplete or where manual processes are still used, by employing techniques including interface automation, synthetic API generation, or remote workflow triggers.

By situating the AI agent system 106 between disparate agent command systems and applications, the architecture shown in FIG. 1C supports a flexible, secure, and intelligent mechanism for managing complex enterprise workflows while maintaining identity and access policies enforced across multiple application types and endpoints.

### Exemplary System Architecture

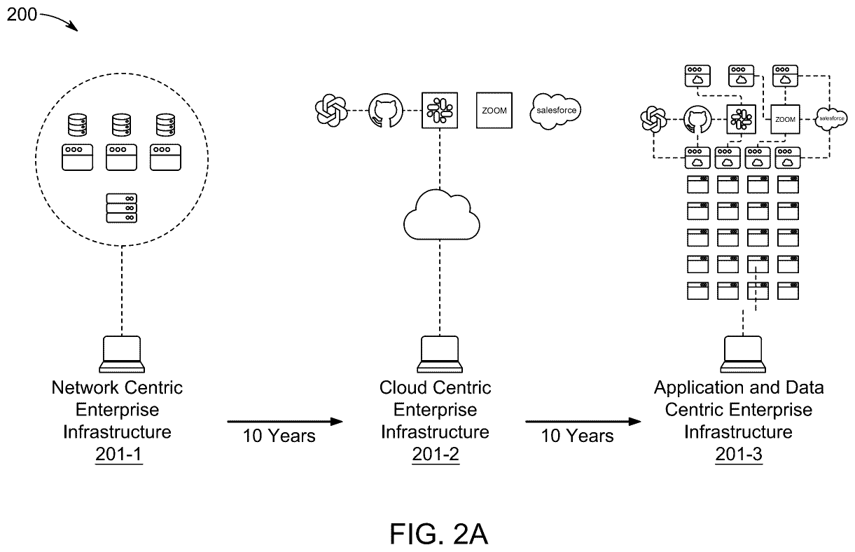

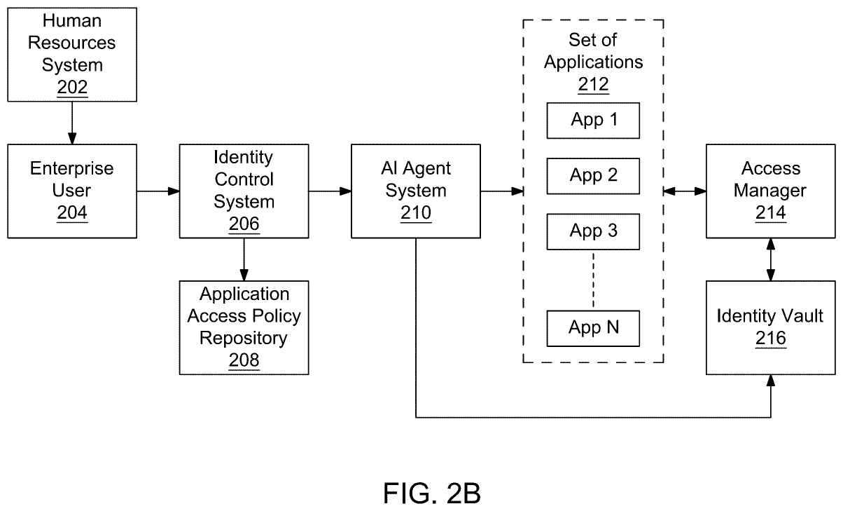

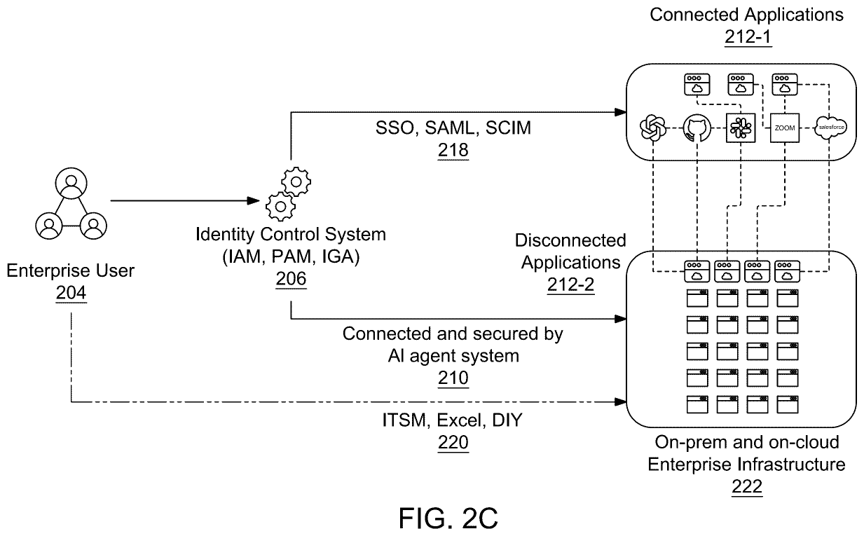

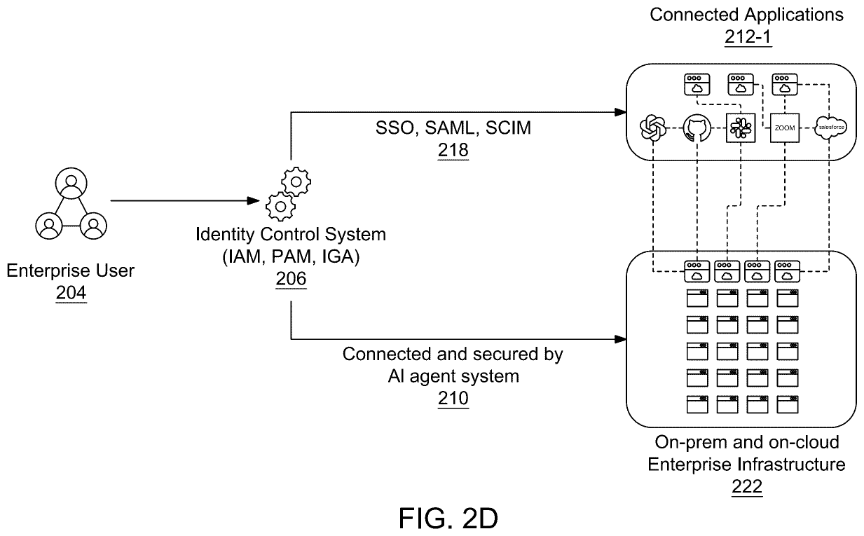

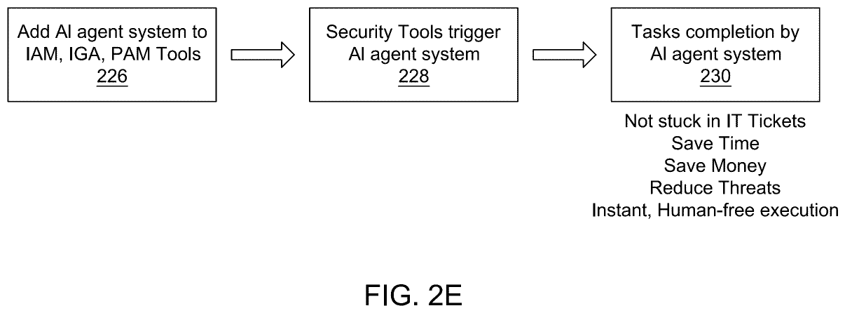

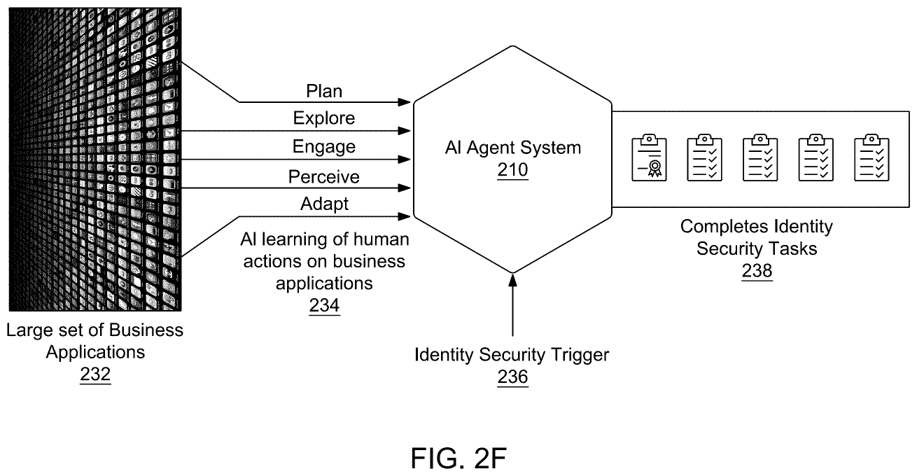

FIG. 2A illustrates an architectural diagram of an exemplary system 200 depicting the evolution of enterprise infrastructure models from network-centric paradigms to application- and data-centric paradigms, in accordance with certain embodiments of the present disclosure. The architectural diagram depicts three successive stages of enterprise infrastructure evolution spanning approximately two decades. A first stage depicts a network-centric enterprise infrastructure 201-1, in which enterprise applications and services are organized around physical network boundaries, on-premises data centers, and perimeter-based security models. A second stage depicts a cloud-centric enterprise infrastructure 201-2, in which enterprise applications and services migrate to cloud-hosted environments, introducing distributed access patterns and multi-tenant service delivery. A third stage depicts an application- and data-centric enterprise infrastructure 201-3, in which the enterprise security and identity perimeter shifts from a network layer to application and data layers, and individual applications and data stores become primary units of access control, policy enforcement, and identity governance. Each transition between successive stages spans approximately ten years. The evolution from the network-centric enterprise infrastructure 201-1 to the application- and data-centric enterprise infrastructure 201-3 creates a heterogeneous application landscape in which enterprise organizations simultaneously operate legacy on-premises applications, cloud-native services, and third-party platforms with varying degrees of integration, connectivity, and programmatic accessibility. The heterogeneity of the application- and data-centric enterprise infrastructure 201-3 forms the operational context in which the AI agent system described herein operates.

FIG. 2B illustrates an exemplary system 200 of an AI agent-based enterprise identity orchestration and credential automation platform, in accordance with certain embodiments of the present disclosure. The system 200 is implemented within a secure enterprise network environment and comprises a plurality of functional modules and system components, including a human resources system 202, an enterprise user 204, an identity control system 206, an application access policy repository 208, an AI agent system 210, a set of applications 212 comprising application 1 through application N, an access manager 214, and an identity vault 216.

The human resources system 202 is a centralized enterprise repository that maintains user-specific attributes and employment metadata, including designation, department, employment status, access eligibility criteria, and historical access records. For example, upon onboarding a new employee into a marketing department, the human resources system 202 stores the relevant role, project assignment, and department-specific flags that inform downstream access decisions. When an employee transitions from one department to another or exits the organization, the human resources system 202 updates the employment status accordingly.

The enterprise user 204 may be an internal administrative system, service entity, or administrative user operating within the enterprise infrastructure that fetches the employee details from the human resources system 202. The employee details include identity attributes, department-based entitlements, project-specific roles, and policy flags that define a scope of application access for the employee. For example, the enterprise user 204 may detect that an employee assigned to a financial audit project is eligible for limited access to an enterprise financial ledger application while being denied access to engineering development platforms.

The identity control system 206 serves as a decision engine that interprets enterprise-defined access control policies and determines an eligible set of applications each employee is permitted to access. The identity control system 206 may utilize static policy rules, dynamic access condition evaluation, or role-based access control logic to determine entitlements. For example, a data analyst joining a compliance team may be granted view-only access to compliance dashboards, whereas a senior compliance officer may be granted editing and submission privileges. Based on the determined scope of access, the identity control system 206 triggers either a credential creation task upon employee onboarding or a revocation task upon employee exit or access expiration.

The application access policy repository 208 is a dedicated storage layer or configuration store that maintains policy documents, compliance checklists, access templates, and entitlement definitions. The application access policy repository 208 may include per-application authentication modes, credential types, and compliance requirements. For example, a customer relationship management system may require multi-factor authentication using time-based tokens, while a regulatory submission platform may require access through a secure virtual private network (VPN). The identity control system 206 consults the application access policy repository 208 when making determinations regarding access provisioning or deprovisioning.

The AI agent system 210 functions as an intelligent execution layer that translates an intent derived from the identity control system 206 into a series of task executions across multiple heterogeneous applications. The AI agent system 210 orchestrates a credential creation, modification, or removal process and communicates with both connected and disconnected applications. For example, a customer relationship management platform may be a sanctioned and programmatically accessible application supporting standard authentication protocols, while a third-party treasury interface hosted on a partner cloud infrastructure may require interface automation using robotic process automation (RPA) or semantic uniform resource locator (URL)-based mapping. The AI agent system 210 handles both categories with equal agility, providing consistent and audit-friendly execution.

The set of applications 212, comprising application 1 through application N, represents a portfolio of enterprise tools and applications that employees may need to access. The set of applications 212 includes customer relationship management platforms, regulatory submission platforms, internal operational tools hosted on private cloud, and third-party partner interfaces. Some applications within the set of applications 212 are classified as sanctioned and support direct programmatic access, while other applications may be unlisted, disconnected, or legacy systems that do not expose modern application programming interfaces. For example, a sanctioned system may allow secure identity federation, while an unsanctioned procurement portal may require screen-based automation or manual form parsing.

The access manager 214 supervises overall task execution and maintains auditability. The access manager 214 verifies that credential lifecycle management activities, including provisioning, updates, and revocations, are completed successfully, logged appropriately, and aligned with enterprise compliance expectations. For example, in scenarios where a deprovisioning task fails due to an unreachable application, the access manager 214 may escalate an issue to an administrator and trigger a retry loop. The access manager 214 may also enforce temporal access constraints, including expiring credentials issued for short-term contractors, and may maintain versioned audit logs to support forensic analysis and compliance reporting.

The identity vault 216 functions as a secure storage module for credentials issued to enterprise users. The identity vault 216 may store usernames, passwords, application programming interface tokens, multi-factor secrets, and biometric templates. For example, when an employee is granted access to a cloud database, generated credentials are securely stored in the identity vault 216 in compliance with encryption-at-rest policies, audit logging, access expiration, and role-based retrieval constraints. The identity vault 216 may support zero-trust integrations with endpoint agents to facilitate secure credential injection at runtime.

The components of the system 200 operate in coordination to provide seamless, policy-compliant, and secure identity orchestration within complex enterprise environments. The AI-driven architecture of the system 200 provisions user access in accordance with verified human resources data and policy data, and executes tasks including application programming interface key refresh and user deactivation proactively, even for applications not directly connected to enterprise identity systems.

FIG. 2C illustrates an architectural diagram depicting integration of AI agent-based identity governance across connected applications and disconnected applications within a hybrid enterprise infrastructure, in accordance with certain embodiments of the present disclosure. FIG. 2C depicts the enterprise user 204 coupled to the identity control system 206 implementing identity and access management (IAM), privileged access management (PAM), and identity governance and administration (IGA) functions. The identity control system 206 is communicatively coupled to the AI agent system 210, which is communicatively coupled to both a set of connected applications 212-1 and a set of disconnected applications 212-2 within an on-premises and on-cloud enterprise infrastructure 222. The connected applications 212-1 are integrated with the identity control system 206 via standardized protocols including single sign-on (SSO), security assertion markup language (SAML), and system for cross-domain identity management (SCIM) 218. The disconnected applications 212-2 are applications that lack native protocol integration and are managed using alternative methods, including information technology service management (ITSM) tickets, spreadsheet-based tracking, or custom-built tools 220. The AI agent system 210 bridges a gap between the connected applications 212-1 and the disconnected applications 212-2 by providing automated identity governance capabilities across both categories of applications irrespective of availability of a programmatic interface.

FIG. 2D illustrates an exemplary connectivity framework between enterprise users, the identity control system, and a plurality of applications integrated with the AI agent system, in accordance with certain embodiments of the present disclosure. FIG. 2D depicts the enterprise user 204 coupled to the identity control system 206 implementing IAM, PAM, and IGA functions. The identity control system 206 is communicatively coupled to the AI agent system 210, which is communicatively coupled to the connected applications 212-1 deployed on the on-premises and on-cloud enterprise infrastructure 222 via SSO, SAML, and SCIM 218. FIG. 2D illustrates an alternative embodiment in which an enterprise application landscape comprises primarily connected applications 212-1, and the AI agent system 210 operates alongside standardized identity federation and provisioning protocols.

FIG. 2E is a system workflow diagram showing an AI agent-driven remediation process initiated by contextual security signals and executed across enterprise applications, in accordance with certain embodiments of the present disclosure. FIG. 2E depicts three sequential stages. At a first stage 226, the AI agent system 210 is added to IAM, IGA, and PAM tools, integrating agentic automation capabilities into existing identity governance infrastructure. At a second stage 228, security tools trigger the AI agent system 210 in response to identity lifecycle events, policy violations, or security incidents. At a third stage 230, the AI agent system 210 completes identity security tasks across an enterprise application estate, achieving instant, human-free execution, time savings, cost reduction, and threat mitigation.

FIG. 2F is a conceptual diagram depicting AI agent behavioral learning for autonomous execution of identity lifecycle tasks in enterprise applications, in accordance with certain embodiments of the present disclosure. FIG. 2F depicts the AI agent system 210 that learns from human actions on business applications 234 within a large set of business applications 232. The AI agent system 210 acquires behavioral patterns through a sequence of learning stages comprising plan, explore, engage, perceive, and adapt. Upon receiving an identity security trigger 236, the AI agent system 210 completes identity security tasks 238 across the large set of business applications 232 by applying learned behavioral patterns to autonomously navigate, interpret, and interact with enterprise application interfaces.

### Internal Functional Modules

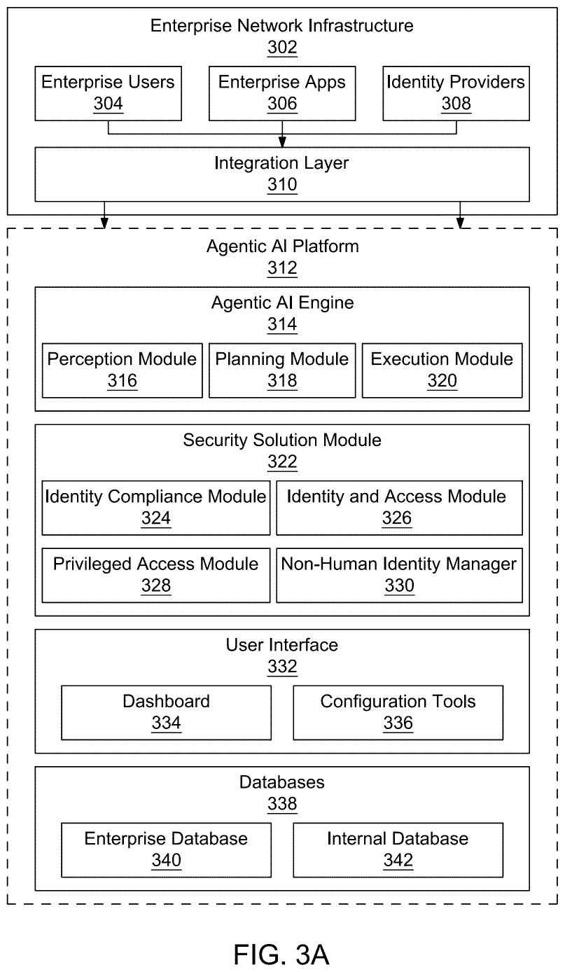

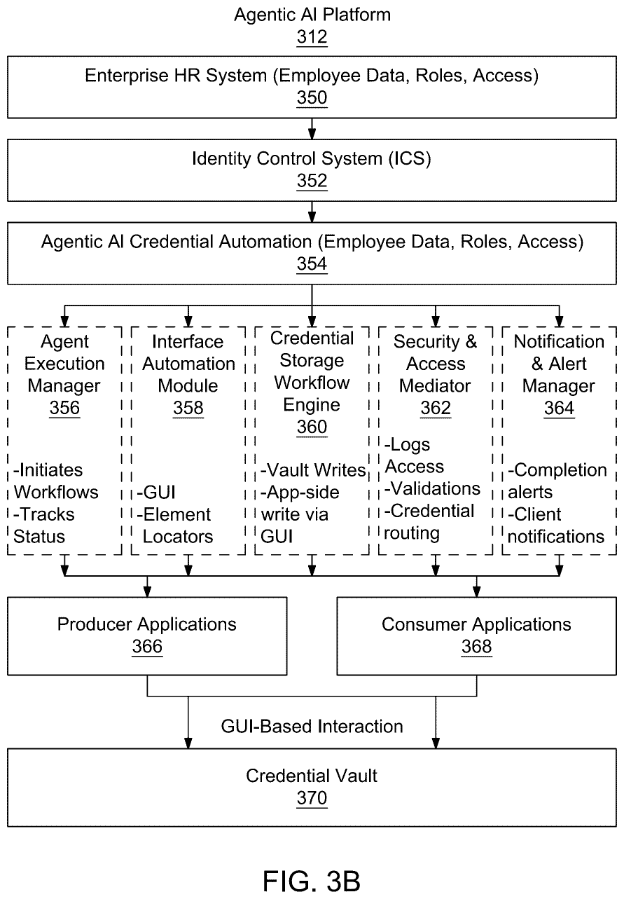

FIG. 3A illustrates an exemplary system architecture depicting internal functional modules of the agentic AI platform, in accordance with certain embodiments of the present disclosure. The architecture is deployed within an enterprise network infrastructure 302 and is communicatively coupled to enterprise users 304, enterprise applications 306, and identity providers 308 via an integration layer 310.

The architecture comprises an agentic AI platform 312 containing an agentic AI engine 314. The agentic AI engine 314 comprises a perception module 316, a planning module 318, and an execution module 320. The perception module 316 is configured to detect and interpret user interface elements rendered on graphical interfaces of enterprise applications using computer vision and image recognition techniques. The planning module 318 is configured to decompose identity governance intents into structured execution plans by interpreting user instructions, evaluating policy constraints, and determining a sequence of actions to be performed across target enterprise applications. The execution module 320 is configured to carry out actions determined by the planning module 318 by generating and executing simulated user interactions with the enterprise application interfaces, including mouse-click simulation, keyboard-input simulation, and form-field population.

The agentic AI platform 312 further comprises a security solution module 322, an identity compliance module 324, an identity and access module 326, a privileged access module 328, and a non-human identity manager 330. The security solution module 322 provides security validation and enforcement across platform workflows. The identity compliance module 324 monitors and enforces compliance with regulatory and organizational access control policies. The identity and access module 326 manages user identity lifecycle operations including provisioning, deprovisioning, and entitlement review. The privileged access module 328 manages elevated access privileges and privileged session controls. The non-human identity manager 330 manages credentials and access privileges associated with service accounts, machine identities, and automated processes.

The architecture comprises a user interface 332 including a dashboard 334 and configuration tools 336 accessible to enterprise administrators and compliance personnel. The architecture is communicatively coupled to databases 338 including an enterprise database 340 and an internal database 342 that store identity records, access policies, credential metadata, and audit logs.

### Agentic AI Credential Automation System

FIG. 3B illustrates the agentic AI platform 312, described with reference to FIG. 3A, configured as an agentic AI credential automation system for performing graphical user interface (GUI)-based orchestration for enterprise identity workflows, in accordance with certain embodiments of the present disclosure. FIG. 3B depicts a credential automation subsystem within the agentic AI platform 312, bridging enterprise policy engines with application endpoints through an intelligent middleware capable of credential generation, injection, and lifecycle management.

The agentic AI platform 312, as depicted in FIG. 3B, comprises an enterprise human resources (HR) system 350 that functions as an authoritative data source for user identity attributes, including employee data, roles, and access entitlements. The enterprise HR system 350 maintains updated metadata about each employee and acts as an originator of identity provisioning or deprovisioning events.

An identity control system (ICS) 352 receives the user identity attributes from the enterprise HR system 350 and evaluates organizational access policies. The identity control system 352 determines application access, triggers credential creation or removal, and stores policy metadata. For example, upon offboarding, the identity control system 352 triggers workflows to remove application-level access, which are then delegated to the credential automation subsystem.

An agentic AI credential automation module 354 functions as a middleware execution engine configured to translate access decisions into executable actions. The agentic AI credential automation module 354 receives the employee data, the roles, and the access entitlements from the identity control system 352 and serves as a core protocol abstraction layer capable of interacting with a heterogeneous application ecosystem. The agentic AI credential automation module 354 orchestrates credential issuance, revocation, and updates across both connected and disconnected systems.

The agentic AI credential automation module 354 comprises an agent execution manager 356, an interface automation module 358, a credential storage workflow engine 360, a security and access mediator 362, and a notification and alert manager 364. The agent execution manager 356 initiates workflows and tracks execution status by decomposing incoming identity intents into atomic sub-tasks and routing the sub-tasks to appropriate modules. For example, upon receiving an instruction to generate a new application programming interface key, the agent execution manager 356 may trigger the credential storage workflow engine 360 and a credential generation workflow in parallel.

The interface automation module 358 facilitates GUI-level automation for applications that lack standard application programming interface connectivity. The interface automation module 358 includes logic for identifying GUI elements including input fields, buttons, dropdowns, and dynamic frames using element locators. The interface automation module 358 enables the agentic AI platform 312 to perform programmatic interactions with external systems in a human-like manner.

The credential storage workflow engine 360 manages secure handling and routing of credentials. The credential storage workflow engine 360 supports vault write operations to a centralized credential vault 370 and application-side write operations via GUI interfaces. For example, a newly created application programming interface key for a field service application may be stored in the credential vault 370 while also being simultaneously injected into an application user management portal.

The security and access mediator 362 logs access events, performs policy validations, and manages credential routing during workflow execution. The security and access mediator 362 monitors transactional success or failure and is configured to enforce conditional logic including time-based access expiry and escalation rules.

The notification and alert manager 364 handles completion alerts and client notifications across the agentic AI platform 312. Upon successful completion of credential-related operations, the notification and alert manager 364 sends alerts to appropriate stakeholders including system administrators, compliance officers, or application owners.

Producer applications 366 represent internal enterprise systems configured to generate credentials, including credential generators, application programming interface key generators, and internal administrative user interfaces. Consumer applications 368 are target systems that rely on generated credentials for user access, including regulatory submission applications, customer relationship management platforms, field operations tools, and treasury systems. The agentic AI credential automation module 354 interacts with both the producer applications 366 and the consumer applications 368 via GUI-based interaction.

The credential vault 370 serves as a centralized storage repository for enterprise credentials. The credential vault 370 is updated via the credential storage workflow engine 360 and supports credential rotations and time-to-live (TTL) enforcement. The credential vault 370 stores credentials including passwords, application programming interface keys, and authentication tokens in an encrypted format, and maintains credentials that are valid and within expiration boundaries.

The agentic AI platform 312, as depicted in FIG. 3B, facilitates a GUI-driven, application-agnostic, and audit-enforced identity orchestration mechanism that reduces dependency on application-specific application programming interfaces. The agentic AI platform 312 is updatable through deployment application template (DAT) files, allowing new applications to be integrated without system reengineering.

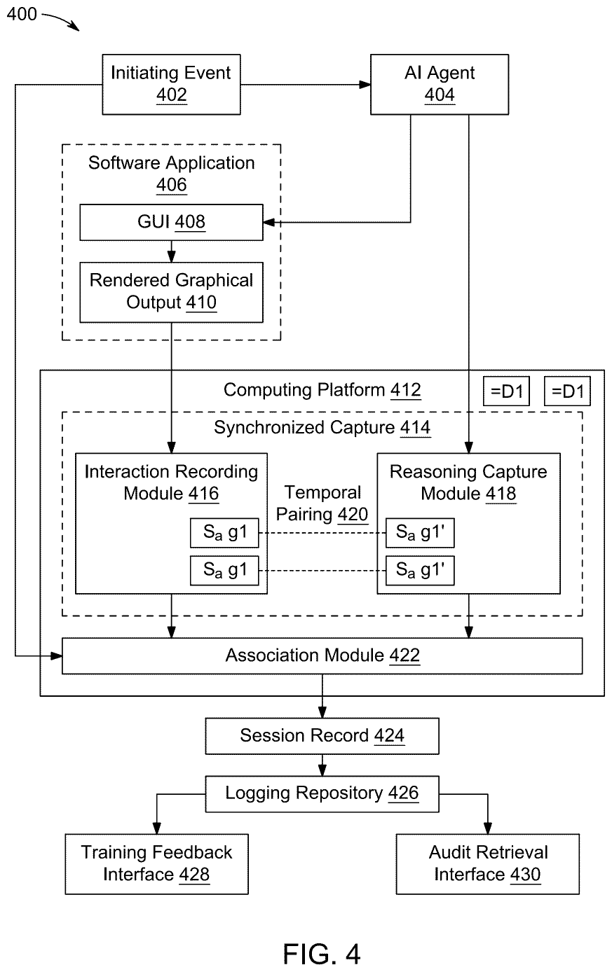

A system that operates within the enterprise environment established by FIG. 1A through FIG. 3B and captures interaction traces of the AI agent during execution of automated tasks on the graphical user interfaces of the software applications is introduced in FIG. 4.

### System for Capturing Interaction Traces of an Artificial Intelligence (AI) Agent

FIG. 4 illustrates a system 400 for capturing interaction traces of an artificial intelligence (AI) agent 404 during execution of an automated task on a graphical user interface (GUI) 408 of a software application 406. The system 400 implements an observability architecture that concurrently captures an observational record of the AI agent's interactions with the GUI 408 and a log of the AI agent's internal decision-making process corresponding to the interactions, and associates both artifacts with an initiating event 402 that caused the AI agent 404 to begin the execution. In some embodiments, the system 400 operates from a rendered graphical output 410 of the GUI 408 and does not rely on application programming interfaces (APIs) or structured telemetry hooks of the software application 406.

The system 400 includes a computing platform 412 comprising one or more processors and a memory storing instructions. The one or more processors execute the instructions stored in the memory to perform the operations described herein. The computing platform 412 may be implemented as a standalone computing device, a virtual machine, a cloud-hosted server, or a containerized execution environment. The one or more processors may include a central processing unit (CPU), a graphics processing unit (GPU), a digital signal processor (DSP), or a combination thereof. The memory may include volatile memory such as random access memory (RAM) for temporary data processing and non-volatile memory such as solid-state drives (SSDs) for persistent storage of program instructions and session data. In some implementations, the computing platform 412 is co-located with the AI agent 404 on a shared computing device. In other implementations, the computing platform 412 operates on a remote server that receives data streams from the AI agent 404 over a network connection.

The system 400 includes an initiating event 402. The initiating event 402 is an event that causes the AI agent 404 to begin execution of the automated task on the GUI 408 of the software application 406. The initiating event 402 may comprise at least one of a security signal generated by a security monitoring system upon detection of a non-compliant configuration state or policy anomaly, a policy-based instruction generated by a governance or compliance platform specifying a corrective action to be performed by the AI agent 404, and an application-level automation event specifying a workflow step or configuration change to be executed by the AI agent 404. For example, a security information and event management (SIEM) platform may detect that a two-factor authentication setting in a cloud-based customer relationship management (CRM) application has been disabled. The SIEM platform generates a security signal identifying the policy violation, and the security signal serves as the initiating event 402 that causes the AI agent 404 to begin a remediation task on the CRM application. In another example, an identity governance and administration (IGA) platform detects that an employee's role has changed and generates a policy-based instruction directing the AI agent 404 to revoke access credentials across a set of applications. In a further example, an application workflow engine generates an application-level automation event directing the AI agent 404 to update a configuration parameter in a third-party enterprise application. Each of these examples constitutes an initiating event 402 that triggers the downstream capture and association operations.

The AI agent 404 is an autonomous software agent that executes the automated task by interacting directly with the GUI 408 of the software application 406. The AI agent 404 perceives rendered interface content using computer vision, interprets the perceived content using a language model, and selects actions based on learned policies and contextual reasoning. The interactions performed by the AI agent 404 include navigating the interface, detecting user interface elements, reading toggle states, interpreting labels, and performing modifications such as selecting dropdown options, entering text into input fields, or submitting form data. For example, when the AI agent 404 is directed to modify a security setting in a third-party application, the AI agent 404 navigates through configuration menus, identifies a relevant toggle control, interprets a label associated with the toggle control, determines a correct state for the toggle control based on an applicable security policy, and executes a simulated click to change the toggle control to the correct state.

The software application 406 is a software application that presents the GUI 408 for interaction by the AI agent 404. The software application 406 may be a web-based application, a native desktop application, a legacy terminal application, or a hybrid application that presents a graphical interface. The software application 406 may include, but is not limited to, enterprise resource planning (ERP) systems, CRM platforms, cloud-based productivity suites, security administration consoles, financial dashboards, and partner-hosted portals. In some implementations, the system 400 may operate across a plurality of software applications, and the software application 406 represents one such software application with which the AI agent 404 interacts during a given execution.

The GUI 408 is a graphical user interface presented by the software application 406 for human or agent interaction. The GUI 408 includes user interface elements such as text input fields, toggle controls, dropdown menus, navigation buttons, configuration panels, form submission controls, and modal dialog boxes. The GUI 408 produces a rendered graphical output 410.

The rendered graphical output 410 is a visual output of the GUI 408 as rendered on a display device or a virtual display buffer. The rendered graphical output 410 represents a pixel-level visual presentation of an interface state at each moment during execution of the automated task. The rendered graphical output 410 is a data source from which the interaction recording module 416 captures the observational record. The rendered graphical output 410 is distinct from any programmatic output of the software application 406 such as API responses, document object model (DOM) structures, or backend telemetry data. In some embodiments, the system 400 captures the observational record from the rendered graphical output 410 without invoking an API of the software application 406. In an illustrative example, the rendered graphical output 410 corresponds to a pixel stream displayed on a headless browser instance in which the AI agent 404 performs the automated task. In another example, the rendered graphical output 410 corresponds to screen output captured from a remote desktop session in which the AI agent 404 interacts with a legacy application. The log of the AI agent's internal decision-making process is captured concurrently by the reasoning capture module 418 as described below.

The computing platform 412 includes a synchronized capture 414 subsystem. The synchronized capture 414 subsystem comprises two modules that operate concurrently during execution of the automated task: the interaction recording module 416 and the reasoning capture module 418. The interaction recording module 416 and the reasoning capture module 418 are temporally aligned through a temporal pairing 420 mechanism such that each segment of the observational record produced by the interaction recording module 416 corresponds to a segment of the log produced by the reasoning capture module 418 during the same portion of execution of the automated task.

The interaction recording module 416 is configured to capture, from the rendered graphical output 410 of the GUI 408, an observational record of interactions performed by the AI agent 404 with the GUI 408 during execution of the automated task. The observational record is a visual record of the AI agent's on-screen activity. The interaction recording module 416 captures the observational record in real time as the AI agent 404 performs the automated task. The observational record may be a continuous video stream encoded at a baseline frame rate, a sequence of screenshot images captured at regular intervals, or a pixel-output stream derived from the rendered graphical output 410. In one implementation, the interaction recording module 416 records screen frames at a baseline capture rate during periods of interface inactivity and at an elevated capture rate in response to detected interaction events performed by the AI agent 404, the interaction events comprising element selections, text entries, navigation transitions, and toggle state changes. The interaction recording module 416 captures cursor movements, element selections, scrolling behavior, keyboard entries, and other GUI-level interactions performed by the AI agent 404 during the execution. For example, when the AI agent 404 modifies a configuration setting in Google Workspace or Salesforce, the interaction recording module 416 generates a continuous visual record of the interface interaction as a replayable screen capture. Capturing of the observational record continues across changes in the GUI 408 occurring during the execution, the changes comprising at least one of repositioned interface controls, updated visual styling, renamed element labels, dynamically loaded interface sections, and rendering updates caused by application state transitions.

The reasoning capture module 418 is configured to generate, concurrently with capture of the observational record by the interaction recording module 416, a log of the AI agent's internal decision-making process corresponding to the interactions. The log is a structured record of the AI agent's perception, interpretation, and reasoning at each interaction during execution of the automated task. The log includes, for a plurality of the interactions, at least a semantic interpretation generated by the AI agent 404 of a user interface element involved in each interaction and a decision criterion applied by the AI agent 404 in selecting each interaction over an alternative interaction available at the GUI 408 at a time of each interaction. The log may further include verification outcomes confirming whether each action executed by the AI agent 404 produced an expected interface state, and fallback actions considered or executed by the AI agent 404 upon encountering an unexpected interface response.

In one implementation, the log is produced by a vision-language reasoning architecture of the AI agent 404. The vision-language reasoning architecture comprises a visual perception module that detects and classifies user interface elements rendered on the GUI 408 using computer vision, a semantic interpretation module that generates textual interpretations of the detected user interface elements and associated labels using a language model, and an action selection module that determines an action to be executed based on outputs of the visual perception module and the semantic interpretation module. The visual perception module may employ a Vision Transformer (ViT) model or a deep convolutional neural network (CNN) that processes screen images captured during execution as sequences of image patches to identify and classify the user interface elements. The reasoning capture module 418 captures outputs of the modules of the vision-language reasoning architecture at each interaction, thereby producing the structured log.

For example, if the AI agent 404 observes a toggle control labeled “Enable external access” in a security configuration panel of the software application 406, the reasoning capture module 418 records: (a) a semantic interpretation indicating that the toggle control governs an external access permission, (b) a classification confidence level of 0.92 indicating certainty in the interpretation, (c) an alternative interpretation that the toggle control governs an API access permission at confidence 0.71, (d) a decision criterion indicating that the AI agent 404 selected disabling of the toggle based on a security policy baseline, and (e) a verification outcome indicating that a post-action interface state matched an expected state. Each of these fields is recorded as a structured entry in the log in temporal alignment with a corresponding segment of the observational record captured by the interaction recording module 416.

The temporal pairing 420 between the interaction recording module 416 and the reasoning capture module 418 operates at a segment level. Each segment of the observational record, corresponding to a window, frame, or fragment of the visual capture, has a corresponding segment of the log produced by the AI agent 404 during the same portion of execution. The temporal pairing 420 allows the system 400 to detect and flag any segment of the observational record that lacks a corresponding segment of the log, or any segment of the log that lacks a corresponding segment of the observational record. The temporal pairing 420 is a structural property of the synchronized capture 414 subsystem. The temporal pairing 420 enables subsequent synchronized replay of the observational record alongside the log, such that a reviewer can identify, at each moment of the replay, what interface state the AI agent 404 observed, what interpretation the AI agent 404 formed, what decision criterion the AI agent 404 applied, and what action the AI agent 404 executed.

The computing platform 412 further includes an association module 422. The association module 422 is configured to associate both the observational record and the log of the internal decision-making process with the initiating event 402 that caused the AI agent 404 to begin execution of the automated task. The association module 422 generates a session record 424 that links the observational record and the log to the initiating event 402 by a reference identifier. The reference identifier enables retrieval of the observational record and the log from the initiating event 402. In one implementation, the reference identifier comprises a task identifier uniquely identifying execution of the automated task, an originating system identifier identifying a system that generated the initiating event 402, a trigger classification identifying a type of the initiating event 402, a session initiation timestamp and a session completion timestamp, and a storage reference linking the task identifier to both the observational record and the log. The association module 422 receives three inputs: the observational record from the interaction recording module 416, the log from the reasoning capture module 418, and the initiating event 402. The association module 422 produces one output: the session record 424 containing a bi-artifact reference structure. For example, if a security signal triggered the AI agent 404 to remediate a misconfigured sharing permission in Salesforce, the association module 422 tags both the observational record and the log with the task identifier, the originating SIEM platform identifier, the trigger classification, and the session timestamps, thereby producing a session record 424 that allows retrieval of a complete bi-artifact audit trail from the task identifier.

The session record 424 is an output of the association module 422. The session record 424 links the observational record and the log to the initiating event 402 by the reference identifier. The session record 424 is a structured data object containing reference identifier fields and pointers to the stored observational record and the stored log. The session record 424 is passed to the logging repository 426 for persistent storage.

The logging repository 426 is a tamper-resistant logging repository configured to store the session record 424 together with, or in linked association with, the observational record and the log of the internal decision-making process as immutable session data. The logging repository 426 comprises metadata including a task identifier uniquely identifying execution of the automated task, a timestamp identifying initiation and completion of the execution, a target application identifier identifying the software application 406, a summary of actions performed by the AI agent 404 during the execution, and an audit status indicating whether the execution was completed, partially completed, or failed. The logging repository 426 supports immutability through write-once storage mechanisms, cryptographic integrity checks, or append-only data structures. The logging repository 426 enables structured retrieval of past sessions by task identifier, by application identifier, by timestamp range, or by audit status. The logging repository 426 may be implemented as a local storage system, a cloud-hosted object store, a distributed ledger, or a compliance-certified archival system. Multiple session records 424 may be stored in the logging repository 426, each corresponding to a separate execution of an automated task by the AI agent 404.

The system 400 further includes a training feedback interface 428. The training feedback interface 428 is configured to classify execution of the automated task as a successful execution or a failed execution based on whether the AI agent 404 achieved an intended outcome of the automated task as determined from the observational record and the log. The training feedback interface 428 provides the observational record and the log to a model training pipeline as labeled training samples for supervised fine-tuning of a machine learning model of the AI agent 404. Sessions classified as successful serve as positive training examples. Sessions classified as failed are analyzed to identify a specific reasoning step at which the AI agent's interpretation of a user interface element diverged from a correct interpretation. The training feedback interface 428 generates corrective training annotations specifying the incorrectly interpreted element, the incorrect semantic interpretation, a correct semantic interpretation, and a corrective training signal for fine-tuning. The training feedback interface 428 enables a closed-loop learning architecture in which a behavioral model of the AI agent 404 improves iteratively based on real execution outcomes.

The system 400 further includes an audit retrieval interface 430. The audit retrieval interface 430 is configured to receive, in response to a request from an authorized entity, the observational record and the log of the internal decision-making process from the logging repository 426. The audit retrieval interface 430 presents the retrieved observational record and log to the authorized entity for compliance verification. The authorized entity may be an enterprise client, a compliance auditor, a regulatory body, or an internal administrator. In one implementation, the audit retrieval interface 430 presents the observational record and the log in a synchronized replay format in which the observational record is displayed as a time-indexed video replay of the execution and textual annotations derived from the log are displayed in temporal alignment with corresponding interface states in the observational record. The audit retrieval interface 430 thereby enables the authorized entity to review, at each moment of the replay, what interface state the AI agent 404 observed, what interpretation the AI agent 404 formed, and what action the AI agent 404 executed.

The system 400 is applicable across a range of deployment contexts. In one deployment, the system 400 monitors an AI agent 404 that performs identity credential management tasks, such as creating, modifying, or revoking user credentials, across multiple enterprise applications. In another deployment, the system 400 monitors an AI agent 404 that performs security configuration remediation tasks, such as disabling non-compliant sharing permissions or enabling required authentication controls. In a further deployment, the system 400 monitors an AI agent 404 that performs workflow automation tasks, such as processing form submissions, updating database records, or generating compliance reports. In each deployment, the system 400 captures the observational record and the log concurrently, associates both artifacts with the initiating event 402, and stores the resulting session record 424 in the logging repository 426 for audit, training, and compliance purposes.

### Method for Capturing Interaction Traces of an Artificial Intelligence (AI) Agent

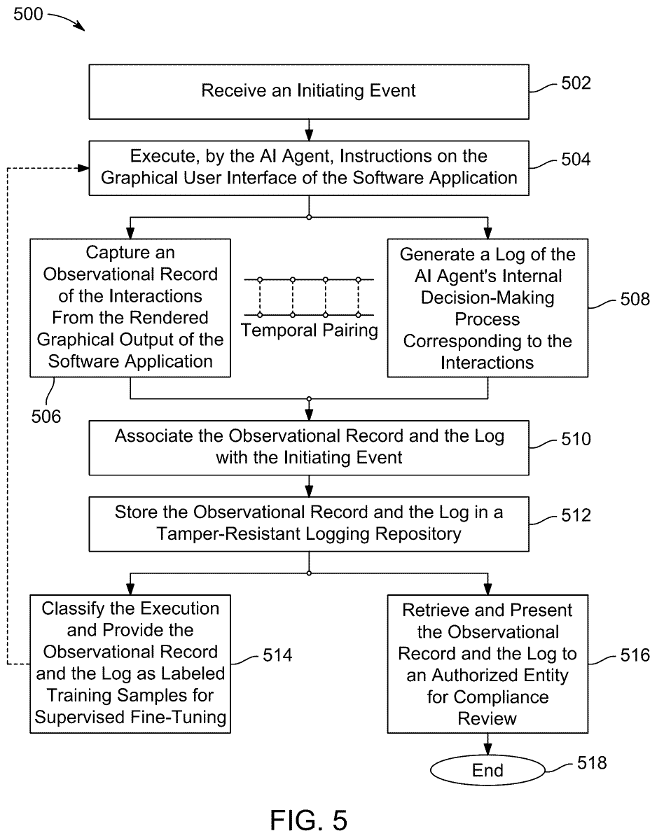

FIG. 5 illustrates a method 500 for capturing interaction traces of an artificial intelligence (AI) agent during execution of an automated task on a graphical user interface (GUI) 408 of a software application 406. The method 500 proceeds through a series of operations that receive an initiating event, execute the automated task, concurrently capture an observational record and a log of the AI agent's internal decision-making process, associate both artifacts with the initiating event, and store the resulting session record for downstream use in training and compliance review. In some embodiments, the method 500 is a computer-implemented method performed by the system 400 described with reference to FIG. 4.

At step 502, the method 500 receives an initiating event 402. The initiating event 402 causes the AI agent 404 to begin execution of the automated task on the GUI 408 of the software application 406. The initiating event 402 may comprise, for example, a security signal identifying a policy violation, a governance instruction specifying a corrective action, or an automation trigger identifying a workflow operation to be executed by the AI agent 404. In one illustrative implementation, the initiating event 402 identifies that a configuration setting of the software application 406 is to be changed or validated. In another illustrative implementation, the initiating event 402 identifies that a workflow task is to be performed through the GUI 408 of the software application 406. The method 500 is initiated in response to receipt of the initiating event 402 and proceeds to execution of the automated task by the AI agent 404.

At step 504, the AI agent 404 begins executing instructions on the GUI 408 of the software application 406. During step 504, the AI agent 404 navigates the interface, detects user interface elements, reads element states, interprets labels and surrounding on-screen content, and performs modifications through simulated interactions. The instructions executed by the AI agent 404 may include navigating through menus, selecting user interface controls, scrolling through interface regions, entering text into fields, toggling configuration controls, selecting dropdown options, submitting form data, and confirming resulting interface states. Step 504 initiates an execution cycle during which the concurrent capture operations of steps 506 and 508 operate. In this manner, the observational record and the internal reasoning log are generated while the AI agent 404 is actively interacting with the GUI 408 rather than after completion of the task.

At steps 506 and 508, the method 500 performs two operations concurrently. Step 506 and step 508 are depicted as parallel branches that execute simultaneously during the automated task rather than sequentially. A temporal pairing relationship connects step 506 and step 508, indicating that each segment of the output produced at step 506 corresponds to a segment of the output produced at step 508 during the same portion of the execution. The temporal pairing may be maintained at the level of frames, time windows, interaction segments, or other execution fragments, so that a reviewer can later correlate what the AI agent 404 observed on the GUI 408 with what the AI agent 404 interpreted and decided during the same moment of execution.

At step 506, the method 500 captures, from a rendered graphical output 410 of the GUI 408, an observational record of interactions performed by the AI agent 404 with the GUI 408 during execution of the automated task. The observational record captures the visual activity of the AI agent 404 on the interface in real time, including element selections, navigation transitions, scrolling behavior, text entries, cursor movements, and toggle state changes. The observational record may be captured as a continuous video stream, a sequence of screenshot images, or another replayable representation derived from the rendered graphical output 410. In some embodiments, the observational record is derived from the rendered graphical output 410 without invoking an application programming interface of the software application 406. In one implementation, the observational record is captured at a first rate during periods of relative inactivity and at a second, higher rate during active interactions, such as element selection or text entry, in order to preserve salient interface changes with greater fidelity. The observational record thus serves as a visual trace of what occurred on the GUI 408 during execution of the automated task.

At step 508, the method 500 generates, concurrently with the capturing at step 506, a log of the AI agent's internal decision-making process corresponding to the interactions. The log records, for a plurality of the interactions, at least a semantic interpretation generated by the AI agent 404 of a user interface element involved in each interaction and a decision criterion applied by the AI agent 404 in selecting each interaction over an alternative interaction available at the GUI 408 at a time of each interaction. In some embodiments, the log further records confidence values, alternative interpretations, fallback options considered, and verification outcomes associated with actions selected by the AI agent 404. The generating at step 508 therefore produces a structured record of how the AI agent 404 perceived, interpreted, and reasoned about interface content while the automated task was being executed. The capturing at step 506 and the generating at step 508 are temporally aligned such that each segment of the observational record corresponds to a segment of the log produced during the same portion of the execution of the automated task. This temporal alignment enables later synchronized replay of the AI agent's observed interface state together with the AI agent's internal reasoning for that state.

At step 510, the method 500 associates both the observational record and the log of the internal decision-making process with the initiating event 402 that caused the AI agent 404 to begin the execution. The association module 422 generates a session record 424 that links the observational record and the log to the initiating event 402 by a reference identifier. The reference identifier enables retrieval of the observational record and the log from the initiating event 402. In some implementations, the reference identifier comprises a task identifier uniquely identifying the execution, an originating system identifier identifying a system that generated the initiating event 402, a trigger classification identifying a type of the initiating event 402, and session timestamps identifying initiation and completion of the execution. By performing the association at step 510, the method 500 ensures that the observational record and the internal reasoning log are not stored as disconnected artifacts, but instead are bound to a common session context linked to the initiating event 402 that caused the AI agent 404 to act.

At step 512, the method 500 stores the observational record and the log of the internal decision-making process in a tamper-resistant logging repository 426 as an immutable session record. The session record comprises metadata including a task identifier uniquely identifying the execution, a timestamp identifying initiation and completion of the execution, a target application identifier identifying the software application 406, a summary of actions performed by the AI agent 404 during the execution, and an audit status indicating whether the execution was completed, partially completed, or failed. In some embodiments, the logging repository 426 preserves immutability through append-only storage, write-once storage techniques, cryptographic integrity checks, or a combination thereof. Step 512 thereby produces a persistent session artifact that can later be used for both audit review and model-improvement purposes.

Following storage at step 512, the method 500 proceeds to downstream use paths at steps 514 and 516.

At step 514, the method 500 classifies execution of the automated task as a successful execution or a failed execution based on whether the AI agent 404 achieved an intended outcome as determined from the observational record and the log. The method 500 provides the observational record and the log to a model training pipeline as labeled training samples for supervised fine-tuning of a machine learning model of the AI agent 404. Sessions classified as failed are analyzed to identify reasoning steps at which the AI agent's interpretation of a user interface element diverged from a correct interpretation. Sessions classified as successful serve as positive training examples for reinforcing correct behavior. In some implementations, the training pipeline derives corrective annotations identifying an incorrectly interpreted interface element, an incorrect semantic interpretation, a correct semantic interpretation, and a corrective training signal for subsequent fine-tuning. As reflected by the return path shown in the figure, step 514 may form a feedback path used to refine subsequent executions of the AI agent 404, such that outputs of the training path influence later executions that again proceed through step 504. The feedback path therefore supports iterative improvement of the AI agent's behavior across repeated executions.

At step 516, the method 500 retrieves and presents the observational record and the log of the AI agent's internal decision-making process to an authorized entity for compliance review. The authorized entity submits a request, and the method 500 retrieves the corresponding session record from the logging repository 426 using the reference identifier. The retrieved observational record and log are presented for compliance verification. In some embodiments, the presentation is provided in a synchronized replay format in which the observational record is displayed as a time-indexed replay of the execution and textual annotations derived from the log are displayed in temporal alignment with corresponding interface states in the observational record. This enables the authorized entity to review, at each moment of the replay, what the AI agent 404 observed, what the AI agent 404 interpreted, what the AI agent 404 decided, and what action the AI agent 404 executed. Step 516 therefore supports regulatory, audit, customer, or internal review of prior AI-agent executions.

At step 518, the method 500 ends. In one embodiment, step 514 supports refinement of future executions of the AI agent 404, while step 516 supports compliance review of the stored session record. In a further embodiment, step 514 may be performed automatically upon completion of step 512, while step 516 may be performed on demand in response to a request from an authorized entity at a later time. The method 500 may be repeated for each new initiating event 402 received by the system 400. Each repetition produces a separate session record 424 stored in the logging repository 426, thereby supporting iterative refinement of a model of the AI agent 404 based on results of prior executions while also maintaining a persistent audit trail for compliance review.

### Temporal Pairing Architecture

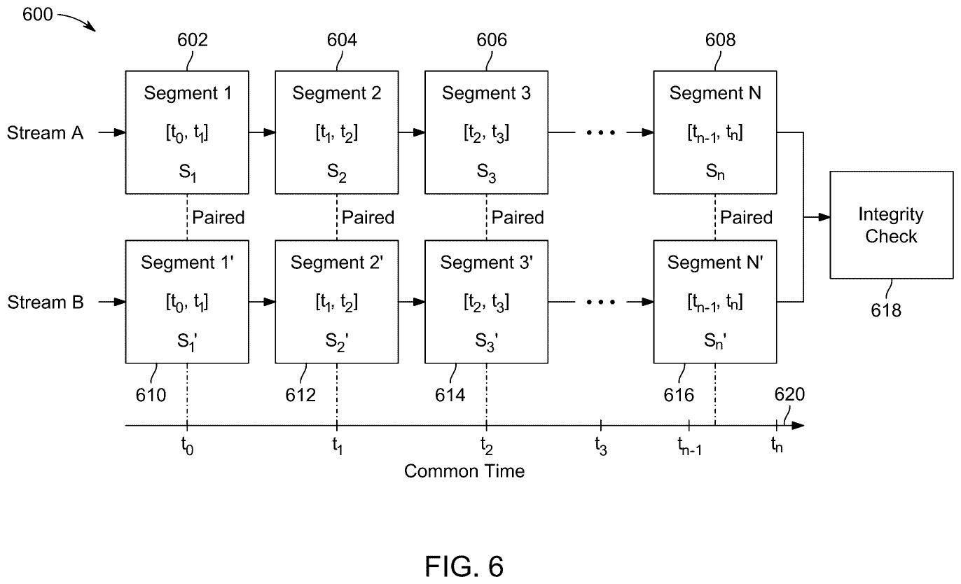

FIG. 6 illustrates a temporal pairing architecture 600 depicting segment-level alignment between an observational record and a log of an AI agent's internal decision-making process during execution of an automated task. The temporal pairing architecture 600 provides a detailed view of a synchronized capture mechanism by which each segment of the observational record corresponds to a segment of the log produced during the same portion of the execution. In some embodiments, the temporal pairing architecture 600 corresponds to the temporal pairing 420 described with reference to FIG. 4.

The temporal pairing architecture 600 comprises two parallel streams identified in the figure as Stream A and Stream B. Stream A represents the observational record captured by the interaction recording module 416, and Stream B represents the log generated by the reasoning capture module 418. Stream A and Stream B extend along a common time reference 620. The common time reference 620 defines a shared temporal axis anchored at discrete time boundaries t0, t1, t2, t3, through tn−1 and tn. The common time reference 620 provides a basis against which both streams are partitioned into corresponding time-bounded segments.

Stream A includes a first segment 602, a second segment 604, a third segment 606, and an Nth segment 608. The first segment 602 spans the time interval from t0 to t1. The second segment 604 spans the time interval from t1 to t2. The third segment 606 spans the time interval from t2 to t3. The Nth segment 608 spans the time interval from tn−1 to tn. Each segment in Stream A contains observational data captured during the corresponding time interval. For example, the first segment 602 may contain rendered pixel frames, cursor positions, and element-selection events captured between t0 and t1 during a portion of execution in which the AI agent navigates to a configuration panel and identifies a toggle control.

Stream B includes a first segment 610, a second segment 612, a third segment 614, and an Nth segment 616. The first segment 610 spans the time interval from t0 to t1. The second segment 612 spans the time interval from t1 to t2. The third segment 614 spans the time interval from t2 to t3. The Nth segment 616 spans the time interval from tn−1 to tn. Each segment in Stream B contains reasoning data generated during the corresponding time interval. For example, the first segment 610 may contain a semantic interpretation of a toggle control, a classification confidence level, an alternative interpretation considered, and a decision criterion applied by the AI agent during the same interval from t0 to t1 in which the first segment 602 of Stream A was captured.

As indicated in the figure by the paired relationships between corresponding upper and lower segments, the first segment 602 is paired with the first segment 610, the second segment 604 is paired with the second segment 612, the third segment 606 is paired with the third segment 614, and the Nth segment 608 is paired with the Nth segment 616. Each such pair shares the same time interval along the common time reference 620 and corresponds to the same portion of execution of the automated task. The pairing enables one-to-one correspondence between observational content in Stream A and reasoning content in Stream B for each segment interval.

The common time reference 620 partitions both streams at the same temporal boundaries t0, t1, t2, t3, through tn−1 and tn. Because both Stream A and Stream B are segmented against the same common time reference 620, each segment of the observational record has a corresponding segment of the reasoning log covering the same execution interval. In some embodiments, the shared temporal boundaries are imposed during synchronized capture rather than reconstructed after capture.

The temporal pairing architecture 600 further includes an integrity check 618. The integrity check 618 operates following capture of the Nth segment 608 and the Nth segment 616. The integrity check 618 validates that each segment in Stream A has a corresponding segment in Stream B and that no segment in either stream lacks a counterpart. If the integrity check 618 detects a missing segment in Stream A without a corresponding segment in Stream B, or a missing segment in Stream B without a corresponding segment in Stream A, the integrity check 618 flags the execution as incomplete. For example, if the interaction recording module 416 captured a final observational segment for a particular time interval but the reasoning capture module 418 did not generate a corresponding reasoning segment for that same interval, the integrity check 618 identifies the gap and generates a notification indicating that temporal pairing is incomplete for that portion of the execution. In some embodiments, the integrity check 618 generates an integrity indicator stored as part of a session record 424.

In some embodiments, the integrity check 618 further generates a cryptographic hash value for each verified segment pair. For each pair comprising a segment of the observational record in Stream A and a corresponding segment of the log in Stream B, the integrity check 618 computes a hash value over the combined contents of the paired segments, including the observational data of the segment in Stream A and the reasoning data of the corresponding segment in Stream B. The hash value for each segment pair binds the observational content and the reasoning content of that pair together, such that any alteration to either the observational data or the reasoning data of an individual segment pair causes the hash value for that pair to change. In a further embodiment, the hash values for successive segment pairs are chained sequentially, such that the hash value for each segment pair incorporates the hash value of the preceding segment pair. The sequential chaining produces a cryptographic chain across the temporal sequence of segment pairs within a single execution, enabling verification that no individual segment pair has been altered, reordered, inserted, or removed after capture. The per-segment-pair hash values and the cryptographic chain may be stored as part of the integrity indicator generated by the integrity check 618 and included in the session record 424.

The temporal pairing architecture 600 operates at a configurable segment granularity. In one implementation, each segment corresponds to a fixed time interval, for example one second or five seconds, producing uniform segment lengths across both streams. In another implementation, each segment corresponds to a single interaction event, for example one click or one text entry, producing variable-length segments aligned to a natural cadence of actions performed by the AI agent. In a further implementation, each segment corresponds to a logical phase of the automated task, for example a navigation phase, a configuration phase, and a verification phase, producing coarse-grained segments aligned to task structure. The segment granularity determines a resolution at which the observational record and the log can be correlated during subsequent replay and analysis. Finer granularity provides more precise correlation between visual activity and reasoning, while coarser granularity reduces storage overhead and simplifies retrieval.

The temporal pairing architecture 600 enables several downstream operations. A reviewer conducting compliance verification can select any interval along the common time reference 620 and retrieve the corresponding segment pair from Stream A and Stream B, thereby observing simultaneously what interface state the AI agent encountered and what reasoning the AI agent applied during that interval. A model training pipeline can isolate a specific segment pair, for example the third segment 606 and the third segment 614, where the AI agent misinterpreted a user interface element, and use that segment pair as a targeted training sample for corrective fine-tuning. A diagnostic tool can scan results of the integrity check 618 across multiple executions and identify patterns of segment loss or desynchronization that may indicate performance degradation in the interaction recording module 416 or the reasoning capture module 418.

### Vision-Language Reasoning Architecture

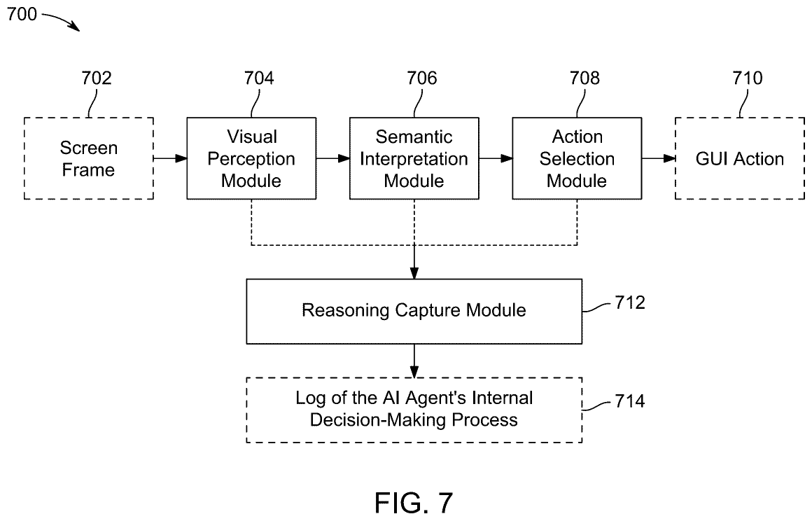

FIG. 7 illustrates a vision-language reasoning architecture 700 of the AI agent 404. The vision-language reasoning architecture 700 comprises three modules that operate in sequence to perceive, interpret, and act on user interface elements rendered on the GUI 408 of the software application 406 during execution of the automated task. The reasoning capture module 712 records an output of each module at each interaction, thereby producing the log 714 of the AI agent's internal decision-making process.

The vision-language reasoning architecture 700 receives a screen frame 702 as input. The screen frame 702 is a captured image of the rendered graphical output 410 of the GUI 408 at a given moment during execution of the automated task. The screen frame 702 represents an interface state as visually rendered on a display device or a virtual display buffer at that moment. The screen frame 702 may be a single image captured at a point in time or a frame extracted from a continuous video stream. In one implementation, the screen frame 702 is a full-resolution screenshot of the entire GUI 408. In another implementation, the screen frame 702 is a cropped region of the GUI 408 corresponding to an active panel or dialog box.

The screen frame 702 is passed to a visual perception module 704. The visual perception module 704 is configured to detect and classify user interface elements rendered on the GUI 408 using computer vision. The visual perception module 704 processes the screen frame 702 and identifies locations, boundaries, and types of user interface elements present in the screen frame 702. The user interface elements detected by the visual perception module 704 include text input fields, toggle controls, dropdown menus, navigation buttons, configuration panels, form submission controls, and modal dialog boxes. For each detected user interface element, the visual perception module 704 generates a bounding region identifying a spatial location of the element within the screen frame 702 and a classification label identifying a type of the element. For example, the visual perception module 704 may detect a rectangular region at coordinates (245, 310) to (420, 340) in the screen frame 702 and classify the region as a toggle control.

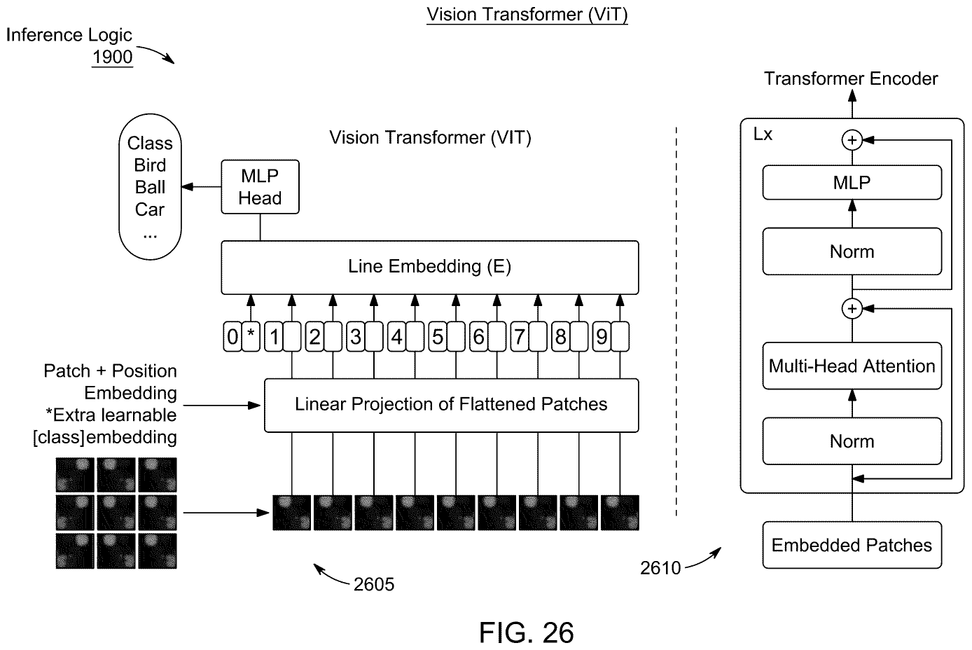

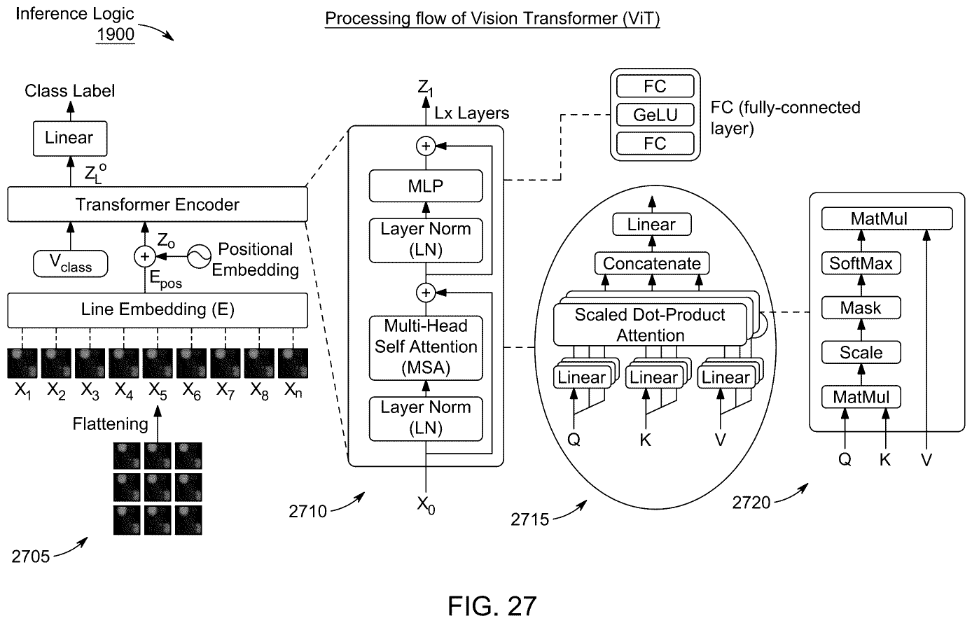

The visual perception module 704 may employ a Vision Transformer (ViT) model or a deep convolutional neural network (CNN). When a ViT model is employed, the visual perception module 704 processes the screen frame 702 as a sequence of image patches. Each image patch is a fixed-size sub-region of the screen frame 702. The ViT model applies positional encoding to each patch, processes the sequence of encoded patches through a plurality of transformer encoder layers, and produces a set of contextualized embeddings representing spatial and semantic relationships among the patches. The visual perception module 704 uses the contextualized embeddings to detect and classify user interface elements across the full screen frame 702. When a deep CNN is employed, the visual perception module 704 processes the screen frame 702 through a sequence of convolutional layers, pooling layers, and fully connected layers to extract hierarchical visual features and produce element-level detection and classification outputs. The architecture of the ViT model and the transformer encoder layers is described in further detail in connection with FIGS. 26 and 27.

The output of the visual perception module 704 is passed to a semantic interpretation module 706. The semantic interpretation module 706 is configured to generate textual interpretations of detected user interface elements and associated labels using a language model. The semantic interpretation module 706 receives detected elements, classification labels of the detected elements, and surrounding textual content extracted from the screen frame 702, and generates a natural-language description of an identity and function of each detected element. The language model employed by the semantic interpretation module 706 processes element-label text, adjacent headings, tooltip text, and contextual cues visible in the screen frame 702 to determine a semantic meaning of each detected element within an operational context of the software application 406.

For each detected user interface element, the semantic interpretation module 706 generates a semantic interpretation record. The semantic interpretation record comprises a primary natural-language description of the detected user interface element's identity and function, a classification confidence level indicating certainty in the primary natural-language description, and at least one alternative interpretation considered by the language model together with a criterion by which the primary natural-language description was selected over the alternative. For example, the visual perception module 704 may detect a toggle control labeled “Require multi-factor authentication” within a section headed “Multi-Factor Authentication.” The semantic interpretation module 706 generates a primary interpretation of “multi-factor authentication enablement toggle” at a confidence level of 0.92, an alternative interpretation of “general account security preference toggle” at a confidence level of 0.71, and a selection criterion of “contextual section heading reads Multi-Factor Authentication.” The primary interpretation is selected because the contextual section heading provides stronger semantic alignment than the element label alone.

The output of the visual perception module 704 and the output of the semantic interpretation module 706 are both passed to an action selection module 708. The action selection module 708 is configured to determine an action to be executed based on outputs of the visual perception module 704 and the semantic interpretation module 706. The action selection module 708 evaluates detected user interface elements, semantic interpretations, and an applicable policy or task objective to select a specific interaction from among alternatives available at the GUI 408 at that moment. The action selection module 708 generates a decision criterion recording a basis on which the selected interaction was chosen over alternative interactions. For example, the action selection module 708 may determine that the toggle control interpreted as “multi-factor authentication enablement toggle” should be set to the “on” position based on a security baseline policy requiring multi-factor authentication to be enabled. The action selection module 708 records the selected interaction, namely set toggle to on, the criterion applied, namely security baseline policy compliance, and an alternative interaction rejected, namely no action, which would leave the current non-compliant state unchanged.

The action selection module 708 produces a GUI action 710. The GUI action 710 is the specific interaction that the AI agent 404 executes on the GUI 408 in response to outputs of the visual perception module 704 and the semantic interpretation module 706. The GUI action 710 may be a mouse click on a toggle control, a text entry into an input field, a selection from a dropdown menu, a navigation to a different interface section, or a form submission. The GUI action 710 is transmitted to the GUI 408 for execution. Following execution of the GUI action 710, the AI agent 404 may perform a verification step to determine whether a resulting interface state corresponds to an expected post-action interface state. If the resulting interface state does not correspond to the expected state, the AI agent 404 may initiate a corrective action.

The reasoning capture module 712 is communicatively coupled to the visual perception module 704, the semantic interpretation module 706, and the action selection module 708. The reasoning capture module 712 records an output of each of the three modules at each interaction during execution of the automated task. The reasoning capture module 712 produces the log 714 of the AI agent's internal decision-making process. For each interaction, the log 714 contains detected user interface elements and classifications of the detected user interface elements from the visual perception module 704, a semantic interpretation record from the semantic interpretation module 706, a decision criterion and a selected interaction from the action selection module 708, and, where applicable, a verification outcome and any corrective action. Each entry in the log 714 corresponds to a single interaction and is temporally aligned with a corresponding segment of the observational record, as described in connection with the temporal pairing architecture of FIG. 6.

The vision-language reasoning architecture 700 operates iteratively during execution of the automated task. For each interaction performed by the AI agent 404, a new screen frame 702 is captured, processed through the visual perception module 704, interpreted by the semantic interpretation module 706, evaluated by the action selection module 708, and recorded by the reasoning capture module 712. A number of iterations corresponds to a number of interactions performed by the AI agent 404 during execution. For a simple task involving a single toggle modification, the vision-language reasoning architecture 700 may execute a small number of iterations. For a complex task involving navigation across multiple interface sections, form entries, and sequential configuration changes, the vision-language reasoning architecture 700 may execute dozens or hundreds of iterations. Each iteration produces one entry in the log 714 and one corresponding segment in the observational record.

### Semantic Interpretation Record Structure

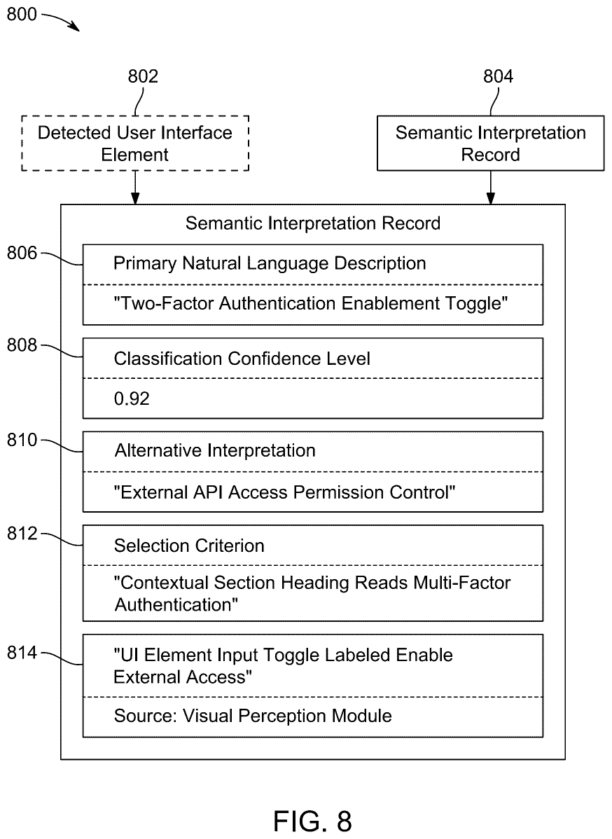

FIG. 8 illustrates a semantic interpretation record structure 800 generated by the semantic interpretation module 706 for a detected user interface element 802. The semantic interpretation record structure 800 depicts data fields that the semantic interpretation module 706 produces for a user interface element detected by the visual perception module 704 during execution of an automated task. The semantic interpretation record structure 800 represents a single entry within the log 714 of the AI agent's internal decision-making process.

The semantic interpretation record structure 800 begins with a detected user interface element 802. The detected user interface element 802 is a user interface element that the visual perception module 704 has identified and classified within a screen frame 702 captured from the rendered graphical output 410 of the GUI 408. The detected user interface element 802 represents an interface control or other interface element as detected from the rendered display. In the example depicted in FIG. 8, the detected user interface element 802 is a toggle control that is later represented in the semantic interpretation record using the example UI-element input shown at 814.

The detected user interface element 802 is processed by the semantic interpretation module 706 to produce a semantic interpretation record 804. The semantic interpretation record 804 is a structured data object comprising a plurality of fields. In the example depicted in FIG. 8, the semantic interpretation record 804 includes a primary natural language description 806, a classification confidence level 808, an alternative interpretation 810, a selection criterion 812, and an input-and-source field 814.

The primary natural language description 806 is a natural language statement describing an identity and function of the detected user interface element 802 as determined by a language model of the semantic interpretation module 706. The primary natural language description 806 represents a highest-confidence assessment of what the detected user interface element 802 is and what the detected user interface element 802 does within a context of the software application 406. The primary natural language description 806 is not merely a repetition of visible label text of the element. Rather, the primary natural language description 806 is a contextually informed interpretation that accounts for surrounding headings, adjacent labels, section context, and an operational domain of the software application 406. In the example depicted in FIG. 8, the primary natural language description 806 reads “Two-Factor Authentication Enablement Toggle.”

The classification confidence level 808 is a numerical value indicating a certainty level of the semantic interpretation module 706 in the primary natural language description 806. The classification confidence level 808 may be expressed as a value between 0 and 1, where a value closer to 1 indicates higher certainty. In the example depicted in FIG. 8, the classification confidence level 808 is 0.92, indicating that the semantic interpretation module 706 assigns a high degree of confidence to the primary natural language description 806. The classification confidence level 808 provides a quantitative basis for downstream processes to assess reliability of the semantic interpretation. For example, a compliance reviewer examining the log 714 may identify interactions where the classification confidence level 808 falls below a predefined threshold and flag those interactions for manual review. In another example, a model training pipeline may assign greater corrective priority to interactions for which the classification confidence level 808 is relatively low.

The alternative interpretation 810 is at least one additional interpretation that the language model of the semantic interpretation module 706 considered for the detected user interface element 802 before selecting the primary natural language description 806. The alternative interpretation 810 represents a competing hypothesis about the identity and function of the detected user interface element 802. In the example depicted in FIG. 8, the alternative interpretation 810 reads “External API Access Permission Control.” The semantic interpretation module 706 therefore considered the possibility that the detected user interface element 802 corresponded to an access-permission control rather than a two-factor-authentication control. In some embodiments, the semantic interpretation record 804 may contain more than one alternative interpretation together with associated ranking or confidence information.

The selection criterion 812 is a criterion by which the primary natural language description 806 was selected over the alternative interpretation 810. The selection criterion 812 records reasoning applied by the semantic interpretation module 706 in choosing the primary interpretation from among candidate interpretations. In the example depicted in FIG. 8, the selection criterion 812 reads “Contextual Section Heading Reads Multi-Factor Authentication.” The semantic interpretation module 706 therefore selected the primary natural language description 806 over the alternative interpretation 810 based on contextual evidence provided by a section heading. The selection criterion 812 may reference various types of contextual evidence including section headings, adjacent label text, tooltip content, breadcrumb navigation paths, form-field groupings, and spatial proximity to related elements.

The input-and-source field 814 records example input information associated with the detected user interface element 802 and a provenance of that input within the vision-language reasoning architecture 700. In the example depicted in FIG. 8, the field 814 includes the text “UI Element Input Toggle Labeled Enable External Access” and also includes the source indication “Source: Visual Perception Module.” Thus, the field 814 reflects example source content received from the visual perception module 704 and used by the semantic interpretation module 706 in generating the semantic interpretation record 804. Unlike the detected user interface element 802 itself, which is the input element being interpreted, the field 814 is part of the semantic interpretation record 804 and documents source material and provenance for that record.

The semantic interpretation record 804 is generated for each detected user interface element 802 that the AI agent 404 interacts with during execution of the automated task. When the AI agent 404 encounters a screen containing multiple user interface elements, the semantic interpretation module 706 may generate a separate semantic interpretation record 804 for each element that the AI agent 404 selects or considers. A collection of semantic interpretation records 804 across interactions during execution constitutes a semantic interpretation component of the log 714.

The semantic interpretation record 804 serves multiple purposes within the system 400. During compliance verification, a reviewer may examine the semantic interpretation record 804 to determine whether the AI agent 404 correctly identified the detected user interface element 802 before acting on that element. If the primary natural language description 806 is incorrect, the reviewer can identify the misinterpretation and the selection criterion 812 that led to the misinterpretation. During model training, the semantic interpretation record 804 provides a labeled example that a training pipeline may use for supervised fine-tuning. If the AI agent 404 selected a correct primary interpretation, the semantic interpretation record 804 serves as a positive training example. If the AI agent 404 selected an incorrect primary interpretation, the semantic interpretation record 804 serves as a corrective training example, and a correct alternative interpretation may be annotated as ground truth for fine-tuning. During diagnostic analysis, the classification confidence level 808 across multiple executions may be aggregated to identify user interface elements or software applications 406 for which the AI agent 404 consistently exhibits low confidence, thereby indicating a need for additional training data or model adjustment.

### Verification Step Architecture

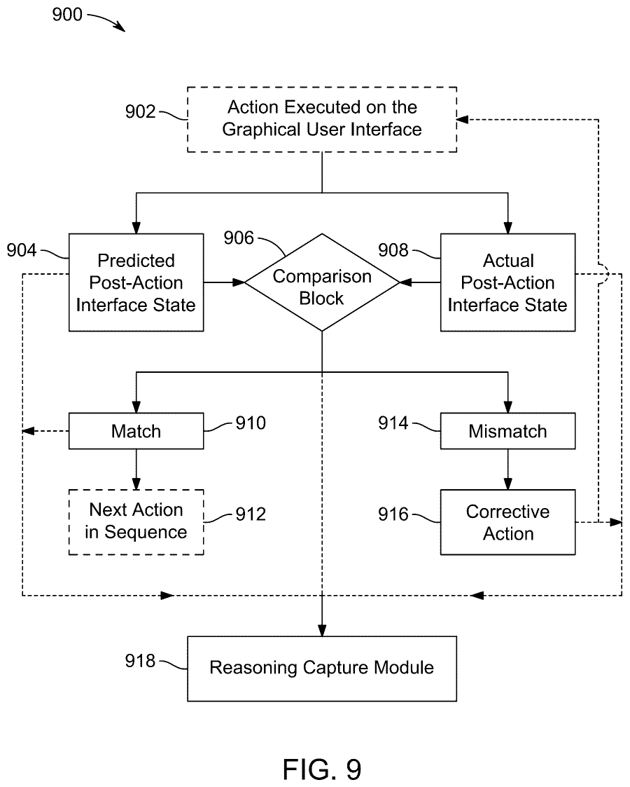

FIG. 9 illustrates a verification step architecture 900 performed by the AI agent 404 following an action executed during execution of an automated task. The verification step architecture 900 includes an action executed on the graphical user interface 902, a predicted post-action interface state 904 generated before or in connection with execution of the action, a comparison block 906, an actual post-action interface state 908 detected after execution of the action, a match outcome 910, a next action in sequence 912, a mismatch outcome 914, a corrective action 916, and a reasoning capture module 918. The comparison block 906 receives the predicted post-action interface state 904 and the actual post-action interface state 908 as comparison inputs and determines whether the actual post-action interface state 908 corresponds to the predicted post-action interface state 904. The reasoning capture module 918 records the predicted post-action interface state 904, the actual post-action interface state 908, the comparison result generated by the comparison block 906, and any next action or corrective action selected in response to the comparison result in the log 714 of the AI agent's internal decision-making process.

The verification step architecture 900 begins with the action executed on the graphical user interface 902. The action executed on the graphical user interface 902 is a GUI action that the action selection module 708 determined and that the AI agent 404 performed on the GUI 408 of the software application 406. The action executed on the graphical user interface 902 may be a click on a toggle control, a text entry into an input field, a selection from a dropdown menu, a form submission, or a navigation to a different interface section. For example, the action executed on the graphical user interface 902 may be a click that sets a toggle control labeled Enable External Access to an off position within a security configuration panel.

Prior to executing the action, or as part of selecting the action for execution, the AI agent 404 generates the predicted post-action interface state 904. The predicted post-action interface state 904 represents an interface state that the AI agent 404 expects to observe on the GUI 408 following execution of the action. The predicted post-action interface state 904 is generated by the action selection module 708 based on a semantic interpretation of a user interface element, a nature of the action to be performed, and a current interface state. For example, if the AI agent 404 clicks a toggle control from an on position to an off position, the predicted post-action interface state 904 may specify that the toggle control appears in the off position, a status indicator adjacent to the toggle control reads Disabled, and visual styling of the toggle control changes from an active color to an inactive color. The predicted post-action interface state 904 may include one or more of an expected element state, an expected label change, an expected visual indicator, an expected page transition, and an expected confirmation message. In some embodiments, the predicted post-action interface state 904 is recorded in the log 714 before the action is executed, thereby preserving the AI agent's expectation for subsequent comparison.

Following execution of the action on the GUI 408, the visual perception module 704 captures a new screen frame 702 and detects a resulting interface state from the rendered graphical output 410. The resulting interface state constitutes the actual post-action interface state 908. The actual post-action interface state 908 represents the interface state that the visual perception module 704 observes on the GUI 408 after the action has been executed. The actual post-action interface state 908 is supplied to the comparison block 906 as an input for comparison against the predicted post-action interface state 904. For example, following a toggle click, the visual perception module 704 may capture a new screen frame 702 and detect that the toggle control now appears in the off position with a status indicator reading Disabled.

In a further example, the actual post-action interface state 908 may indicate that the software application 406 has presented an authentication prompt, a multi-factor authentication dialog, or a visual verification challenge that the AI agent 404 cannot resolve autonomously. In response to the mismatch 914, the corrective action 916 may comprise pausing execution of the automated task and awaiting input from a human operator. The AI agent 404, through the semantic interpretation module 706, generates a semantic interpretation of the authentication prompt, including a classification confidence level and a description of the element detected. The action selection module 708 determines that autonomous resolution is not available for the detected element and selects the corrective action of pausing execution. The reasoning capture module 918 records the corrective action 916 in the log 714, including the semantic interpretation of the authentication prompt, the decision criterion for pausing, and a status indicating that the AI agent 404 has paused execution. During the period of the pause, the interaction recording module 416 continues capturing the rendered graphical output 410, thereby recording visual changes to the graphical user interface 408 caused by the human operator's interactions, such as credential entry, button selections, or dialog dismissals. When the human operator completes the required interaction and the graphical user interface 408 transitions to a post-authentication state, the visual perception module 704 detects the resulting interface state change. The AI agent 404 resumes execution of the automated task, and the reasoning capture module 918 records the resumption in the log 714, including a semantic interpretation of the post-authentication interface state and a determination that the authentication requirement has been satisfied. The temporal pairing 420 between the observational record and the log is maintained across the pause period, such that segments of the observational record captured during the human operator's interaction correspond to segments of the log reflecting the AI agent's pause state and monitoring observations during the same portion of execution.

The comparison block 906 receives the predicted post-action interface state 904 and the actual post-action interface state 908 as inputs. The comparison block 906 determines whether the actual post-action interface state 908 corresponds to the predicted post-action interface state 904. The comparison block 906 evaluates correspondence by comparing expected element states, labels, visual indicators, and page structures specified in the predicted post-action interface state 904 against corresponding attributes detected in the actual post-action interface state 908. The comparison block 906 produces one of two outcomes: a match 910 or a mismatch 914.

A match 910 occurs when the actual post-action interface state 908 corresponds to the predicted post-action interface state 904. The match 910 indicates that the action executed on the graphical user interface 902 produced the expected interface state. When the comparison block 906 produces a match 910, the verification step architecture 900 proceeds to the next action in sequence 912. The next action in sequence 912 represents a subsequent interaction that the AI agent 404 performs as part of the automated task. The AI agent 404 may then capture a new screen frame 702 and the vision-language reasoning architecture 700 may begin a next iteration of perception, interpretation, and action selection. For example, after verifying that a toggle control is now in the off position and that a status indicator reads “Disabled,” the AI agent 404 may proceed to a next configuration element in a security settings panel.

A mismatch 914 occurs when the actual post-action interface state 908 does not correspond to the predicted post-action interface state 904. The mismatch 914 indicates that the action executed on the graphical user interface 902 did not produce the expected interface state. A mismatch 914 may arise from several causes. The software application 406 may present an error dialog in response to the action. The user interface element may fail to change state due to a permission restriction. A page may reload or navigate to an unexpected location. The element may change position or label during the action due to a dynamic interface update. When the comparison block 906 produces a mismatch 914, the verification step architecture 900 proceeds to a corrective action 916.

The corrective action 916 is an action initiated by the AI agent 404 in response to the mismatch 914. The corrective action 916 represents the AI agent's response to an unexpected interface state. The corrective action 916 may include retrying the same action on the same user interface element, navigating to a parent settings page and locating the element from a different entry point, scrolling the interface to locate a repositioned element, dismissing an error dialog and reattempting the action, or selecting an alternative user interface element that achieves a same functional outcome through a different interaction path. For example, if the AI agent 404 attempted to set a toggle to an off position but the actual post-action interface state 908 shows that a permissions dialog appeared instead of the expected state change, the corrective action 916 may involve dismissing the permissions dialog, navigating to an administrator settings page, elevating access permissions, and then returning to the original toggle to reattempt the action. In another example, if the toggle control has been repositioned during a dynamic interface update and the actual post-action interface state 908 shows no change at expected coordinates, the corrective action 916 may involve the visual perception module 704 rescanning the full screen frame 702 to locate the repositioned toggle control and executing a click at a new location. In some embodiments, execution of the corrective action 916 leads to a further action executed on the graphical user interface 902, thereby continuing the verification cycle during the same automated task.

The reasoning capture module 918 records the complete verification step in the log 714. For each action executed during execution of the automated task, the reasoning capture module 918 records the predicted post-action interface state 904 representing an interface state expected by the AI agent 404 following the executed action, the actual post-action interface state 908 detected by the visual perception module 704 after the action was executed, a determination of whether the actual post-action interface state 908 corresponds to the predicted post-action interface state 904, and, where the actual and predicted states do not correspond, a description of the corrective action 916 initiated by the AI agent 404 in response. The reasoning capture module 918 may also record fallback actions considered by the AI agent 404. A fallback action is an alternative action that the AI agent 404 evaluated as a potential response to the mismatch 914 but did not execute because the corrective action 916 resolved the mismatch first. For example, the AI agent 404 may have considered navigating to a parent settings page as a fallback action but did not execute that fallback action because dismissing an error dialog and retrying the original action succeeded. The fallback action considered may be recorded in the log 714 together with a status indicating whether the fallback action was executed or not required.

The verification step architecture 900 operates iteratively at each interaction during execution of the automated task. For each GUI action 710 produced by the action selection module 708, the AI agent 404 generates the predicted post-action interface state 904, executes the action, captures the actual post-action interface state 908 through the visual perception module 704, and evaluates correspondence through the comparison block 906. If a match 910 is detected, the AI agent 404 proceeds to the next action in sequence 912. If a mismatch 914 is detected, the AI agent 404 initiates the corrective action 916 and may then re-enter the execution-and-verification cycle. The reasoning capture module 918 records the verification step for each iteration. The resulting verification records in the log 714 provide a trace of each moment at which the AI agent 404 confirmed a successful action and each moment at which the AI agent 404 detected and responded to an unexpected interface state. A compliance reviewer examining the log 714 can identify a specific interaction at which a mismatch 914 occurred, inspect the predicted and actual interface states, review the corrective action 916 taken, and assess whether the AI agent's response was appropriate. A model training pipeline can isolate verification steps that produced mismatches 914, extract the predicted and actual interface states as labeled training data, and use the data for targeted fine-tuning to improve the AI agent's prediction accuracy for post-action interface states in similar interface contexts.

### Initiating Event Architecture

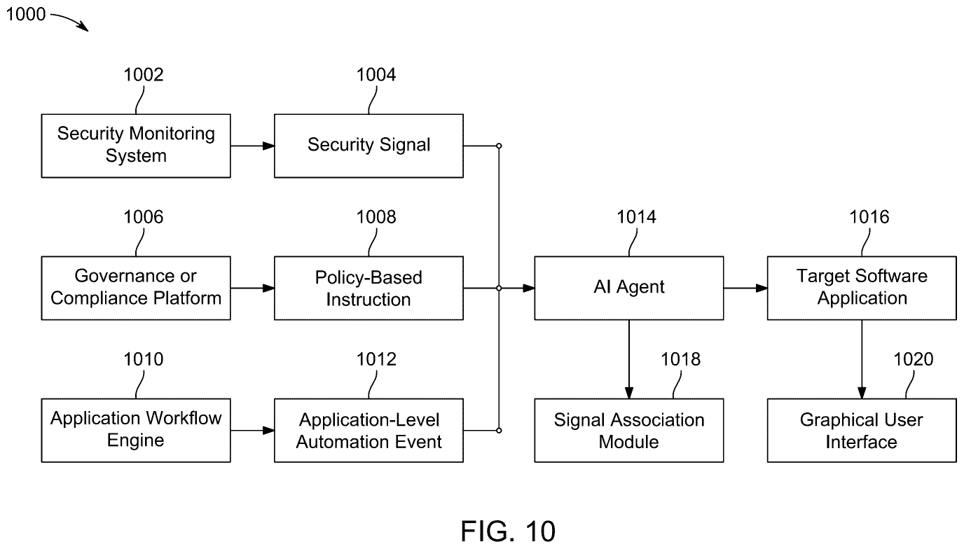

FIG. 10 illustrates an initiating event architecture 1000 depicting three types of initiating events that cause the AI agent 1014 to begin execution of an automated task on a graphical user interface 1020 of a target software application 1016. The initiating event architecture 1000 shows three distinct origination paths that converge on the AI agent 1014. The three origination paths correspond to three types of initiating events: a security signal 1004, a policy-based instruction 1008, and an application-level automation event 1012. The AI agent 1014 is further coupled to a signal association module 1018, which associates a resulting observational record and a resulting log with the initiating event, as described in further detail with reference to FIG. 4.

A first origination path begins at a security monitoring system 1002. The security monitoring system 1002 is a computing system configured to monitor a configuration state, access policies, and security posture of one or more enterprise software applications on a continuous or periodic basis. The security monitoring system 1002 may be implemented as a security information and event management (SIEM) platform, a cloud security posture management (CSPM) tool, a configuration compliance scanner, or a real-time threat detection engine. The security monitoring system 1002 evaluates a configuration state of the target software application 1016 against a set of predefined security policies, compliance baselines, or organizational standards. When the security monitoring system 1002 detects a deviation from an expected configuration state, the security monitoring system 1002 generates the security signal 1004.

The security signal 1004 is generated by the security monitoring system 1002 upon detection of a non-compliant configuration state or policy anomaly in the target software application 1016. A non-compliant configuration state is a state in which a security setting, access control, or configuration parameter of the target software application 1016 does not conform to an applicable security policy or compliance baseline. A policy anomaly is a deviation from an expected policy condition that may indicate a security vulnerability, an unauthorized modification, or a configuration drift. For example, the security monitoring system 1002 may detect that a two-factor authentication setting in a cloud-based customer relationship management application has been disabled, that a file-sharing permission has been set to public access, that an administrative account password has not been rotated within a required interval, or that an access control list has been modified to grant elevated privileges to an unauthorized user group. Each of these conditions constitutes a non-compliant configuration state or policy anomaly that triggers generation of the security signal 1004. The security signal 1004 carries metadata identifying a type of anomaly detected, a specific configuration parameter involved, the target software application 1016 in which the anomaly was detected, and a timestamp indicating when the anomaly was detected.

The security signal 1004 is transmitted to the AI agent 1014. Upon receiving the security signal 1004, the AI agent 1014 begins execution of an automated task on the graphical user interface 1020 of the target software application 1016 to remediate the detected non-compliant configuration state or policy anomaly. For example, if the security signal 1004 indicates that two-factor authentication has been disabled, the AI agent 1014 navigates to a security settings panel of the target software application 1016, locates a two-factor authentication toggle control, and sets the toggle control to an enabled position. The security signal 1004 therefore serves as one initiating event that triggers the execution and capture pipeline.

A second origination path begins at a governance or compliance platform 1006. The governance or compliance platform 1006 is a computing system configured to enforce organizational policies, regulatory requirements, and compliance mandates across an enterprise software estate. The governance or compliance platform 1006 may be implemented as an identity governance and administration (IGA) platform, a governance, risk, and compliance (GRC) tool, a regulatory compliance management system, or a policy orchestration engine. The governance or compliance platform 1006 evaluates enterprise events such as employee onboarding, role changes, departmental transfers, access certification reviews, and regulatory audit findings, and generates instructions directing automated systems to perform corrective or provisioning actions in response.

The governance or compliance platform 1006 generates the policy-based instruction 1008. The policy-based instruction 1008 specifies a corrective action to be performed by the AI agent 1014 on the target software application 1016. The policy-based instruction 1008 is a structured directive that identifies the target software application 1016, a user or account affected, a specific action to be performed, and a policy justification for the action. For example, an IGA platform may detect that an employee has been transferred from an engineering department to a legal department and generate the policy-based instruction 1008 directing the AI agent 1014 to revoke the employee's access credentials in engineering-specific applications and to provision new credentials in legal department applications. In another example, a GRC tool may determine, following an access certification review, that a set of users retains access privileges that are no longer justified by current roles and generate the policy-based instruction 1008 directing the AI agent 1014 to revoke the excess privileges in each affected application. The policy-based instruction 1008 differs from the security signal 1004 in that the policy-based instruction 1008 originates from a governance decision rather than from detection of an anomalous state.

The policy-based instruction 1008 is transmitted to the AI agent 1014. Upon receiving the policy-based instruction 1008, the AI agent 1014 begins execution of the specified corrective action on the graphical user interface 1020 of the target software application 1016. The policy-based instruction 1008 therefore serves as another initiating event that triggers the capture and association pipeline for that execution.

A third origination path begins at an application workflow engine 1010. The application workflow engine 1010 is a computing system configured to orchestrate multi-step business processes, operational workflows, and application-level automation sequences across one or more enterprise software applications. The application workflow engine 1010 may be implemented as a business process management (BPM) platform, an information technology service management (ITSM) tool, a workflow automation platform, or a custom orchestration engine maintained by enterprise information-technology teams. The application workflow engine 1010 manages sequencing, scheduling, and execution of discrete workflow steps, each of which may involve interaction with a different software application or a different configuration parameter within a same software application.

The application workflow engine 1010 generates the application-level automation event 1012. The application-level automation event 1012 specifies a workflow step or configuration change to be executed by the AI agent 1014 on the target software application 1016. The application-level automation event 1012 is a structured event that identifies a workflow context, a specific step within a workflow, the target software application 1016, and a configuration change or action to be performed. For example, an ITSM tool may receive a ticket requesting rotation of an API key in a partner-hosted financial dashboard. Upon ticket approval, the ITSM tool generates the application-level automation event 1012 directing the AI agent 1014 to navigate to an API-key management page of the financial dashboard, generate a new API key, and update a corresponding credential-vault entry. In another example, a BPM platform managing a scheduled configuration review workflow may generate the application-level automation event 1012 directing the AI agent 1014 to verify and update specific configuration parameters across a set of enterprise applications. The application-level automation event 1012 differs from the security signal 1004 and the policy-based instruction 1008 in that the application-level automation event 1012 originates from a workflow context rather than from a security detection or a governance decision.

The application-level automation event 1012 is transmitted to the AI agent 1014. Upon receiving the application-level automation event 1012, the AI agent 1014 begins execution of the specified workflow step or configuration change on the graphical user interface 1020 of the target software application 1016. The application-level automation event 1012 therefore serves as a further initiating event that triggers the capture and association pipeline for that execution.

The AI agent 1014 depicted in FIG. 10 corresponds to the AI agent 404 described with reference to FIG. 4. Regardless of which origination path generated the initiating event, the AI agent 1014 performs the automated task by interacting directly with the graphical user interface 1020 of the target software application 1016. The AI agent 1014 perceives rendered interface content using computer vision, interprets the content using a language model, and selects actions using the vision-language reasoning architecture described with reference to FIG. 7. The target software application 1016 depicted in FIG. 10 corresponds to the software application 406 described with reference to FIG. 4. The graphical user interface 1020 corresponds to the GUI 408 described with reference to FIG. 4.

The three origination paths converge at the AI agent 1014. Following receipt of the initiating event and execution of the automated task by the AI agent 1014, event context associated with the initiating event is provided to the signal association module 1018. The signal association module 1018 corresponds to the association module 422 described with reference to FIG. 4. The signal association module 1018 associates both the observational record and the log of the internal decision-making process with the initiating event. The signal association module 1018 generates the session record 424 linking both artifacts to the initiating event by a reference identifier. The signal association module 1018 processes the security signal 1004, the policy-based instruction 1008, and the application-level automation event 1012 uniformly. Each type of initiating event may be tagged with a trigger classification identifying the type of the initiating event, an originating system identifier identifying the system that generated the initiating event, and session timestamps. The trigger classification and the originating system identifier may be stored as fields within the session record 424, thereby enabling downstream retrieval and filtering by initiating-event type or originating system.

In some embodiments, the initiating event architecture 1000 is not limited to the three origination paths depicted in FIG. 10. In other implementations, an initiating event may originate from additional sources such as a human administrator issuing a manual command through a command-line utility, a partner organization transmitting a callback through an integration gateway, a directory service detecting a group-membership change, or a scheduled script executing at a predetermined interval. Each such additional source constitutes an initiating event that causes the AI agent 1014 to begin execution of an automated task and that triggers the concurrent capture and association operations of the system 400. The three origination paths depicted in FIG. 10 represent primary categories of initiating events encountered in enterprise identity governance, security remediation, and application workflow contexts.

### Session Record Schema

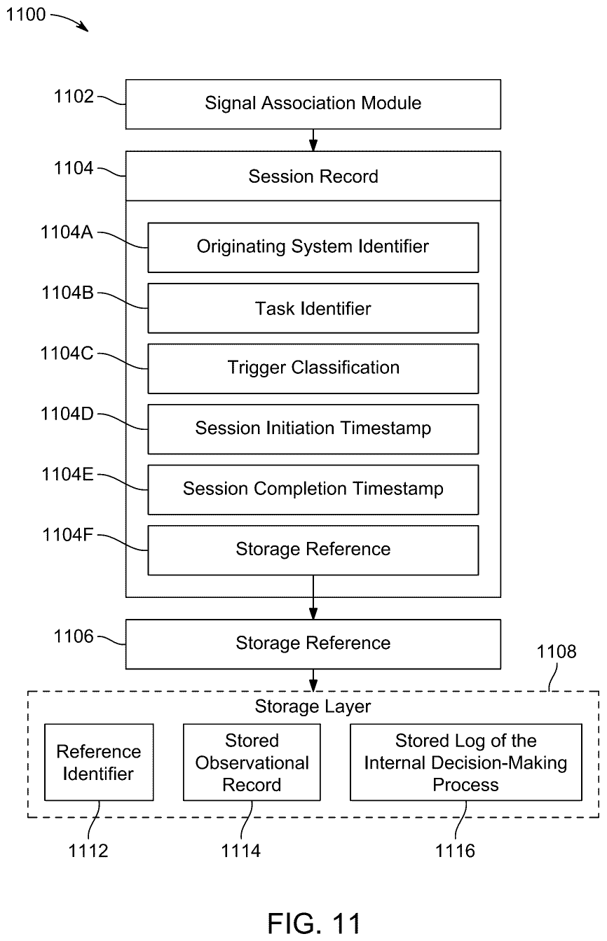

FIG. 11 illustrates a session record schema 1100 depicting a structure of a session record 1104 generated by a signal association module 1102 and a relationship between the session record 1104 and stored artifacts in a storage layer 1108. The session record schema 1100 shows how the signal association module 1102 links both an observational record and a log of an internal decision-making process to an initiating event by a reference structure that enables retrieval of both artifacts from persistent storage. In some embodiments, the signal association module 1102 corresponds to the association module 422 described with reference to FIG. 4.

The signal association module 1102 receives the observational record from the interaction recording module 416, the log from the reasoning capture module 418, and the initiating event 402. The signal association module 1102 processes these inputs and generates the session record 1104. The session record 1104 is a structured data object comprising a plurality of metadata fields. Each metadata field captures a specific attribute of execution of an automated task and of the initiating event that triggered the execution. As depicted in FIG. 11, the session record 1104 contains six metadata fields.

A first metadata field is an originating system identifier 1104A. The originating system identifier 1104A identifies a system that generated the initiating event 402. For example, if the initiating event 402 was a security signal generated by a security information and event management platform, the originating system identifier 1104A records an identity of that platform. If the initiating event 402 was a policy-based instruction generated by an identity governance platform, the originating system identifier 1104A records an identity of that platform. If the initiating event 402 was an application-level automation event generated by an information-technology service-management tool, the originating system identifier 1104A records an identity of that tool. The originating system identifier 1104A enables downstream filtering and retrieval of session records by originating system.

A second metadata field is a task identifier 1104B. The task identifier 1104B uniquely identifies execution of the automated task. Each execution of an automated task by the AI agent 404 receives a distinct task identifier 1104B, and no two executions share the same task identifier 1104B. The task identifier 1104B may be implemented as a universally unique identifier, a sequential numerical identifier, a hash-based identifier derived from execution parameters and timestamp, or another identifier format that provides uniqueness within the storage layer 1108. The task identifier 1104B serves as a principal identifier by which the session record 1104 and associated artifacts may be retrieved from storage.

A third metadata field is a trigger classification 1104C. The trigger classification 1104C identifies a type of the initiating event 402. The trigger classification 1104C indicates whether the initiating event 402 was, for example, a security signal, a policy-based instruction, or an application-level automation event. The trigger classification 1104C enables categorization of session records by trigger type, which supports audit reporting, trend analysis, and compliance documentation.

A fourth metadata field is a session initiation timestamp 1104D. The session initiation timestamp 1104D records a date and time at which the AI agent 404 began execution of the automated task in response to the initiating event 402. The session initiation timestamp 1104D is recorded when the AI agent 404 starts interacting with the GUI 408 of the software application 406.

A fifth metadata field is a session completion timestamp 1104E. The session completion timestamp 1104E records a date and time at which the AI agent 404 completed execution of the automated task. The session initiation timestamp 1104D and the session completion timestamp 1104E together define a temporal window of the execution. A difference between the session completion timestamp 1104E and the session initiation timestamp 1104D represents a duration of the execution. In some embodiments, that duration is used by diagnostic tools to identify executions that took longer than expected, which may indicate interface-navigation difficulties, repeated corrective actions, or performance degradation in the target software application 406.

A sixth metadata field is a storage reference 1104F. The storage reference 1104F links the metadata of the session record 1104 to stored artifacts in the storage layer 1108. The storage reference 1104F contains location information, a path, a pointer, a key, or another addressing structure by which both the stored observational record 1114 and the stored log 1116 can be accessed within the storage layer 1108. The storage reference 1104F therefore implements a bi-artifact association between the session record 1104 and the stored artifacts corresponding to the same execution.

As further shown in FIG. 11, the session record 1104 outputs to a storage reference 1106. The storage reference 1106 represents a downstream reference object or reference output derived from the session record 1104 and used to access stored artifacts in the storage layer 1108. In some embodiments, the storage reference 1106 is generated from, or corresponds to, the storage reference field 1104F of the session record 1104. The storage reference 1106 provides linkage from the session record 1104 to data stored in the storage layer 1108.

The storage layer 1108 is a persistent storage system that holds a reference identifier 1112, a stored observational record 1114, and a stored log 1116 of the internal decision-making process. The storage layer 1108 may be implemented as a file system, an object store, a database, or a distributed storage architecture. Within the storage layer 1108, the stored observational record 1114 and the stored log 1116 are separate artifacts corresponding to the same execution. The stored observational record 1114 contains an observational record of interactions performed by the AI agent 404 with the GUI 408 during execution of the automated task. The stored log 1116 contains the log of the internal decision-making process corresponding to those interactions.

The reference identifier 1112 is stored in the storage layer 1108 and functions as an addressable linkage element associated with the stored artifacts. In some embodiments, the reference identifier 1112 incorporates, directly or indirectly, information derived from the task identifier 1104B, the originating system identifier 1104A, the trigger classification 1104C, the session initiation timestamp 1104D, the session completion timestamp 1104E, and the storage reference 1104F. The reference identifier 1112 thereby enables downstream retrieval of the stored observational record 1114 and the stored log 1116 as artifacts associated with the same execution session.

The three-element structure at a lower portion of FIG. 11, comprising the reference identifier 1112, the stored observational record 1114, and the stored log 1116, depicts a bi-artifact retrieval mechanism. The reference identifier 1112 serves as a bridge between the metadata captured in the session record 1104 and the stored artifacts in the storage layer 1108. An authorized entity requesting a compliance review may provide the task identifier 1104B or another query parameter associated with the session record 1104. The system may then retrieve the corresponding session record 1104, obtain the storage reference 1106 and the reference identifier 1112, and retrieve both the stored observational record 1114 and the stored log 1116 as a paired set of artifacts associated with the same execution.

The session record schema 1100 supports multiple downstream retrieval and analysis operations. In some embodiments, session records may be queried by task identifier 1104B, by originating system identifier 1104A, by trigger classification 1104C, or by a time range defined by the session initiation timestamp 1104D and the session completion timestamp 1104E. Such retrieval flexibility supports different downstream use cases. For example, a compliance auditor may query by trigger classification and date range, a model training pipeline may query by task identifier to retrieve artifacts for targeted fine-tuning, and a diagnostic tool may query by originating system identifier to analyze performance of executions initiated by a particular platform. These retrieval operations are supported by the schema, although not all such query paths are expressly depicted in FIG. 11.

The session record schema 1100 is extensible. In some implementations, the session record 1104 may include additional metadata fields beyond the six fields expressly depicted in FIG. 11. For example, the session record 1104 may include a target application identifier specifying the software application 406 on which the AI agent 404 performed the automated task, a summary of actions performed by the AI agent 404 during execution, and an audit status indicating whether the execution was completed, partially completed, or failed. FIG. 11 focuses on the core reference structure linking the session record 1104 to the stored observational record 1114 and the stored log 1116 through the storage reference 1106 and the reference identifier 1112.

### Tamper-Resistant Logging Repository Architecture

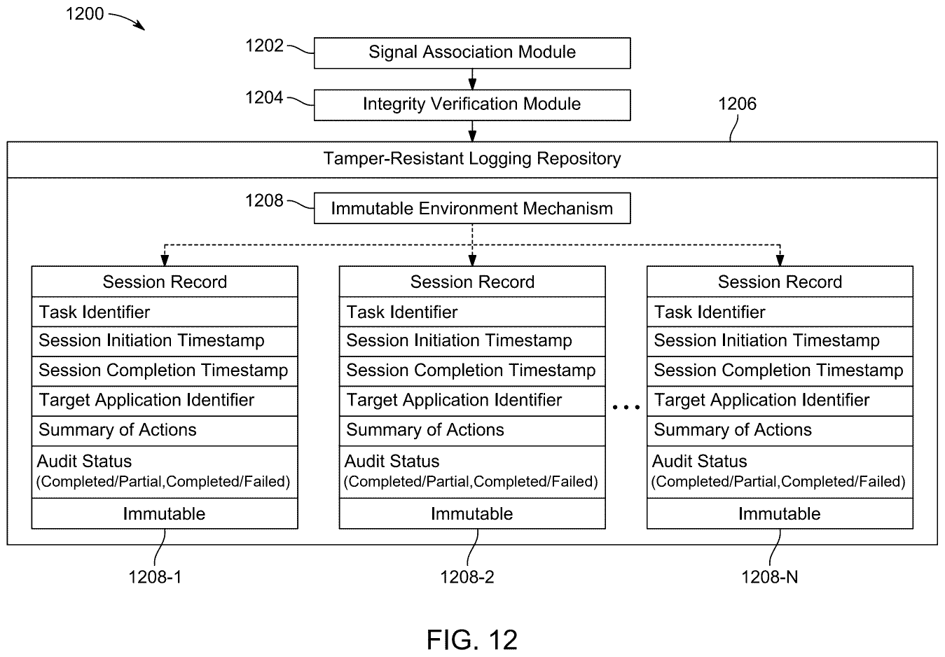

FIG. 12 illustrates a tamper-resistant logging repository architecture 1200. The tamper-resistant logging repository architecture 1200 depicts a storage infrastructure that receives session records from a signal association module 1202, validates integrity through an integrity verification module 1204, stores the session records within a tamper-resistant logging repository 1206, enforces immutability through an immutable environment mechanism 1208, and maintains a plurality of immutable session records 1208-1 through 1208-N. The tamper-resistant logging repository architecture 1200 provides a persistent storage layer for session records generated during execution of automated tasks by the AI agent 404.

The signal association module 1202 feeds session records into the tamper-resistant logging repository architecture 1200. In some embodiments, the signal association module 1202 corresponds to the association module 422 described with reference to FIG. 4. Each session record received from the signal association module 1202 contains execution metadata and, in some embodiments, includes or references an observational record of interactions performed by the AI agent 404 with the GUI 408, a log of the AI agent's internal decision-making process corresponding to the interactions, and a reference structure linking both artifacts to the initiating event 402. The signal association module 1202 transmits the session record to the tamper-resistant logging repository architecture 1200 upon completion of the association step.

The integrity verification module 1204 receives each incoming session record before the session record is committed to persistent storage within the tamper-resistant logging repository 1206. The integrity verification module 1204 validates structural completeness and consistency of the session record at the time of storage. In some embodiments, the integrity verification module 1204 verifies that the session record contains required metadata fields, that linked observational-record and log artifacts are present and non-empty, that temporal pairing between segments of the observational record and segments of the log is intact, and that a reference structure correctly links both artifacts to the initiating event. The integrity verification module 1204 may further apply a cryptographic integrity mechanism to the session record at the time of storage. The cryptographic integrity mechanism may generate a hash value or digital signature computed over contents of the session record, including associated observational-record, log, and metadata content. The hash value or digital signature may be stored alongside the session record and recalculated later to verify that the session record has not been altered since storage. If the integrity verification module 1204 detects that a required field is missing, that temporal pairing is incomplete, or that a cryptographic value does not match an expected value, the integrity verification module 1204 rejects the session record or flags the session record for review.

The integrity verification module 1204 and the cryptographic integrity mechanism operate as a sequential verification pipeline. The integrity verification module 1204 first validates that temporal pairing between segments of the observational record and segments of the log is intact, confirming that each segment of the observational record has a corresponding segment of the log produced during the same portion of execution. Upon successful validation of the temporal pairing, the cryptographic integrity mechanism generates the hash value or digital signature over the complete contents of the verified session record, including the temporally paired observational record and log. The cryptographic hash value therefore certifies both the content integrity and the temporal correspondence of the observational record and the log. A downstream system or authorized entity may recalculate the hash value at any time after storage and compare the recalculated hash value against the stored hash value to confirm that the temporally paired artifacts have not been modified, reordered, or selectively altered since the time of storage.

The tamper-resistant logging repository 1206 is a persistent storage structure in which verified session records are stored. The tamper-resistant logging repository 1206 may be implemented as a local storage system co-located with the computing platform 412, a cloud-hosted object store with versioning and legal-hold capabilities, a distributed storage cluster with replication across multiple availability zones, or a compliance-certified archival service provided by a third-party vendor. The specific storage implementation does not affect operation of upstream components. The interaction recording module 416, the reasoning capture module 418, and the association module 422 may produce the session record in a storage-agnostic format, and the tamper-resistant logging repository 1206 accepts the session record through the integrity verification module 1204 regardless of the underlying storage technology.

The immutable environment mechanism 1208 operates within the tamper-resistant logging repository 1206 and enforces immutability on all stored session records. Once a session record is committed to the tamper-resistant logging repository 1206 through the integrity verification module 1204, the session record becomes immutable and cannot be altered, overwritten, or deleted through normal operational processes. The immutable environment mechanism 1208 may be implemented through write-once storage media, append-only data structures, cryptographic chaining in which each session record hash incorporates a hash of a preceding session record, compliance-certified archival storage with legal-hold enforcement, or distributed-ledger technology in which the session record is recorded across multiple independent nodes. The immutable environment mechanism 1208 operates at the storage layer and is transparent to upstream components, such that the signal association module 1202 and the integrity verification module 1204 need not be aware of the specific immutability technology employed.

The tamper-resistant logging repository 1206 stores a plurality of immutable session records 1208-1, 1208-2, through 1208-N. Each immutable session record 1208 corresponds to a separate execution of an automated task by the AI agent 404. Each immutable session record 1208 contains a defined set of metadata fields. As depicted in FIG. 12, each immutable session record includes a task identifier, a session initiation timestamp, a session completion timestamp, a target application identifier, a summary of actions, an audit status, and an immutable indicator. The immutable indicator reflects that the session record has been committed under the immutable environment mechanism 1208 and is maintained in immutable form within the repository 1206.

The task identifier uniquely identifies execution of the automated task. In some embodiments, the task identifier corresponds to the task identifier 1104B described with reference to FIG. 11. The task identifier serves as a primary retrieval key for the immutable session record 1208 from the tamper-resistant logging repository 1206. A session initiation timestamp identifies the date and time at which the AI agent 404 began execution. In some embodiments, the session initiation timestamp corresponds to the session initiation timestamp 1104D described with reference to FIG. 11. A session completion timestamp identifies the date and time at which the AI agent 404 completed execution. In some embodiments, the session completion timestamp corresponds to the session completion timestamp 1104E described with reference to FIG. 11. Together, the session initiation timestamp and the session completion timestamp define a temporal window of the execution.

A target application identifier identifies the software application 406 on which the AI agent 404 performed the automated task. The target application identifier may specify a name, version, instance, or endpoint of the software application 406. For example, the target application identifier may identify a production instance of a customer relationship management platform, an administrative console of a cloud productivity suite, or a specific partner-hosted portal. The target application identifier enables retrieval and filtering of session records by target application, thereby supporting application-specific compliance reporting and cross-application audit-trail analysis.

A summary of actions records a condensed description of actions performed by the AI agent 404 during execution. The summary of actions may list user interface elements interacted with, types of actions performed, such as toggle-state changes, text entries, form submissions, and navigation transitions, and a sequence in which those actions occurred. The summary of actions provides a human-readable overview of the execution without requiring full replay of the observational record. For example, a summary of actions may state that the AI agent 404 navigated to security settings, disabled an external-access toggle, verified a post-action state, and submitted a configuration change. In some embodiments, the summary of actions is generated by the association module 422 based on contents of the log and the observational record.

An audit status indicates whether execution was completed, partially completed, or failed. The audit status reflects an outcome of the execution as determined by the system 400. An audit status of completed indicates that the AI agent 404 performed intended actions and achieved an intended outcome of the automated task. An audit status of partially completed indicates that the AI agent 404 performed some but not all intended actions before execution was interrupted, timed out, or encountered an unrecoverable error. An audit status of failed indicates that the AI agent 404 did not achieve the intended outcome due to a misinterpretation of a user interface element, an unexpected interface response, a permission restriction, or another failure condition. In some embodiments, the audit status is determined based on verification outcomes recorded in the log. If all verification steps produced matches, the audit status may be set to completed. If one or more verification steps produced mismatches that were resolved through corrective actions, the audit status may be set to completed or partially completed depending on whether all intended actions were ultimately performed. If one or more verification steps produced mismatches that were not resolved, the audit status may be set to failed.

The plurality of immutable session records 1208-1 through 1208-N accumulates over time as the AI agent 404 performs additional automated tasks. Each execution produces one immutable session record. The tamper-resistant logging repository 1206 supports structured retrieval across accumulated session records. A downstream system may query the tamper-resistant logging repository 1206 by task identifier to retrieve a specific session record, by target application identifier to retrieve session records for a specific software application, by timestamp range to retrieve session records within a specified date window, by audit status to retrieve failed or partially completed executions, or by a combination of such criteria. This structured retrieval capability enables the training feedback interface 428 to identify failed executions for corrective training, the audit retrieval interface 430 to locate session records in response to compliance-review requests, and diagnostic tools to analyze execution patterns and identify recurring failure modes.

The tamper-resistant logging repository architecture 1200 may be used in environments subject to multiple compliance frameworks. In environments subject to the Sarbanes-Oxley Act, immutability enforcement and the audit-status field support demonstrable control over automated actions affecting financial systems. In environments subject to the Health Insurance Portability and Accountability Act, tamper-resistant storage and the complete metadata schema support auditable records of automated access to healthcare applications. In environments subject to the General Data Protection Regulation, the session records provide verifiable documentation of automated processing activities. The immutable environment mechanism 1208 and the integrity verification module 1204 together provide a technical foundation for such compliance uses by preventing post-hoc modification of session records and enabling later verification that stored records have not been altered.

### Training Feedback Architecture

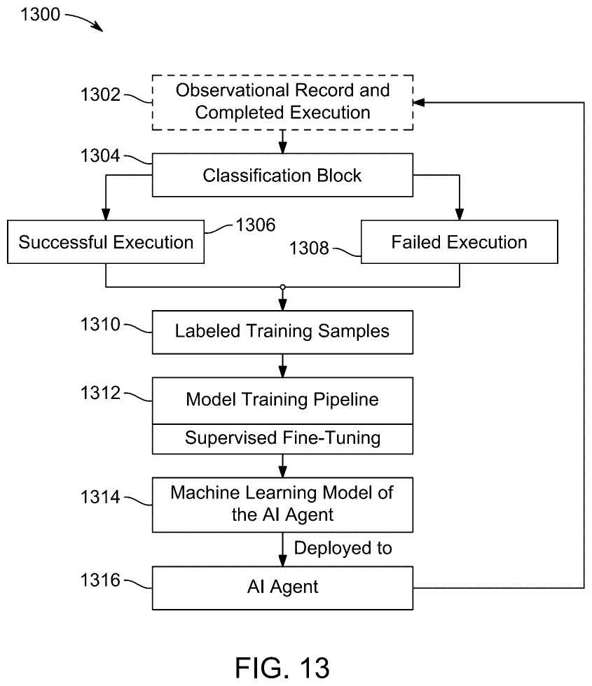

FIG. 13 illustrates a training feedback architecture 1300 depicting a closed-loop model-improvement cycle by which an observational record and a log of an AI agent's internal decision-making process are reused as training data for supervised fine-tuning of a machine learning model 1314 of the AI agent. The training feedback architecture 1300 receives an observational record and completed execution 1302, classifies the execution, generates labeled training samples 1310, processes the labeled training samples 1310 through a model training pipeline and supervised fine-tuning stage 1312, produces an updated machine learning model 1314 of the AI agent, and deploys the updated machine learning model 1314 to the AI agent 1316. Subsequent executions performed by the AI agent 1316 then generate additional observational records and completed executions 1302, thereby forming the closed-loop training cycle shown in the figure.

The training feedback architecture 1300 begins with the observational record and completed execution 1302. The observational record and completed execution 1302 represents output of a completed automated task performed by the AI agent 404. In some embodiments, the observational record and completed execution 1302 includes an observational record captured by the interaction recording module 416, a log generated by the reasoning capture module 418, and a session record 424 produced by the association module 422. The observational record and completed execution 1302 may be retrieved from the tamper-resistant logging repository 426 following storage of the session record. The observational record and completed execution 1302 therefore provides the source execution data from which downstream training inputs are derived.

The observational record and completed execution 1302 is passed to a classification block 1304. The classification block 1304 classifies execution of the automated task as either a successful execution 1306 or a failed execution 1308. The classification is based on whether the AI agent 404 achieved an intended outcome of the automated task as determined from the observational record and the log. In some embodiments, the classification block 1304 evaluates verification outcomes recorded in the log to determine the classification. If all verification steps recorded in the log produced matches between predicted post-action interface states and actual post-action interface states, and if the AI agent 404 completed intended actions specified by an initiating event 402, the classification block 1304 classifies the execution as the successful execution 1306. If one or more verification steps produced mismatches that the AI agent 404 could not resolve through corrective actions, or if the AI agent 404 did not complete all intended actions, the classification block 1304 classifies the execution as the failed execution 1308.

The classification block 1304 may apply additional criteria beyond verification outcomes. For example, the classification block 1304 may evaluate whether a total execution duration exceeded a predefined threshold, whether a number of corrective actions exceeded a predefined retry limit, or whether an audit status in the session record indicates a partially completed state. In some implementations, the classification block 1304 accepts manual classification input from a human reviewer who inspects the observational record and the log and confirms or overrides an automated classification. In other implementations, the classification block 1304 operates fully automatically based on verification outcomes and an audit-status field of the session record.

Sessions classified as the successful execution 1306 and sessions classified as the failed execution 1308 are both routed to a labeled training samples stage 1310. The labeled training samples 1310 represent the observational record and the log annotated with a classification label indicating whether the execution was successful or failed. Sessions classified as the successful execution 1306 receive a positive label. Sessions classified as the failed execution 1308 receive a negative label. The classification label transforms the observational record and the log from audit artifacts into training artifacts usable by a machine-learning pipeline.

For sessions classified as the failed execution 1308, the training feedback architecture 1300 may perform additional analysis before generating the labeled training samples 1310. The log may be analyzed to identify a specific reasoning step at which the AI agent's interpretation of a user interface element diverged from a correct interpretation. That analysis may locate a semantic interpretation record within the log where a primary natural-language description did not accurately describe an identity or function of the detected user interface element. Upon identifying the divergence point, the training feedback architecture 1300 may generate a training annotation specifying the user interface element that was incorrectly interpreted, the AI agent's incorrect semantic interpretation of the user interface element, a correct semantic interpretation of the user interface element, and a corrective training signal for fine-tuning the machine learning model 1314. For example, if the AI agent 404 misinterpreted a dropdown menu labeled “Access Level” as a navigation control rather than a permission selector, the training annotation may record the incorrect interpretation, the correct interpretation, contextual label and heading information, and a corrective signal directing the machine learning model 1314 to associate visual and textual features of that element with the correct interpretation in future executions.

The labeled training samples 1310 are passed to a model training pipeline and supervised fine-tuning stage 1312. As depicted in the figure, the stage 1312 encompasses both model training pipeline processing and supervised fine-tuning. The stage 1312 is configured to ingest labeled training data and use the labeled training data to update parameters of the machine learning model 1314. In some embodiments, the stage 1312 includes data preprocessing operations that normalize screen frames, segment log entries, and format training annotations into a structure compatible with model input requirements. In some embodiments, the stage 1312 further includes data augmentation operations that apply transformations to screen frames, such as cropping, scaling, or color adjustments, to increase diversity of the training data. The stage 1312 may process both positively labeled samples from successful executions 1306 and negatively labeled samples with corrective annotations from failed executions 1308.

The supervised fine-tuning portion of stage 1312 updates parameters of the machine learning model 1314 based on the labeled training samples 1310. In some embodiments, the supervised fine-tuning adjusts weights and parameters of the visual perception module 704, the semantic interpretation module 706, and the action selection module 708 within the vision-language reasoning architecture 700, depending on which component contributed to a successful or failed outcome. For positively labeled samples, the supervised fine-tuning reinforces parameter values that produced correct perception, interpretation, and action selection. For negatively labeled samples with corrective annotations, the supervised fine-tuning adjusts parameter values to reduce likelihood of recurrence of an incorrect interpretation when the model encounters similar visual and textual features in future executions. In some embodiments, the supervised fine-tuning employs gradient-based optimization techniques including stochastic gradient descent, Adam, or other optimization algorithms to update the model parameters.

The stage 1312 produces the machine learning model 1314 of the AI agent. The machine learning model 1314 represents trained parameters of the vision-language reasoning architecture 700 that govern how the AI agent 404 perceives user interface elements, generates semantic interpretations, and selects actions during execution of automated tasks. The machine learning model 1314 incorporates corrections and reinforcements derived from the labeled training samples 1310.

The machine learning model 1314 is deployed to the AI agent 1316. The deployment replaces or updates existing model parameters of the AI agent 404 with the fine-tuned parameters produced by the stage 1312. The AI agent 1316 shown in FIG. 13 therefore corresponds to a deployed AI agent operating with the updated machine learning model 1314. Following deployment, the AI agent 1316 performs subsequent automated tasks using the updated machine learning model 1314. Those subsequent executions generate new observational records and completed executions 1302, which are again classified by the classification block 1304 and routed through the labeled training samples stage 1310 and the stage 1312 for further fine-tuning. The return path shown in FIG. 13 from the AI agent 1316 back to the observational record and completed execution 1302 depicts this iterative closed-loop improvement cycle.

The closed-loop architecture depicted in FIG. 13 operates at multiple time scales. At an individual-execution level, a single failed execution classified as the failed execution 1308 may produce a targeted corrective annotation addressing a specific misinterpretation. At an aggregate level, an accumulation of labeled training samples 1310 across many executions may produce a training dataset that captures a range of user-interface variations, element types, application layouts, and contextual patterns encountered by the AI agent 404 across an enterprise software estate. Such progressive accumulation of training data may enable the machine learning model 1314 to generalize across applications and to maintain accuracy as software applications update interfaces, rename elements, or reposition controls. In some embodiments, dynamic GUI resilience described elsewhere in the disclosure is strengthened by the closed-loop training architecture depicted in FIG. 13 because the model's ability to adapt to interface changes improves as more diverse training data accumulates from real-world executions.

### Audit Retrieval and Compliance Verification Architecture

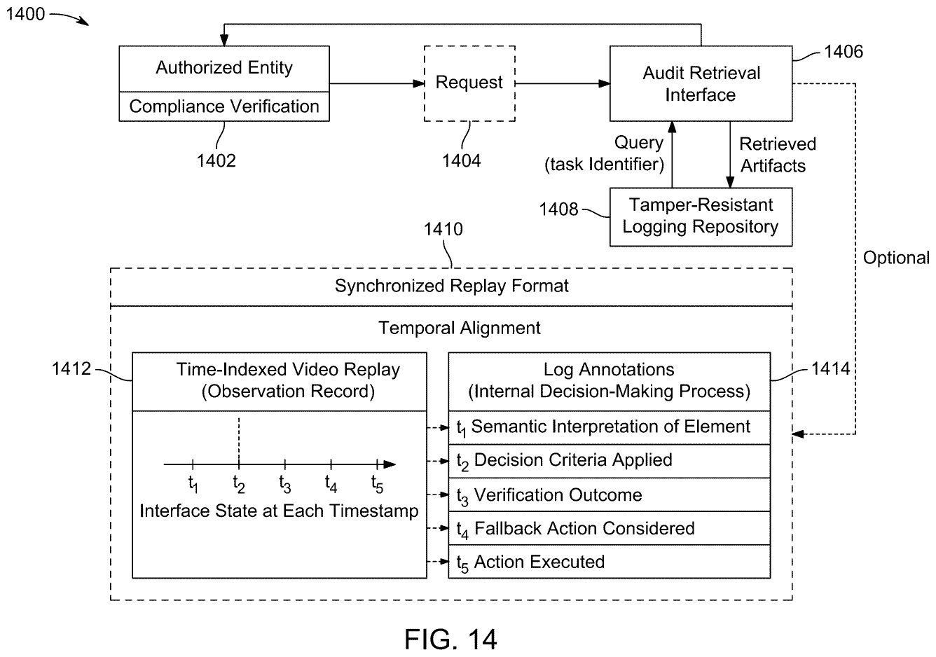

FIG. 14 illustrates an audit retrieval and compliance verification architecture 1400 depicting a process by which an authorized entity 1402 requests, retrieves, and reviews an observational record and a log of an AI agent's internal decision-making process for compliance verification. The audit retrieval and compliance verification architecture 1400 shows a data flow from a request 1404 initiated by the authorized entity 1402, through an audit retrieval interface 1406, to a tamper-resistant logging repository 1408, and back to the authorized entity 1402 in the form of retrieved artifacts for compliance verification. FIG. 14 further depicts an optional synchronized replay format 1410 in which the observational record and the log are presented in temporal alignment.

The authorized entity 1402 is an individual, organization, or system authorized to review session records stored in the tamper-resistant logging repository 1408. The authorized entity 1402 may be an enterprise client that engaged the AI agent 404 to perform automated tasks on the enterprise's software applications. The authorized entity 1402 may be a compliance auditor conducting a regulatory review under frameworks such as the Sarbanes-Oxley Act, the Health Insurance Portability and Accountability Act, or the General Data Protection Regulation. The authorized entity 1402 may be a regulatory body exercising oversight authority over automated operations. The authorized entity 1402 may also be an internal administrator responsible for monitoring behavior of the AI agent 404 and verifying that the AI agent 404 performed automated tasks in accordance with organizational policies. The authorized entity 1402 is external to the AI agent 404 and uses the architecture 1400 to conduct compliance verification of a specific execution.

The authorized entity 1402 submits the request 1404 to the audit retrieval interface 1406. The request 1404 specifies an execution that the authorized entity 1402 wishes to review. The request 1404 may identify the execution by task identifier, by target application identifier, by timestamp range, by audit status, or by a combination of these criteria. For example, the authorized entity 1402 may request a session record for a particular task identifier to review an execution in which the AI agent 404 modified a two-factor authentication setting. In another example, the authorized entity 1402 may request all session records having an audit status of failed for a specific software application within a defined time window. The request 1404 may originate from a web-based dashboard, an application programming interface call, a command-line query, or a formal audit request submitted through a governance platform.

The audit retrieval interface 1406 receives the request 1404 from the authorized entity 1402 and translates the request 1404 into a query directed to the tamper-resistant logging repository 1408. As indicated in the figure, the query may use a task identifier to locate a corresponding immutable session record within the tamper-resistant logging repository 1408. The audit retrieval interface 1406 enforces access control by validating that the authorized entity 1402 has appropriate permissions to access the requested session records. The audit retrieval interface 1406 may apply role-based access control, attribute-based access control, or policy-based access control to determine whether the authorized entity 1402 is permitted to view the requested records. If the authorized entity 1402 does not have sufficient permissions, the audit retrieval interface 1406 may deny the request and record the access attempt.

The tamper-resistant logging repository 1408 receives the query from the audit retrieval interface 1406 and retrieves the corresponding immutable session record. In some embodiments, the tamper-resistant logging repository 1408 corresponds to the tamper-resistant logging repository architecture 1200 described with reference to FIG. 12. The tamper-resistant logging repository 1408 locates the session record using the query criteria, follows a stored reference structure to a stored observational record and a stored log, and returns both artifacts to the audit retrieval interface 1406 as retrieved artifacts. The retrieved artifacts may further include metadata fields of the session record, including a task identifier, an originating system identifier, a trigger classification, a session initiation timestamp, a session completion timestamp, a target application identifier, a summary of actions, and an audit status. The audit retrieval interface 1406 then provides the retrieved artifacts to the authorized entity 1402 for compliance verification.

Compliance verification is performed by the authorized entity 1402 using the retrieved artifacts. During compliance verification, the authorized entity 1402 reviews the observational record to determine what the AI agent 404 did on the GUI 408 during execution of the automated task. The authorized entity 1402 reviews the log to determine why the AI agent 404 performed each action, what semantic interpretation the AI agent 404 formed of each user interface element, what decision criteria the AI agent 404 applied, and whether the AI agent 404 verified an outcome of each action. The authorized entity 1402 may compare behavior of the AI agent 404 as documented in the retrieved artifacts against an applicable policy baseline to determine whether the execution was compliant.

FIG. 14 further depicts the optional synchronized replay format 1410. The synchronized replay format 1410 is an alternative presentation mode in which the audit retrieval interface 1406 presents the retrieved artifacts in a temporally aligned display. In the synchronized replay format 1410, the observational record is displayed as a time-indexed video replay 1412 of execution of the automated task. The time-indexed video replay 1412 shows interface states observed by the AI agent 404 at successive timestamps during execution.

Alongside the time-indexed video replay 1412, log annotations 1414 derived from the log are displayed in temporal alignment with corresponding interface states in the observational record. The temporal alignment synchronizes each log annotation with a moment in the video replay at which a corresponding interaction occurred.

As illustrated in FIG. 14, the synchronized replay format 1410 may include timestamps t1 through t5. At each timestamp, the synchronized replay format 1410 presents an interface state from the observational record on one side and a corresponding log annotation on the other side. For example, at a first timestamp the log annotations 1414 may display a semantic interpretation of a user interface element encountered by the AI agent 404. At another timestamp the log annotations 1414 may display decision criteria applied by the AI agent 404 in selecting an interaction. At another timestamp the log annotations 1414 may display a verification outcome following an executed action. At another timestamp the log annotations 1414 may display a fallback action considered by the AI agent 404. At another timestamp the log annotations 1414 may display an action executed by the AI agent 404. The timestamps shown in FIG. 14 are illustrative, and a typical execution may involve many more temporally aligned annotations.

The synchronized replay format 1410 allows the authorized entity 1402 to observe, at each moment of the replay, what interface state the AI agent 404 observed, what interpretation the AI agent 404 formed, what decision criterion the AI agent 404 applied, what verification the AI agent 404 performed, and what action the AI agent 404 executed. In some implementations, the audit retrieval interface 1406 presents the retrieved artifacts in the synchronized replay format 1410 by default. In other implementations, the audit retrieval interface 1406 presents the observational record and the log as separate downloadable files, and the authorized entity 1402 may request the synchronized replay format 1410 as an additional presentation option. In further implementations, the audit retrieval interface 1406 presents the retrieved artifacts in a tabular format in which each row corresponds to a single interaction and contains a thumbnail image from the observational record, a semantic interpretation, a decision criterion, a verification outcome, and a fallback action. The selected presentation format does not alter underlying data, and the observational record and the log retain temporal alignment established by the temporal pairing mechanism described with reference to FIG. 6.

In some embodiments, the synchronized replay format 1410 presents the complete session including periods during which the AI agent 404 paused execution and a human operator performed interactions on the graphical user interface 408. During such periods, the time-indexed video replay 1412 displays the visual changes caused by the human operator's interactions, and the log annotations 1414 display the AI agent's pause state, including the semantic interpretation of the element that caused the pause, the decision criterion for pausing, and the monitoring observations recorded by the AI agent 404 during the pause. An authorized entity 1402 reviewing the synchronized replay format 1410 can identify the transition from AI agent interaction to human operator interaction and back to AI agent interaction, and can verify that the observational record maintained continuous capture across the transition.

The synchronized replay format 1410 supports bidirectional navigation between the observational record and the log. An authorized entity 1402 may select a segment of the log, such as a specific semantic interpretation or decision criterion entry, and the synchronized replay format 1410 retrieves and displays the corresponding segment of the observational record captured during the same portion of execution, thereby presenting the exact interface state that the AI agent 404 observed at the time of the selected reasoning entry. Conversely, the authorized entity 1402 may navigate to a position along the time-indexed video replay 1412, and the synchronized replay format 1410 retrieves and displays the corresponding log annotations 1414 produced by the AI agent 404 during the same portion of execution, thereby presenting the AI agent's semantic interpretation, decision criterion, verification outcome, and any fallback action corresponding to the selected interface state.

The audit retrieval and compliance verification architecture 1400 supports multiple concurrent requests from different authorized entities 1402. For example, a compliance auditor may review one session record for regulatory purposes while an internal administrator reviews a different session record for operational monitoring. Each request 1404 is processed independently through the audit retrieval interface 1406, and each authorized entity 1402 receives retrieved artifacts corresponding to the requested execution. The tamper-resistant logging repository 1408 serves read-only access to immutable session records. No retrieval operation modifies stored session records, and immutability enforced within the repository is maintained throughout retrieval and presentation.

### Dynamic GUI Resilience Architecture

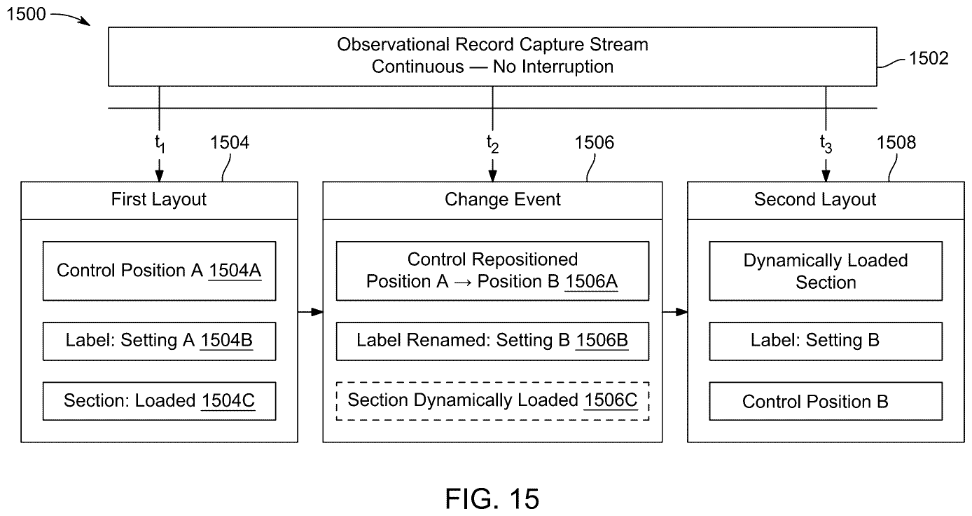

FIG. 15 illustrates a dynamic GUI resilience architecture 1500 depicting behavior of an observational record capture stream 1502 when a graphical user interface 408 of a software application 406 undergoes changes during execution of an automated task. The dynamic GUI resilience architecture 1500 demonstrates that capturing of the observational record continues across changes in the GUI 408 without interruption. In some embodiments, the capturing continues without requiring reconfiguration of an interaction recording module 416 during the execution, and in further embodiments without interrupting concurrent generation of a reasoning log associated with the execution.

The dynamic GUI resilience architecture 1500 is organized along a horizontal time progression spanning time t1, time t2, and time t3. The observational record capture stream 1502 runs continuously across the full time progression from t1 through t3. The observational record capture stream 1502 is labeled “Continuous-No Interruption,” indicating that the interaction recording process maintains unbroken capture throughout execution regardless of changes that occur in the GUI 408 at time t2.

At time t1, the GUI 408 presents a first layout 1504. The first layout 1504 represents an initial rendered state of the interface at a beginning of a relevant portion of execution. The first layout 1504 contains three depicted interface elements. A first element is a control position A 1504A. The control position A 1504A represents a user interface control, such as a toggle, button, or slider, located at a first spatial position within the interface. A second element is a label “Setting A” 1504B. The label 1504B is text associated with the control or with an adjacent interface element. A third element is a section “Loaded A” 1504C. The section 1504C is a portion of the interface that has been rendered and is visible at time t1. The first layout 1504 therefore represents a stable rendered interface state from which the AI agent 404 may perceive user interface elements, generate semantic interpretations, and select actions during execution.

At time t2, a change event 1506 occurs. The change event 1506 represents a modification to the GUI 408 that alters visual presentation, spatial arrangement, or content of one or more interface elements while the automated task is still in progress. The change event 1506 may be triggered by the software application 406 itself in response to an application-state transition, by user activity in another session, by a server-side update, by a dynamic content-loading event, or by a scheduled interface refresh. The change event 1506 is an external modification to the interface that occurs during execution and that the ongoing observational record capture stream 1502 traverses without interruption.

FIG. 15 depicts three types of changes occurring at the change event 1506.

A first change is a repositioned interface control 1506A. The control that was located at position A 1504A in the first layout 1504 is repositioned to position B 1506A in a later layout. The spatial coordinates of the control within the interface have therefore changed. For example, a toggle control that appeared at an upper portion of a configuration panel at time t1 may be moved to a lower portion of that panel at time t2 due to insertion of a new settings category above the toggle control. In some embodiments, a visual perception process operating during the execution detects the control at the new position and determines that the repositioned control corresponds to the same functional control that had previously appeared at position A.

A second change is a renamed element label 1506B. The label that read “Setting A” 1504B in the first layout 1504 is renamed to “Setting B” 1506B in a later layout. The text content of the label has changed while an underlying function associated with the control may remain the same. For example, a label reading “Enable External Access” at time t1 may be renamed to “External Access Control” at time t2 due to a localization update, terminology standardization, or application-version update applied during execution. In some embodiments, a semantic interpretation process reinterprets the new label text and determines that the renamed label refers to the same functional control as the original label.

A third change is a dynamically loaded interface section 1506C. A section of the interface that was not present or not fully rendered in the first layout 1504 is dynamically loaded at time t2 and appears in a later layout. The dynamically loaded section 1506C introduces interface content that was not visible at time t1. For example, a configuration panel may load additional settings options through an asynchronous data request that completes at time t2, causing new toggle controls, input fields, or dropdown menus to appear below previously visible elements. In some embodiments, a perception and interpretation process executed by the AI agent 404 detects and classifies the newly appeared elements and generates semantic interpretations for them after they become visible.

At time t3, the GUI 408 presents a second layout 1508. The second layout 1508 represents a post-change rendered state of the interface following the change event 1506. The second layout 1508 contains the control at position B, a label “Setting B,” and a second loaded section corresponding to the changed interface state. The AI agent 404 may continue execution of the automated task on the second layout 1508, and the observational record capture stream 1502 continues across the transition from the first layout 1504 through the change event 1506 to the second layout 1508.

The observational record capture stream 1502 runs continuously across all three time points. At time t1, an interaction recording process captures rendered graphical output 410 showing the first layout 1504. At time t2, the interaction recording process captures rendered graphical output 410 during and immediately following the change event 1506, thereby recording the transition from the first layout 1504 toward the second layout 1508. At time t3, the interaction recording process captures rendered graphical output 410 showing the second layout 1508. No gap exists in the capture stream between t1 and t3. The observational record capture stream 1502 does not pause, restart, or reinitialize when the change event 1506 occurs. In some embodiments, the interaction recording module 416 continues capturing frames at a same capture cadence before, during, and after the change event 1506.

The dynamic GUI resilience architecture 1500 further applies to periods during which the AI agent 404 has paused execution to allow a human operator to perform an interaction on the graphical user interface 408 that the AI agent 404 cannot perform autonomously, such as entering multi-factor authentication credentials or completing a visual verification challenge. During such periods, the rendered graphical output 410 continues to be produced by the software application 406 as the human operator interacts with the graphical user interface 408. The interaction recording module 416 continues capturing from the rendered graphical output 410 without interruption, thereby recording the visual changes caused by the human operator's interactions within the same observational record that contains the AI agent's preceding and subsequent interactions. The observational record capture stream 1502 therefore maintains continuity across the transition from AI agent interaction to human operator interaction and back to AI agent interaction.

In some embodiments, concurrent log generation by the reasoning capture module 418 also continues across the change event 1506. When the AI agent 404 encounters the second layout 1508 following the change event 1506, the reasoning capture module 418 records the AI agent's perception of the repositioned control at position B, the AI agent's reinterpretation of the renamed label “Setting B,” and the AI agent's detection and classification of the newly loaded interface section. In some embodiments, temporal pairing between the observational record and the reasoning log is maintained across the change event 1506, such that segments of the observational record captured at time t2 and time t3 correspond to segments of the log produced during the same portions of execution.

The dynamic GUI resilience architecture 1500 is not limited to the three types of changes depicted in FIG. 15. In some embodiments, capturing of the observational record continues across changes comprising at least one of repositioned interface controls, updated visual styling, renamed element labels, dynamically loaded interface sections, and rendering updates caused by application-state transitions. Updated visual styling includes changes to color schemes, font sizes, border styles, button shapes, and icon appearances that alter visual presentation of interface elements without necessarily changing positions or labels. Rendering updates caused by application-state transitions include page reloads, tab switches, modal-dialog appearances and dismissals, collapsible-section expansions and contractions, and progressive content-rendering events. Each of these change types may occur independently or in combination during a single execution of the automated task, and the observational record capture stream 1502 continues across such changes.

The dynamic GUI resilience architecture 1500 supports continued operation across interface change without requiring the capture stream itself to depend on static element locators. In some embodiments, the AI agent 404 uses a visual perception module 704 and a semantic interpretation module 706 to detect and interpret interface elements based on visual appearance and contextual meaning rather than solely on fixed coordinates or static identifiers. When a control is repositioned, the visual perception module 704 may detect the control at the new position based on visual features. When a label is renamed, the semantic interpretation module 706 may interpret the new label based on contextual cues. When a new section is dynamically loaded, the visual perception module 704 may detect the new elements and the semantic interpretation module 706 may generate interpretations for them. The interaction recording module 416 captures these interface changes in the observational record, and, in some embodiments, the reasoning capture module 418 records the AI agent's response to the changed interface in the log.

### Data Source Architecture

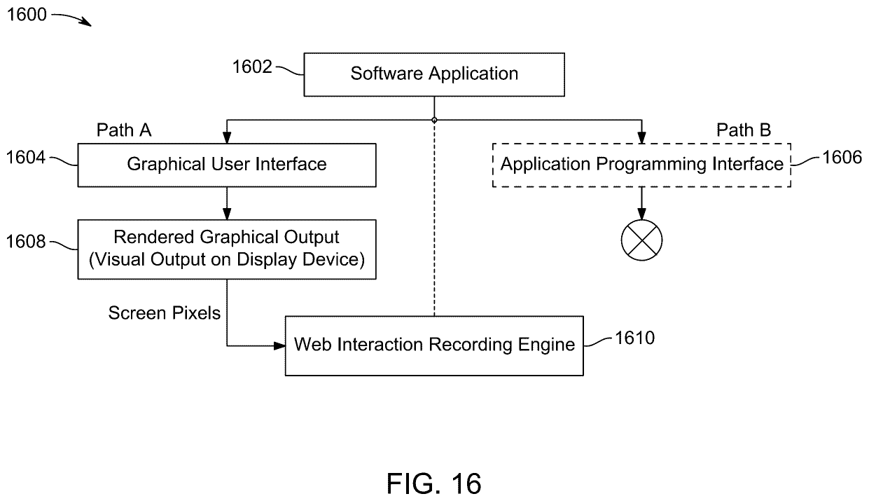

FIG. 16 illustrates a data source architecture 1600 by which an interaction recording module captures an observational record from a rendered graphical output 1608 of a software application 1602. FIG. 16 depicts two contrasting data paths originating from the software application 1602: an active capture path, Path A, through a graphical user interface 1604 and the rendered graphical output 1608, and an inactive path, Path B, through an application programming interface 1606. The data source architecture 1600 demonstrates that the system 400 obtains the observational record from the rendered graphical output 1608 of the software application 1602 and does not invoke the application programming interface 1606 of the software application 1602 for that capture.

The software application 1602 is a target application on which the AI agent 404 performs an automated task. In some embodiments, the software application 1602 corresponds to the software application 406 described with reference to FIG. 4. The software application 1602 presents two interfaces through which external systems may obtain information about application state and behavior: the graphical user interface 1604 and the application programming interface 1606.

The graphical user interface 1604 is a visual interface presented by the software application 1602 for human or agent interaction. The graphical user interface 1604 renders user interface elements such as text input fields, toggle controls, dropdown menus, navigation buttons, configuration panels, form submission controls, and modal dialog boxes on a display device or virtual display buffer. The graphical user interface 1604 is the interface through which the AI agent 404 perceives application state, interprets element meaning, and performs actions during execution of the automated task.

The graphical user interface 1604 produces the rendered graphical output 1608. The rendered graphical output 1608 is a visual output of the graphical user interface 1604 as displayed on a display device or rendered into a virtual display buffer. The rendered graphical output 1608 consists of screen pixels. The screen pixels are pixel-level visual data composing the rendered interface image at each moment during execution. The rendered graphical output 1608 represents what a human observer or the AI agent 404 would see when viewing the display device. The rendered graphical output 1608 is raw visual output of the graphical user interface 1604 and does not itself require structured metadata, element identifiers, DOM node references, or programmatic event data in order to be captured as an observational record.

The application programming interface 1606 is a programmatic interface exposed by the software application 1602 for structured machine-to-machine communication. The application programming interface 1606 provides structured access to application data, configuration parameters, and operational functions through predefined endpoints, request formats, and response schemas. Many enterprise software applications expose application programming interfaces 1606 for integration with identity and access management platforms, monitoring tools, and automation systems. However, some enterprise software applications, including legacy systems, third-party portals, partner-hosted dashboards, and internally administered tools, do not expose application programming interfaces 1606, or expose only limited application programming interfaces 1606 that do not cover configuration parameters or user-interface states relevant to the automated task. For such applications, the application programming interface 1606 is unavailable or insufficient as a data source for observability.

FIG. 16 depicts two data paths from the software application 1602 to a web interaction recording engine 1610.

Path A is the active capture path. Path A runs from the graphical user interface 1604, through the rendered graphical output 1608, and to the web interaction recording engine 1610. Path A represents a data flow by which the system 400 captures the observational record. In some embodiments, the web interaction recording engine 1610 corresponds to the interaction recording module 416 described with reference to FIG. 4. The web interaction recording engine 1610 receives pixel data from the rendered graphical output 1608 and generates the observational record from that pixel data. The web interaction recording engine 1610 does not request, receive, or process data from the application programming interface 1606 for purposes of observational-record capture. In one implementation, the web interaction recording engine 1610 captures pixel data from a headless browser instance in which the AI agent 404 performs the automated task. In another implementation, the web interaction recording engine 1610 captures pixel data from a remote desktop session, a virtual display buffer, or a screen-capture interface that reads rendered pixel output of the display device without accessing document object model structures, markup source, client runtime state, or backend data streams of the software application 1602.

Path B represents the application programming interface 1606. Path B is depicted as inactive. Path B shows a potential path from the application programming interface 1606 that is not connected to the web interaction recording engine 1610. The system 400 does not invoke Path B for capture of the observational record. The inactivity of Path B is a deliberate architectural choice. The system 400 is designed to operate on the rendered graphical output 1608 so that the system 400 can function on software applications that lack application programming interfaces, that expose only limited application programming interfaces, or that restrict programmatic access to configuration parameters and interface states relevant to the automated task.

The distinction between Path A and Path B is architecturally significant. First, the rendered graphical output 1608 is broadly available wherever the software application 1602 presents the graphical user interface 1604 on a display device or virtual display buffer, regardless of whether the software application 1602 exposes the application programming interface 1606. Second, the rendered graphical output 1608 captures what the AI agent 404 actually perceives during execution, thereby preserving fidelity between what the AI agent 404 saw and what the observational record documents. Third, the rendered graphical output path supports end-to-end audit traceability because a reviewer examining the observational record can inspect the same interface states encountered by the AI agent 404 during execution rather than a structured abstraction of those states.

The data source architecture depicted in FIG. 16 applies to capture of both the observational record and, in some embodiments, a reasoning-related log derived from the same visual input. The observational record is captured directly from the rendered graphical output 1608 through Path A. In some embodiments, a reasoning capture module 418 generates a log based on internal processing of the same rendered graphical output 1608 by the AI agent 404. Thus, both the observational record and associated reasoning artifacts may be derived from the rendered graphical output 1608, without dependence on data obtained through the application programming interface 1606.

The data source architecture 1600 is not limited to web-based applications. The rendered graphical output 1608 may be produced by any software application 1602 that presents the graphical user interface 1604, including a web-based application rendered in a browser, a native desktop application rendered by a windowing system, a legacy terminal application rendered through a terminal emulator, or a hybrid application combining web and native interface components. The web interaction recording engine 1610 captures pixel data from the rendered graphical output 1608 regardless of application type, platform, or rendering technology.

### Log Content Structure

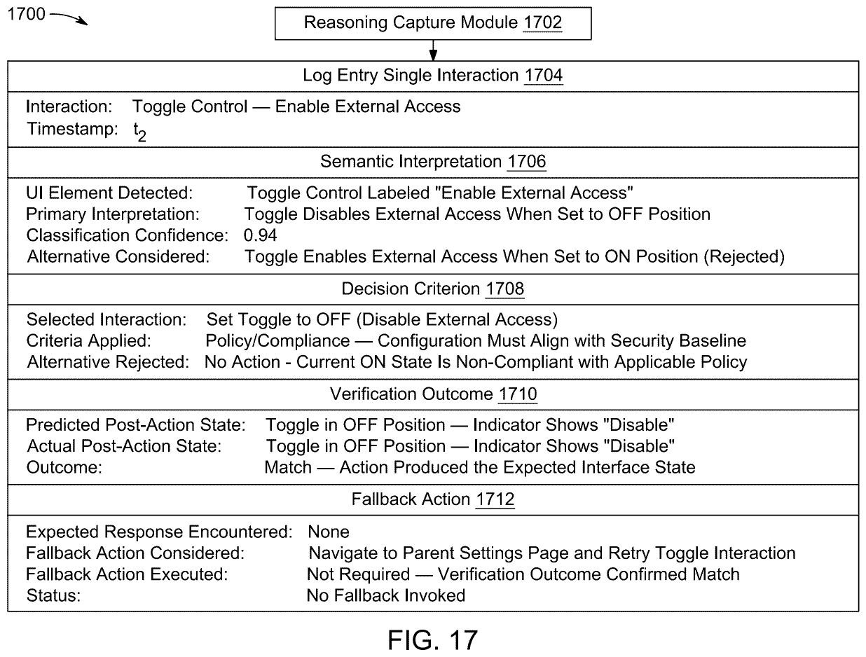

FIG. 17 illustrates a log content structure 1700 depicting four content sections that the reasoning capture module 1702 records in a log for a single interaction performed by the AI agent 404 during execution of an automated task. The log content structure 1700 shows a complete log entry 1704 comprising a semantic interpretation section 1706, a decision criterion section 1708, a verification outcome section 1710, and a fallback action section 1712. Each section records a distinct aspect of the AI agent's internal decision-making process for the interaction.

The log entry 1704 corresponds to a single interaction performed by the AI agent 404 at a specific moment during execution. FIG. 17 depicts the log entry 1704 for an interaction with a toggle control labeled “Enable External Access” at timestamp t2. The log entry 1704 begins with a header identifying the interaction type, the element label, and the timestamp at which the interaction occurred. Each log entry 1704 in the log corresponds to one segment of the observational record captured during the same portion of execution, thereby maintaining temporal alignment with the observational record as described with reference to FIG. 6.

The semantic interpretation section 1706 is a first content section of the log entry 1704. The semantic interpretation section 1706 records a semantic interpretation generated by the AI agent 404 for the user interface element involved in the interaction. The semantic interpretation section 1706 contains an output of the semantic interpretation module 706 for the detected user interface element. In the example depicted in FIG. 17, the semantic interpretation section 1706 records that the user interface element detected is a toggle control labeled “Enable External Access,” records a primary interpretation indicating that the toggle control disables external access when set to an off position, records a classification confidence level of 0.94, and records an alternative interpretation considered by the language model. In the example, the alternative considered indicates that the toggle control enables external access when set to an on position and that this alternative was rejected. The semantic interpretation section 1706 therefore provides a record of what the AI agent 404 understood about the element.

The decision criterion section 1708 is a second content section of the log entry 1704. The decision criterion section 1708 records a decision criterion applied by the AI agent 404 in selecting an interaction over an alternative interaction available at the GUI 408 at the time of the interaction. The decision criterion section 1708 contains an output of the action selection module 708 for the detected user interface element. In the example depicted in FIG. 17, the decision criterion section 1708 records that the AI agent 404 selected the interaction “Set Toggle to OFF (Disable External Access).” The decision criterion section 1708 further records that the criterion applied was policy and compliance, specifically that the configuration must align with a security baseline. The decision criterion section 1708 also records an alternative interaction that was rejected. In the example, the rejected alternative was “No Action,” meaning the AI agent 404 considered leaving the toggle in its current on state. The rejection rationale indicates that the current on state is non-compliant with an applicable policy. The decision criterion section 1708 therefore provides a record of why the AI agent 404 chose the executed action.

The verification outcome section 1710 is a third content section of the log entry 1704. The verification outcome section 1710 records whether the executed action produced an expected interface state. The verification outcome section 1710 contains a result of a verification step performed by the AI agent 404 following execution of the action, as described with reference to FIG. 9. In the example depicted in FIG. 17, the verification outcome section 1710 records three fields. A predicted post-action state indicates that the AI agent 404 expected the toggle to appear in an off position with an indicator showing “Disable.” An actual post-action state indicates that the visual perception module 704 detected the toggle in the off position with an indicator showing “Disable” after the action was executed. An outcome determination indicates “Match,” meaning the action produced the expected interface state. The verification outcome section 1710 therefore provides a record of whether the action worked as expected. When the outcome determination is a match, the verification outcome section 1710 confirms that the AI agent 404 successfully performed the intended modification. When the outcome determination is a mismatch, the verification outcome section 1710 records a discrepancy between the predicted and actual states, thereby providing a basis for corrective action and downstream error analysis.

The fallback action section 1712 is a fourth content section of the log entry 1704. The fallback action section 1712 records fallback actions considered or executed by the AI agent 404 upon encountering an unexpected interface response. In the example depicted in FIG. 17, the fallback action section 1712 records four fields. An unexpected response encountered field indicates “None,” meaning the AI agent 404 did not encounter an unexpected response during the interaction. A fallback action considered field indicates “Navigate to Parent Settings Page and Retry Toggle Interaction,” meaning the AI agent 404 identified a contingency plan that it would have executed if the verification outcome had been a mismatch. A fallback action executed field indicates “Not Required,” meaning the verification outcome was a match and the fallback action was not invoked. A status field indicates “No Fallback Invoked,” summarizing that the interaction completed successfully without requiring any corrective or fallback response. The fallback action section 1712 therefore provides a record of what alternative response the AI agent 404 prepared in case the action did not achieve the intended result.

In another example, the fallback action section 1712 may record a scenario in which the AI agent 404 encounters a multi-factor authentication prompt or a visual verification challenge during execution. The unexpected response encountered field indicates that an authentication dialog was detected. The fallback action considered field indicates a pause of execution to allow a human operator to complete the authentication interaction. The fallback action executed field indicates that the AI agent 404 paused execution and the human operator performed the required interaction. The status field indicates that the human operator completed the authentication interaction and the AI agent 404 resumed execution. The semantic interpretation section 1706 for the corresponding log entry records the AI agent's interpretation of the authentication prompt, including the element type, the classification confidence level, and the determination that autonomous resolution was not available.

The four content sections of the log entry 1704 together provide a complete record of the AI agent's perception, reasoning, verification, and contingency planning for a single interaction. The semantic interpretation section 1706 documents what the AI agent 404 understood about the user interface element. The decision criterion section 1708 documents why the AI agent 404 selected a particular action. The verification outcome section 1710 documents whether the action achieved the intended result. The fallback action section 1712 documents what alternative response the AI agent 404 prepared in case the action did not achieve the intended result. Each section is recorded independently, and each section contains structured fields that can be queried, filtered, and analyzed by downstream systems.

The log content structure 1700 is repeated for each interaction that the AI agent 404 performs during execution of the automated task. A complete log 714 for a single execution contains a sequence of log entries 1704, each structured according to the four-section format depicted in FIG. 17. A first log entry corresponds to a first interaction at timestamp t1. A second log entry corresponds to a second interaction at timestamp t2, as depicted in FIG. 17. Additional log entries follow through a final interaction at timestamp tn. A collection of log entries across all interactions constitutes a complete log of the AI agent's internal decision-making process for the execution.

The log content structure 1700 supports multiple downstream use cases. During compliance verification through the audit retrieval interface 430, a reviewer can examine any log entry 1704 and inspect all four content sections to assess whether the AI agent 404 correctly identified the element, chose an appropriate action for an appropriate reason, confirmed the outcome, and had a reasonable contingency plan. During model training through the training feedback interface 428, the classification block 1304 can use the verification outcome section 1710 to identify interactions where the AI agent 404 encountered mismatches and can use the semantic interpretation section 1706 to locate a specific misinterpretation that caused the mismatch. During diagnostic analysis, decision criterion sections 1708 across multiple executions can be aggregated to identify patterns in action-selection behavior, such as recurring reliance on a particular criterion type or recurring rejection of specific alternative interactions.

The example depicted in FIG. 17 uses a security-configuration toggle to illustrate the four-section log content structure 1700. The same four-section structure may be applied to other types of user interface elements and other interaction types. For a text-entry interaction, the semantic interpretation section 1706 records the AI agent's interpretation of an input field's purpose and expected format, the decision criterion section 1708 records a basis on which the AI agent 404 selected a specific text value to enter, the verification outcome section 1710 records whether the entered text was accepted by the software application 406 and produced an expected post-entry state, and the fallback action section 1712 records any alternative entry strategy considered by the AI agent 404. For a dropdown-menu selection, a form submission, a navigation action, or another interaction type, the four sections follow the same general structure with content appropriate to the interaction type.

### Multi-Application Execution Architecture

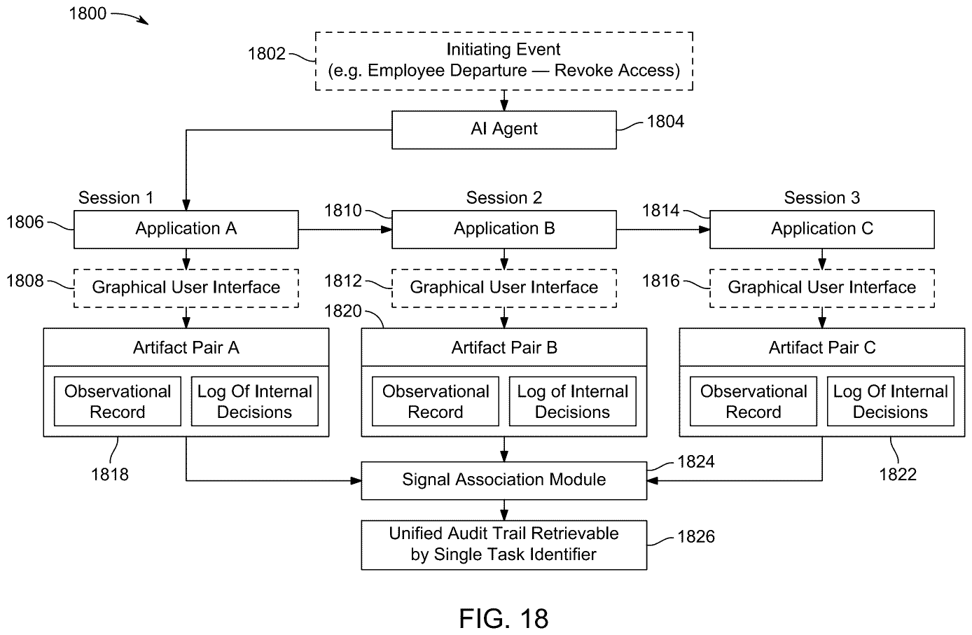

FIG. 18 illustrates a multi-application execution architecture 1800 depicting a scenario in which execution of an automated task initiated by a single initiating event 1802 spans a plurality of sequential agent sessions across a plurality of software applications. The multi-application execution architecture 1800 demonstrates how the system 400 captures, for each session, a separate observational record and a separate log of internal decisions, and associates all artifact pairs with the single initiating event 1802 through a unified audit trail 1826 retrievable by a single task identifier.

The multi-application execution architecture 1800 begins with the initiating event 1802. The initiating event 1802 is a single event that triggers an automated task requiring the AI agent 1804 to perform actions across multiple software applications. In the example depicted in FIG. 18, the initiating event 1802 is an employee departure event that requires revocation of a departing employee's access credentials across enterprise applications in which the employee holds active accounts. The employee departure event may originate from a human resources system, an identity governance and administration platform, or a security monitoring system that detects a change in employee status. The initiating event 1802 may carry an identity of the departing employee, a list of applications requiring credential revocation, and a policy basis for the revocation. A single initiating event 1802 thus causes the AI agent 1804 to perform a sequence of related automated tasks across multiple software applications.

The AI agent 1804 receives the initiating event 1802 and determines that the automated task requires interaction with multiple software applications, depicted in FIG. 18 as Application A 1806, Application B 1810, and Application C 1814. Application A 1806 may be a cloud-based customer relationship management platform in which the departing employee has an active user account. Application B 1810 may be a partner-hosted financial dashboard in which the departing employee has read and write access to financial reports. Application C 1814 may be an internal compliance management tool in which the departing employee has administrative privileges. Each application presents its own graphical user interface with distinct interface layouts, element types, navigation structures, and configuration panels. The AI agent 1804 performs the revocation task on each application sequentially, interacting with each application's graphical user interface through the vision-language reasoning architecture 700.

In a first session, the AI agent 1804 interacts with Application A 1806 through the graphical user interface 1808. During that first session, the AI agent 1804 navigates to a user-management section of Application A 1806, locates the departing employee's account, and performs credential-revocation actions required by an applicable policy. The interaction recording module 416 captures an observational record of the AI agent's interactions with the graphical user interface 1808 from rendered graphical output. Concurrently, the reasoning capture module 418 generates a log of the AI agent's internal decision-making process corresponding to those interactions. The observational record and the log produced during that first session together constitute artifact pair A 1818.

Upon completing the first session on Application A 1806, the AI agent 1804 proceeds to a second session on Application B 1810 through the graphical user interface 1812. Application B 1810 presents a different graphical user interface with different element types, navigation patterns, and configuration layouts than Application A 1806. The AI agent 1804 adapts to the interface of Application B 1810 using the visual perception module 704 and the semantic interpretation module 706, navigates to a relevant access-management section, and performs credential-revocation actions required for Application B 1810. The interaction recording module 416 captures a separate observational record for the second session, and the reasoning capture module 418 generates a separate log for the second session. The observational record and the log produced during that second session together constitute artifact pair B 1820.

Upon completing the second session on Application B 1810, the AI agent 1804 proceeds to a third session on Application C 1814 through the graphical user interface 1816. Application C 1814 presents a third distinct graphical user interface. The AI agent 1804 adapts to the interface of Application C 1814, navigates to an administrative-privileges section, and performs credential-revocation and privilege-removal actions required for Application C 1814. The interaction recording module 416 captures a separate observational record for the third session, and the reasoning capture module 418 generates a separate log for the third session. The observational record and the log produced during that third session together constitute artifact pair C 1822.

Each artifact pair comprises an observational record and a log of internal decisions. Artifact pair A 1818 contains the observational record and the log from the first session on Application A 1806. Artifact pair B 1820 contains the observational record and the log from the second session on Application B 1810. Artifact pair C 1822 contains the observational record and the log from the third session on Application C 1814. Each artifact pair is an independent bi-artifact record documenting the AI agent's behavior on a single application during a single session. Each observational record within each artifact pair maintains temporal alignment with a corresponding log through the temporal pairing mechanism, such that each segment of the observational record corresponds to a segment of the log produced during the same portion of execution on that application.

The signal association module 1824 receives the three artifact pairs and the initiating event 1802. The signal association module 1824 associates artifact pair A 1818, artifact pair B 1820, and artifact pair C 1822 with the single initiating event 1802 that caused the AI agent 1804 to begin the multi-application execution. The signal association module 1824 links all three artifact pairs to the initiating event 1802 through a common task identifier. The common task identifier represents the overall execution triggered by the initiating event 1802, rather than the individual sessions. In some embodiments, each individual session may additionally receive a session-level identifier that distinguishes the first session on Application A 1806 from the second session on Application B 1810 and the third session on Application C 1814. Such session-level identifiers may be nested under the common task identifier, thereby establishing a hierarchical association structure in which the common task identifier serves as a parent and the session-level identifiers serve as children.

In some embodiments, the signal association module 1824 further maintains a causal chain linking the initiating event 1802 to each session's observational record and log. The causal chain may preserve the sequential relationship among sessions, including an order in which sessions occurred, an application addressed in each session, and any dependency relationships among the sessions. For example, if revocation of credentials in Application A 1806 is a prerequisite for revocation of credentials in Application B 1810 because Application B 1810 inherits access permissions from Application A 1806, the causal chain may record that dependency. If the sessions are independent and sequential ordering is a matter of scheduling rather than dependency, the causal chain may record the sequential order without a dependency relationship.

The output of the signal association module 1824 is the unified audit trail 1826. The unified audit trail 1826 is a composite record that encompasses the three artifact pairs and the initiating event 1802, linked by the common task identifier. The unified audit trail 1826 is retrievable by a single task identifier. A downstream system that queries the common task identifier retrieves the complete multi-application execution record, including the initiating event 1802, artifact pair A 1818 from the session on Application A 1806, artifact pair B 1820 from the session on Application B 1810, and artifact pair C 1822 from the session on Application C 1814. An authorized entity therefore does not need to query each session individually or know in advance how many sessions the execution comprised. A single query using the common task identifier returns the complete set of artifact pairs and, in some embodiments, the causal chain linking them to the initiating event 1802.

In some embodiments, the unified audit trail 1826 is stored in the tamper-resistant logging repository 426 as a composite immutable record. Each artifact pair within the unified audit trail 1826 may retain individual session-level metadata, including a target application identifier, a session initiation timestamp, a session completion timestamp, a summary of actions, and an audit status for that session. The unified audit trail 1826 may aggregate the session-level metadata into a composite view showing overall execution status across all addressed applications. If all sessions completed successfully, the unified audit trail 1826 may reflect an overall audit status of completed. If one or more sessions failed or partially completed, the unified audit trail 1826 may reflect per-session audit status for each application, thereby enabling a compliance reviewer to identify which specific application and which specific session encountered difficulty.

The multi-application execution architecture 1800 is not limited to three applications or three sessions. The architecture supports any number of sequential sessions across any number of software applications, determined by scope of the initiating event 1802. An employee departure event affecting ten applications may produce ten sequential sessions and ten artifact pairs, all linked to the single initiating event 1802 through the common task identifier in the unified audit trail 1826. A quarterly access-certification review affecting many applications may likewise produce many sequential sessions and artifact pairs linked through the same mechanism.

The multi-application execution architecture 1800 supports enterprise identity-governance and audit use cases in which a reviewer needs a unified record of an automated operation spanning multiple applications. A compliance auditor reviewing an organization's response to an employee departure may need to verify that credentials were revoked in every affected application, not merely in one application. The unified audit trail 1826 provides a single retrievable record spanning the full multi-application operation. The auditor can review the observational record and the log for each application individually, compare the AI agent's behavior across applications, and verify that revocation was performed consistently across the software estate. Without the unified audit trail 1826, the auditor would need to locate and correlate separate session records for each application independently, with no single structural mechanism confirming that all applications were addressed and no unified chain linking the individual sessions to the original initiating event 1802.

### Artificial Intelligence System Implementation

The system 400 described in connection with FIG. 4 through FIG. 18 comprises several components that rely on artificial intelligence to perform their functions. The visual perception module 704 detects and classifies user interface elements rendered on the GUI 408 using computer vision. The semantic interpretation module 706 generates textual interpretations of the detected user interface elements and associated labels using a language model. The action selection module 708 determines actions to be executed based on the outputs of the visual perception module 704 and the semantic interpretation module 706. Each of these modules operates on visual and textual data that the AI agent 404 encounters during the execution of the automated task on the graphical user interface of the software application 406. The accuracy and reliability of the observational record captured by the interaction recording module 416 and the log generated by the reasoning capture module 418 depend directly on the performance of the underlying artificial intelligence models that power these modules.

The artificial intelligence models employed by the system 400 are built on a class of neural network architectures known as transformers. A transformer is a parallel input, parallel output architecture that processes input sequences using a self-attention mechanism to compute context-informed representations of each element in the sequence. The transformer architecture is applicable to both natural language processing tasks, where the input sequence comprises words or tokens, and computer vision tasks, where the input sequence comprises image patches extracted from a screen frame 702. The visual perception module 704 may employ a Vision Transformer (ViT) model that processes screen images as sequences of image patches to detect and classify user interface elements. The semantic interpretation module 706 may employ a language model based on the transformer architecture to generate natural language descriptions of detected elements. The action selection module 708 may employ a transformer-based model that processes the combined outputs of the visual perception module 704 and the semantic interpretation module 706 to select actions.

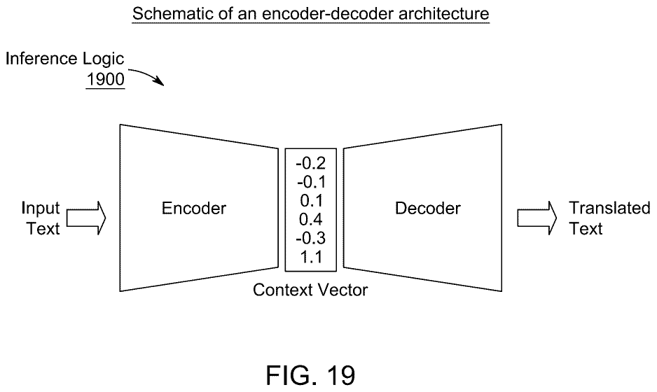

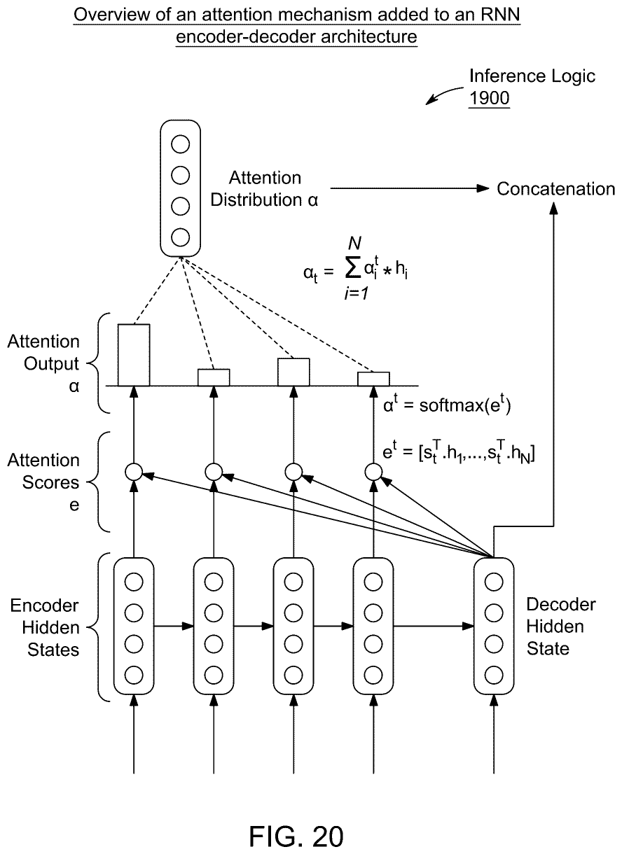

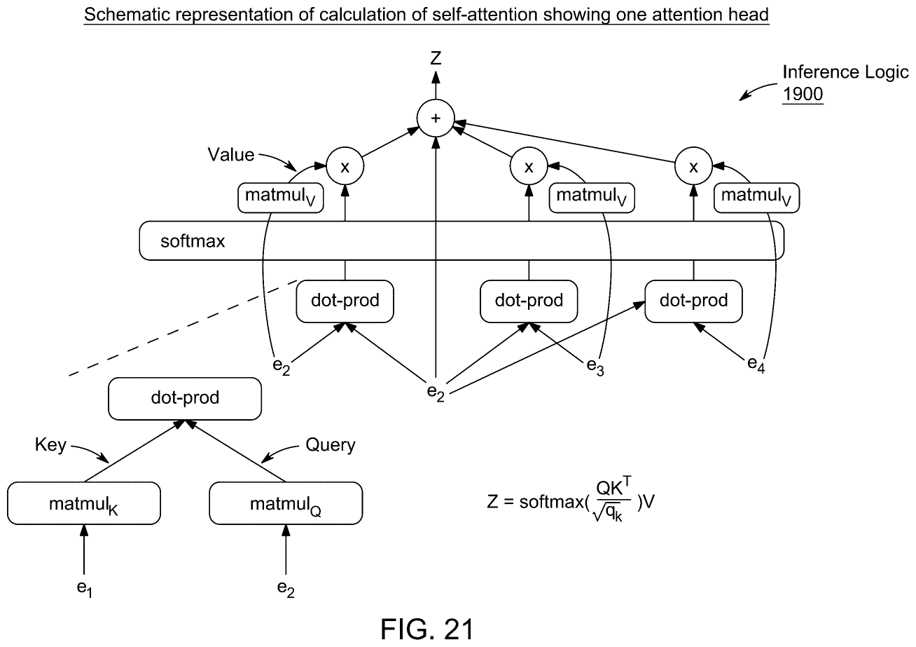

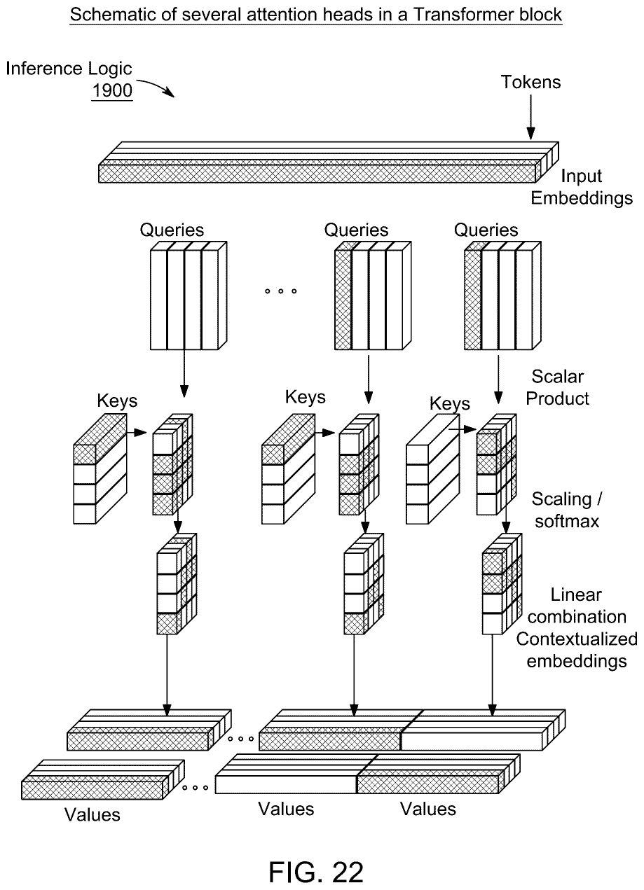

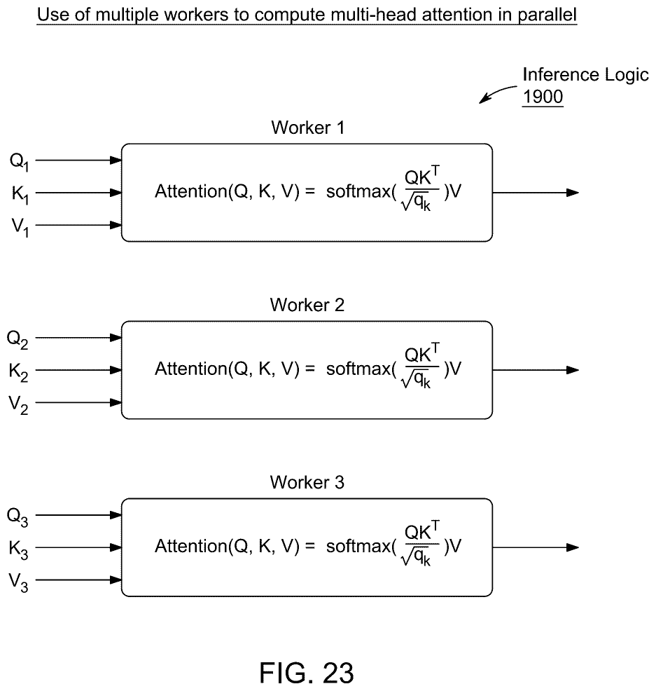

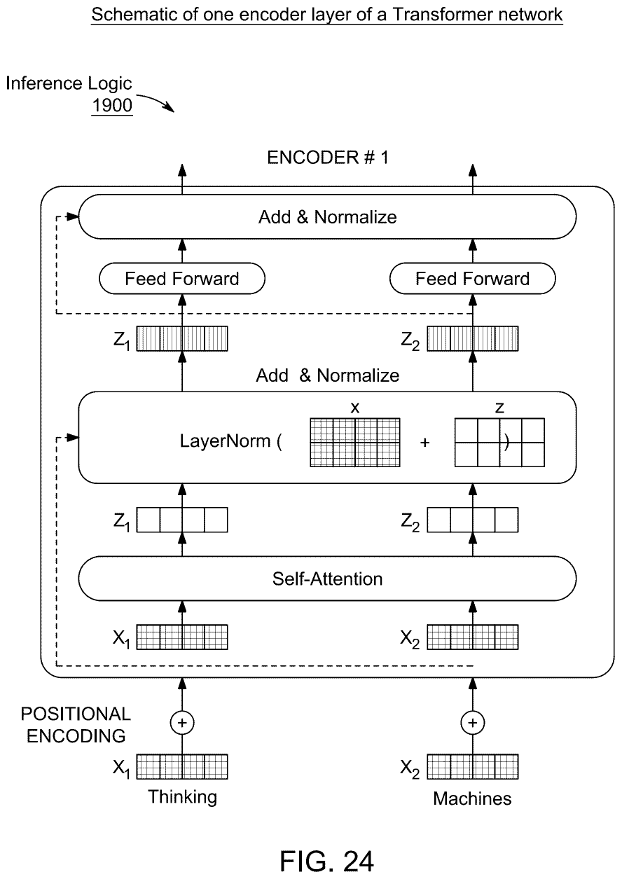

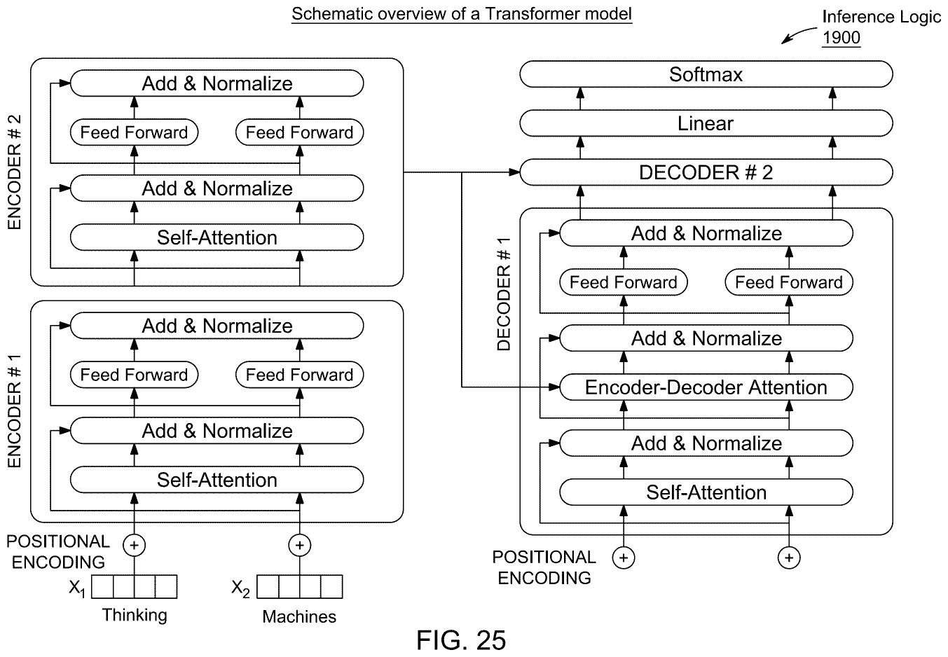

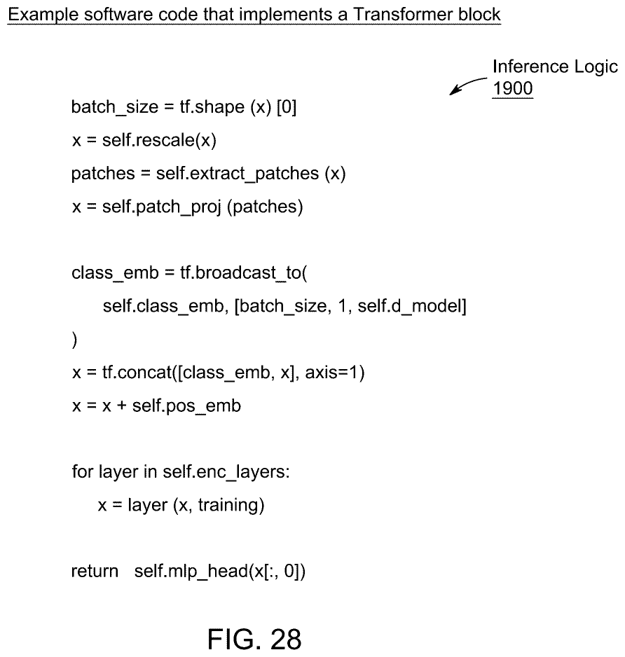

FIG. 19 through FIG. 28 illustrate the architecture, components, and processing flow of the transformer-based models that underlie the artificial intelligence subsystems of the system 400. FIG. 19 illustrates the encoder-decoder architecture that forms the foundational building block of transformer models. FIG. 20 illustrates the attention mechanism that enables the transformer to weigh relationships among all elements in an input sequence. FIG. 21 illustrates the calculation of self-attention for a single attention head. FIG. 22 illustrates the use of multiple attention heads within a transformer block. FIG. 23 illustrates parallel computation of multi-head attention across multiple workers. FIG. 24 illustrates the structure of a single encoder layer within a transformer network. FIG. 25 illustrates the complete transformer model comprising encoder and decoder stacks. FIG. 26 illustrates the Vision Transformer (ViT) architecture that adapts the transformer framework from natural language processing to computer vision by treating image patches as input tokens. FIG. 27 illustrates the processing flow of the Vision Transformer, including the flattening, positional embedding, multi-head self-attention, and classification stages. FIG. 28 illustrates example software code that implements a transformer block. The following paragraphs describe each of these figures in detail.

Some implementations of the technology disclosed relate to using a Transformer model to provide an AI system. In particular, the technology disclosed proposes a parallel input, parallel output (PIPO) AI system based on the Transformer architecture. The Transformer model relies on a self-attention mechanism to compute a series of context-informed vector-space representations of elements in the input sequence and the output sequence, which are then used to predict distributions over subsequent elements as the model predicts the output sequence element-by-element. Not only is this mechanism straightforward to parallelize, but as each input's representation is also directly informed by all other inputs' representations, this results in an effectively global receptive field across the whole input sequence. This stands in contrast to, e.g., convolutional architectures which typically only have a limited receptive field.

In one implementation, the disclosed AI system is a multilayer perceptron (MLP). In another implementation, the disclosed AI system is a feedforward neural network. In yet another implementation, the disclosed AI system is a fully connected neural network. In a further implementation, the disclosed AI system is a fully convolution neural network. In a yet further implementation, the disclosed AI system is a semantic segmentation neural network. In a yet another further implementation, the disclosed AI system is a generative adversarial network (GAN) (e.g., CycleGAN, StyleGAN, pixelRNN, text-2-image, DiscoGAN, IsGAN). In a yet another implementation, the disclosed AI system includes self-attention mechanisms like Transformer, Vision Transformer (ViT), Bidirectional Transformer (BERT), Detection Transformer (DETR), Deformable DETR, UP-DETR, DeiT, Swin, GPT, iGPT, GPT-2, GPT-3, various ChatGPT versions, various LLAMA versions, BERT, SpanBERT, ROBERTa, XLNet, ELECTRA, UniLM, BART, T5, ERNIE (THU), KnowBERT, DeiT-Ti, DeiT-S, DeiT-B, T2T-ViT-14, T2T-ViT-19, T2T-ViT-24, PVT-Small, PVT-Medium, PVT-Large, TNT-S, TNT-B, CPVT-S, CPVT-S-GAP, CPVT-B, Swin-T, Swin-S, Swin-B, Twins-SVT-S, Twins-SVT-B, Twins-SVT-L, Shuffle-T, Shuffle-S, Shuffle-B, XCiT-S12/16, CMT-S, CMT-B, VOLO-D1, VOLO-D2, VOLO-D3, VOLO-D4, MoCo v3, ACT, TSP, Max-DeepLab, VisTR, SETR, Hand-Transformer, HOT-Net, METRO, Image Transformer, Taming transformer, TransGAN, IPT, TTSR, STTN, Masked Transformer, CLIP, DALL-E, Cogview, UniT, ASH, TinyBert, FullyQT, ConvBert, FCOS, Faster R-CNN+FPN, DETR-DC5, TSP-FCOS, TSP-RCNN, ACT+MKDD (L=32), ACT+MKDD (L=16), SMCA, Efficient DETR, UP-DETR, UP-DETR, VITB/16-FRCNN, VIT-B/16-FRCNN, PVT-Small+RetinaNet, Swin-T+RetinaNet, Swin-T+ATSS, PVT-Small+DETR, TNT-S+DETR, YOLOS-Ti, YOLOS-S, and YOLOS-B.

In one implementation, the disclosed AI system is a convolution neural network (CNN) with a plurality of convolution layers. In another implementation, the disclosed AI system is a recurrent neural network (RNN) such as a long short-term memory network (LSTM), bi-directional LSTM (Bi-LSTM), or a gated recurrent unit (GRU). In yet another implementation, the disclosed AI system includes both a CNN and an RNN.

In yet other implementations, the disclosed AI system can use 1D convolutions, 2D convolutions, 3D convolutions, 4D convolutions, 5D convolutions, dilated or atrous convolutions, transpose convolutions, depthwise separable convolutions, pointwise convolutions, 1×1 convolutions, group convolutions, flattened convolutions, spatial and cross-channel convolutions, shuffled grouped convolutions, spatial separable convolutions, and deconvolutions. The disclosed AI system can use one or more loss functions such as logistic regression/log loss, multi-class cross-entropy/softmax loss, binary cross-entropy loss, mean-squared error loss, L1 loss, L2 loss, smooth L1 loss, and Huber loss. The disclosed AI system can use any parallelism, efficiency, and compression schemes such TFRecords, compressed encoding (e.g., PNG), sharding, parallel calls for map transformation, batching, prefetching, model parallelism, data parallelism, and synchronous/asynchronous stochastic gradient descent (SGD). The disclosed AI system can include upsampling layers, downsampling layers, recurrent connections, gates and gated memory units (like an LSTM or GRU), residual blocks, residual connections, highway connections, skip connections, peephole connections, activation functions (e.g., non-linear transformation functions like rectifying linear unit (ReLU), leaky ReLU, exponential liner unit (ELU), sigmoid and hyperbolic tangent (tanh)), batch normalization layers, regularization layers, dropout, pooling layers (e.g., max or average pooling), global average pooling layers, and attention mechanisms.

The disclosed AI system can be a linear regression model, a logistic regression model, an Elastic Net model, a support vector machine (SVM), a random forest (RF), a decision tree, and a boosted decision tree (e.g., XGBoost), or some other tree-based logic (e.g., metric trees, kd-trees, R-trees, universal B-trees, X-trees, ball trees, locality sensitive hashes, and inverted indexes). The disclosed AI system can be an ensemble of multiple models, in some implementations.

In some implementations, the disclosed AI system can be trained using backpropagation-based gradient update techniques. Example gradient descent techniques that can be used for training the disclosed AI system include stochastic gradient descent, batch gradient descent, and mini-batch gradient descent. Some examples of gradient descent optimization algorithms that can be used to train the disclosed AI system are Momentum, Nesterov accelerated gradient, Adagrad, Adadelta, RMSprop, Adam, AdaMax, Nadam, and AMSGrad.

### Transformer Logic

Machine learning is the use and development of computer systems that can learn and adapt without following explicit instructions, by using algorithms and statistical models to analyze and draw inferences from patterns in data. Some of the state-of-the-art models use Transformers, a more powerful and faster model than neural networks alone. Transformers originate from the field of natural language processing (NLP), but can be used in computer vision and many other fields. Neural networks process input in series and weight relationships by distance in the series. Transformers can process input in parallel and do not necessarily weigh by distance. For example, in natural language processing, neural networks process a sentence from beginning to end with the weights of words close to each other being higher than those further apart. This leaves the end of the sentence very disconnected from the beginning causing an effect called the vanishing gradient problem. Transformers look at each word in parallel and determine weights for the relationships to each of the other words in the sentence. These relationships are called hidden states because they are later condensed for use into one vector called the context vector. Transformers can be used in addition to neural networks. This architecture is described here.

### Encoder-Decoder Architecture

FIG. 19 is a schematic representation of an encoder-decoder architecture. This architecture is often used for NLP and has two main building blocks. The first building block is the encoder that encodes an input into a fixed-size vector. In the system we describe here, the encoder is based on a recurrent neural network (RNN). At each time step, t, a hidden state of time step, t−1, is combined with the input value at time step t to compute the hidden state at timestep t. The hidden state at the last time step, encoded in a context vector, contains relationships encoded at all previous time steps. For NLP, each step corresponds to a word. Then the context vector contains information about the grammar and the sentence structure. The context vector can be considered a low-dimensional representation of the entire input space. For NLP, the input space is a sentence, and a training set consists of many sentences.

The context vector is then passed to the second building block, the decoder. For translation, the decoder has been trained on a second language. Conditioned on the input context vector, the decoder generates an output sequence. At each time step, t, the decoder is fed the hidden state of time step, t−1, and the output generated at time step, t−1. The first hidden state in the decoder is the context vector, generated by the encoder. The context vector is used by the decoder to perform the translation.

The whole model is optimized end-to-end by using backpropagation, a method of training a neural network in which the initial system output is compared to the desired output and the system is adjusted until the difference is minimized. In backpropagation, the encoder is trained to extract the right information from the input sequence, the decoder is trained to capture the grammar and vocabulary of the output language. This results in a fluent model that uses context and generalizes well. When training an encoder-decoder model, the real output sequence is used to train the model to prevent mistakes from stacking. When testing the model, the previously predicted output value is used to predict the next one.

When performing a translation task using the encoder-decoder architecture, all information about the input sequence is forced into one vector, the context vector. Information connecting the beginning of the sentence with the end is lost, the vanishing gradient problem. Also, different parts of the input sequence are important for different parts of the output sequence, information that cannot be learned using only RNNs in an encoder-decoder architecture.

### Attention Mechanism

Attention mechanisms distinguish Transformers from other machine learning models. The attention mechanism provides a solution for the vanishing gradient problem. FIG. 20 shows an overview of an attention mechanism added onto an RNN encoder-decoder architecture. At every step, the decoder is given an attention score, e, for each encoder hidden state. In other words, the decoder is given weights for each relationship between words in a sentence. The decoder uses the attention score concatenated with the context vector during decoding. The output of the decoder at time step t is based on all encoder hidden states and the attention outputs. The attention output captures the relevant context for time step t from the original sentence. Thus, words at the end of a sentence may now have a strong relationship with words at the beginning of the sentence. In the sentence “The quick brown fox, upon arriving at the doghouse, jumped over the lazy dog,” fox and dog can be closely related despite being far apart in this complex sentence.

To weight encoder hidden states, a dot product between the decoder hidden state of the current time step, and all encoder hidden states, is calculated. This results in an attention score for every encoder hidden state. The attention scores are higher for those encoder hidden states that are similar to the decoder hidden state of the current time step. Higher values for the dot product indicate the vectors are pointing more closely in the same direction. The attention scores are converted to fractions that sum to one using the SoftMax function.

The SoftMax scores provide an attention distribution. The x-axis of the distribution is position in a sentence. The y-axis is attention weight. The scores show which encoder hidden states are most closely related. The SoftMax scores specify which encoder hidden states are the most relevant for the decoder hidden state of the current time step.

The elements of the attention distribution are used as weights to calculate a weighted sum over the different encoder hidden states. The outcome of the weighted sum is called the attention output. The attention output is used to predict the output, often in combination (concatenation) with the decoder hidden states. Thus, both information about the inputs, as well as the already generated outputs, can be used to predict the next outputs.

By making it possible to focus on specific parts of the input in every decoder step, the attention mechanism solves the vanishing gradient problem. By using attention, information flows more directly to the decoder. It does not pass through many hidden states. Interpreting the attention step can give insights into the data. Attention can be thought of as a soft alignment. The words in the input sequence with a high attention score align with the current target word. Attention describes long-range dependencies better than RNN alone. This enables analysis of longer, more complex sentences.

The attention mechanism can be generalized as: given a set of vector values and a vector query, attention is a technique to compute a weighted sum of the vector values, dependent on the vector query. The vector values are the encoder hidden states, and the vector query is the decoder hidden state at the current time step.

The weighted sum can be considered a selective summary of the information present in the vector values. The vector query determines on which of the vector values to focus. Thus, a fixed-size representation of the vector values can be created, in dependence upon the vector query.

The attention scores can be calculated by the dot product, or by weighing the different values (multiplicative attention).

### Embeddings

For most machine learning models, the input to the model needs to be numerical. The input to a translation model is a sentence, and words are not numerical. multiple methods exist for the conversion of words into numerical vectors. These numerical vectors are called the embeddings of the words. Embeddings can be used to convert any type of symbolic representation into a numerical one.

Embeddings can be created by using one-hot encoding. The one-hot vector representing the symbols has the same length as the total number of possible different symbols. Each position in the one-hot vector corresponds to a specific symbol. For example, when converting colors to a numerical vector, the length of the one-hot vector would be the total number of different colors present in the dataset. For each input, the location corresponding to the color of that value is one, whereas all the other locations are valued at zero. This works well for working with images. For NLP, this becomes problematic, because the number of words in a language is very large. This results in enormous models and the need for a lot of computational power. Furthermore, no specific information is captured with one-hot encoding. From the numerical representation, it is not clear that orange and red are more similar than orange and green. For this reason, other methods exist.

A second way of creating embeddings is by creating feature vectors. Every symbol has its specific vector representation, based on features. With colors, a vector of three elements could be used, where the elements represent the amount of yellow, red, and/or blue needed to create the color. Thus, all colors can be represented by only using a vector of three elements. Also, similar colors have similar representation vectors.

For NLP, embeddings based on context, as opposed to words, are small and can be trained. The reasoning behind this concept is that words with similar meanings occur in similar contexts. Different methods take the context of words into account. Some methods, like GloVe, base their context embedding on co-occurrence statistics from corpora (large texts) such as Wikipedia. Words with similar co-occurrence statistics have similar word embeddings. Other methods use neural networks to train the embeddings. For example, they train their embeddings to predict the word based on the context (Common Bag of Words), and/or to predict the context based on the word (Skip-Gram). Training these contextual embeddings is time intensive. For this reason, pre-trained libraries exist. Other deep learning methods can be used to create embeddings. For example, the latent space of a variational autoencoder (VAE) can be used as the embedding of the input. Another method is to use 1D convolutions to create embeddings. This causes a sparse, high-dimensional input space to be converted to a denser, low-dimensional feature space.

### Self-Attention: Queries (Q), Keys (K), Values (V)

Transformer models are based on the principle of self-attention. Self-attention allows each element of the input sequence to look at all other elements in the input sequence and search for clues that can help it to create a more meaningful encoding. It is a way to look at which other sequence elements are relevant for the current element. The Transformer can grab context from both before and after the currently processed element.

When performing self-attention, three vectors need to be created for each element of the encoder input: the query vector (Q), the key vector (K), and the value vector (V). These vectors are created by performing matrix multiplications between the input embedding vectors using three unique weight matrices.

After this, self-attention scores are calculated. When calculating self-attention scores for a given element, the dot products between the query vector of this element and the key vectors of all other input elements are calculated. To make the model mathematically more stable, these self-attention scores are divided by the root of the size of the vectors. This has the effect of reducing the importance of the scalar thus emphasizing the importance of the direction of the vector. Just as before, these scores are normalized with a SoftMax layer. This attention distribution is then used to calculate a weighted sum of the value vectors, resulting in a vector z for every input element. In the attention principle explained above, the vector to calculate attention scores and to perform the weighted sum was the same, in self-attention two different vectors are created and used. As the self-attention needs to be calculated for all elements (thus a query for every element), one formula can be created to calculate a Z matrix. The rows of this Z matrix are the z vectors for every sequence input element, giving the matrix a size length sequence dimension QKV.

Multi-headed attention is executed in the Transformer. FIG. 21 is a schematic representation of the calculation of self-attention showing one attention head. For every attention head, different weight matrices are trained to calculate Q, K, and V. Every attention head outputs a matrix Z. Different attention heads can capture different types of information. The different Z matrices of the different attention heads are concatenated. This matrix can become large when multiple attention heads are used. To reduce dimensionality, an extra weight matrix W is trained to condense the different attention heads into a matrix with the same size as one Z matrix. This way, the amount of data given to the next step does not enlarge every time self-attention is performed.

When performing self-attention, information about the order of the different elements within the sequence is lost. To address this problem, positional encodings are added to the embedding vectors. Every position has its unique positional encoding vector. These vectors follow a specific pattern, which the Transformer model can learn to recognize. This way, the model can consider distances between the different elements.

As discussed above, in the core of self-attention are three objects: queries (Q), keys (K), and values (V). Each of these objects has an inner semantic meaning of their purpose. One can think of these as analogous to databases. We have a user-defined query of what the user wants to know. Then we have the relations in the database, i.e., the values which are the weights. More advanced database management systems create some apt representation of its relations to retrieve values more efficiently from the relations. This can be achieved by using indexes, which represent information about what is stored in the database. In the context of attention, indexes can be thought of as keys. So instead of running the query against values directly, the query is first executed on the indexes to retrieve where the relevant values or weights are stored. Lastly, these weights are run against the original values to retrieve data that is most relevant to the initial query.

FIG. 22 depicts several attention heads in a Transformer block. We can see that the outputs of queries and keys dot products in different attention heads are differently colored. This depicts the capability of the multi-head attention to focus on different aspects of the input and aggregate the obtained information by multiplying the input with different attention weights.

Examples of attention calculation include scaled dot-product attention and additive attention. There are several reasons why scaled dot-product attention is used in the Transformers. Firstly, the scaled dot-product attention is relatively fast to compute, since its main parts are matrix operations that can be run on modern hardware accelerators. Secondly, it performs similarly well for smaller dimensions of the K matrix, dk, as the additive attention. For larger dk, the scaled dot-product attention performs a bit worse because dot products can cause the vanishing gradient problem. This is compensated via the scaling factor, which is defined as \sqrt{dk}.

As discussed above, the attention function takes as input three objects: key, value, and query. In the context of Transformers, these objects are matrices of shapes (n, d), where n is the number of elements in the input sequence and dis the hidden representation of each element (also called the hidden vector). Attention is then computed as:

$$Attention ( Q , K , V ) = Softmax ( \frac{Q {K}^{T}}{\sqrt{d k}} ) V$$

where Q, K, V are computed as:

X·W_{Q},X·W_{K},X·W_{V}

X is the input matrix and W_{Q}, W_{K}, W_{V} are learned weights to project the input matrix into the representations. The dot products appearing in the attention function are exploited for their geometrical interpretation where higher values of their results mean that the inputs are more similar, i.e., pointing in the geometrical space in the same direction. Since the attention function now works with matrices, the dot product becomes matrix multiplication. The SoftMax function is used to normalize the attention weights into the value of 1 prior to being multiplied by the values matrix. The resulting matrix is used either as input into another layer of attention or becomes the output of the Transformer.

### Multi-Head Attention

Transformers become even more powerful when multi-head attention is used. Queries, keys, and values are computed the same way as above, though they are now projected into h different representations of smaller dimensions using a set of h learned weights. Each representation is passed into a different scaled dot-product attention block called a head. The head then computes its output using the same procedure as described above.

Formally, the multi-head attention is defined as:

$$MultiHeadAttention ( Q , K , V ) = [ {head}_{1} , … , {head}_{h} ] {W}_{0} where {head}_{i} = Attention ( {QW}_{i}^{Q} , {KW}_{i}^{K} , {VW}_{i}^{V} )$$

The outputs of all heads are concatenated together and projected again using the learned weights matrix W₀ to match the dimensions expected by the next block of heads or the output of the Transformer. Using the multi-head attention instead of the simpler scaled dot-product attention enables Transformers to jointly attend to information from different representation subspaces at different positions.

As shown in FIG. 23, one can use multiple workers to compute the multi-head attention in parallel, as the respective heads compute their outputs independently of one another. Parallel processing is one of the advantages of Transformers over RNNs.

Assuming the naive matrix multiplication algorithm which has a complexity of:

a·b·c

For matrices of shape (a, b) and (c, d), to obtain values Q, K, V, we need to compute the operations:

X·W_{Q},X·W_{K},X·WV

The matrix X is of shape (n, d) where n is the number of patches and dis the hidden vector dimension. The weights W_{Q}, W_{K}, W_{V} are all of shape (d, d). Omitting the constant factor 3, the resulting complexity is:

n·d²

We can proceed to the estimation of the complexity of the attention function itself, i.e., of

$$Softmax ( \frac{Q {K}^{T}}{\sqrt{d k}} ) V .$$

The matrices Q and K are both of shape (n, d). The transposition operation does not influence the asymptotic complexity of computing the dot product of matrices of shapes (n, d)·(d, n), therefore its complexity is:

n²·d

Scaling by a constant factor of \sqrt{dk}, where dk is the dimension of the keys vector, as well as applying the SoftMax function, both have the complexity of a·b for a matrix of shape (a, b), hence they do not influence the asymptotic complexity. Lastly the dot product

$$Softmax ( \frac{Q {K}^{T}}{\sqrt{d k}} ) \cdot V$$

is between matrices of shapes (n, n) and (n, d) and so its complexity is:

n²·d

The final asymptotic complexity of scaled dot-product attention is obtained by summing the complexities of computing Q, K, V, and of the following attention function:

n·d²+n²·d.

The asymptotic complexity of multi-head attention is the same since the original input matrix X is projected into h matrices of shapes

$$( n , \frac{d}{h} ) ,$$

where h is the number of heads. From the point of view of asymptotic complexity, h is constant, therefore we would arrive at the same estimate of asymptotic complexity using a similar approach as for the scaled dot-product attention.

Transformer models often have the encoder-decoder architecture, although this is not necessarily the case. The encoder is built out of different encoder layers which are all constructed in the same way. The positional encodings are added to the embedding vectors. Afterward, self-attention is performed.

### Encoder Block of Transformer

FIG. 24 portrays one encoder layer of a Transformer network. Every self-attention layer is surrounded by a residual connection, summing up the output and input of the self-attention. This sum is normalized, and the normalized vectors are fed to a feed-forward layer. Every z vector is fed separately to this feed-forward layer. The feed-forward layer is wrapped in a residual connection and the outcome is normalized too. Often, numerous encoder layers are piled to form the encoder. The output of the encoder is a fixed-size vector for every element of the input sequence.

Just like the encoder, the decoder is built from different decoder layers. In the decoder, a modified version of self-attention takes place. The query vector is only compared to the keys of previous output sequence elements. The elements further in the sequence are not known yet, as they still must be predicted. No information about these output elements may be used.

### Encoder-Decoder Blocks of Transformer

FIG. 25 shows a schematic overview of a Transformer model. Next to a self-attention layer, a layer of encoder-decoder attention is present in the decoder, in which the decoder can examine the last Z vectors of the encoder, providing fluent information transmission. The ultimate decoder layer is a feed-forward layer. All layers are packed in a residual connection. This allows the decoder to examine all previously predicted outputs and all encoded input vectors to predict the next output. Thus, information from the encoder is provided to the decoder, which could improve the predictive capacity. The output vectors of the last decoder layer need to be processed to form the output of the entire system. This is done by a combination of a feed-forward layer and a SoftMax function. The output corresponding to the highest probability is the predicted output value for a subject time step.

For some tasks other than translation, only an encoder is needed. This is true for both document classification and name entity recognition. In these cases, the encoded input vectors are the input of the feed-forward layer and the SoftMax layer. Transformer models have been extensively applied in different NLP fields, such as translation, document summarization, speech recognition, and named entity recognition. These models have applications in the field of biology as well for predicting protein structure and function and labeling DNA sequences.

### Vision Transformer

There are extensive applications of transformers in vision including popular recognition tasks (e.g., image classification, object detection, action recognition, and segmentation), generative modeling, multi-modal tasks (e.g., visual-question answering, visual reasoning, and visual grounding), video processing (e.g., activity recognition, video forecasting), low-level vision (e.g., image super-resolution, image enhancement, and colorization) and 3D analysis (e.g., point cloud classification and segmentation).

Transformers were originally developed for NLP and worked with sequences of words. In image classification, we often have a single input image in which the pixels are in a sequence. To reduce the computation required, Vision Transformers (ViTs) cut the input image into a set of fixed-sized patches of pixels. The patches are often 16×16 pixels. They are treated much like words in NLP Transformers. ViTs are depicted in FIG. 26 (2605, 2610), FIG. 27 (2705, 2710, 2715, 2720). Unfortunately, important positional information is lost because image sets are position-invariant. This problem is solved by adding a learned positional encoding into the image patches.

The computations of the ViT architecture can be summarized as follows. The first layer of a ViT extracts a fixed number of patches from an input image (2705). The patches are then projected to linear embeddings. A special class token vector is added to the sequence of embedding vectors to include all representative information of all tokens through the multi-layer encoding procedure. The class vector is unique to each image. Vectors containing positional information are combined with the embeddings and the class token. The sequence of embedding vectors is passed into the Transformer blocks. The class token vector is extracted from the output of the last Transformer block and is passed into a multilayer perceptron (MLP) head whose output is the final classification. The perceptron takes the normalized input and places the output in categories. It classifies the images. This procedure directly translates into the Python Keras code shown in FIG. 28.

When the input image is split into patches, a fixed patch size is specified before instantiating a ViT. Given the quadratic complexity of attention, patch size has a large effect on the length of training and inference time. A single Transformer block comprises several layers. The first layer implements Layer Normalization, followed by the multi-head attention that is responsible for the performance of ViTs. In the depiction of a Transformer block as 2710, we can see two arrows. These are residual skip connections. Including skip connection data can simplify the output and improve the results. The output of the multi-head attention is followed again by Layer Normalization. And finally, the output layer is an MLP (Multi-Layer Perceptron) with the GELU (Gaussian Error Linear Unit) activation function.

ViTs can be pretrained and fine-tuned. Pretraining is generally done on a large dataset. Fine-tuning is done on a domain specific dataset.

Domain-specific architectures, like convolutional neural networks (CNNs) or long short-term memory networks (LSTMs), have been derived from the usual architecture of MLPs and suffer from so-called inductive biases that predispose the networks towards a certain output. ViTs stepped in the opposite direction of CNNs and LSTMs and became more general architectures by eliminating inductive biases. A ViT can be seen as a generalization of MLPs because MLPs, after being trained, do not change their weights for different inputs. On the other hand, ViTs compute their attention weights at runtime based on the particular input.

### Computer System

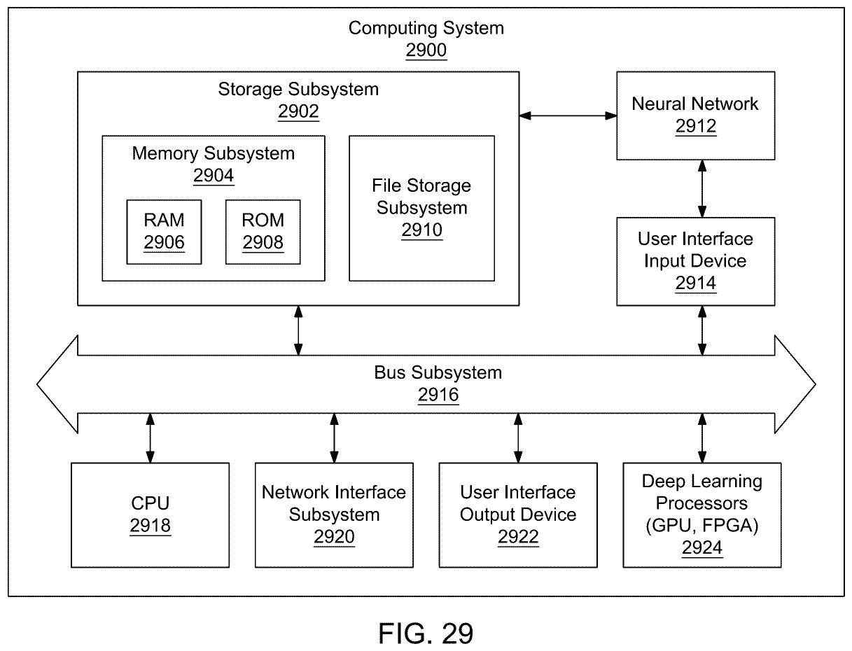

FIG. 29 shows an example computer system 2900 that can be used to implement the technology disclosed. The computer system 2900 is a representation of the system, as described in FIG. 4. The computer system 2900 includes at least one central processing unit (CPU) 2918 that communicates with a number of peripheral devices via bus subsystem 2916. These peripheral devices can include a storage subsystem 2902 including, for example, memory devices and a file storage subsystem 2910, user interface input devices 2914, user interface output devices 2922, and a network interface subsystem 2920. The input and output devices allow user interaction with computer system 2900. Network interface subsystem 2920 provides an interface to outside networks, including an interface to corresponding interface devices in other computer systems.

In one implementation, a neural network 2912 is communicably linked to the storage subsystem 2902 and the user interface input devices 2914.

User interface input devices 2914 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 2900.

User interface output devices 2922 can include a display subsystem, a printer, a fax machine, or non-visual displays such as audio output devices. The display subsystem can include an LED display, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 2900 to the user or to another machine or computer system.

Storage subsystem 2902 stores programming and data constructs that provide the functionality of some or all of the modules and methods described herein. These software modules are generally executed by deep learning processors 2924.

Deep learning processors 2924 can be graphics processing units (GPUs), field-programmable gate arrays (FPGAs), application-specific integrated circuits (ASICs), and/or coarse-grained reconfigurable architectures (CGRAs). Processors 2924 can be hosted by a deep learning cloud platform such as Google Cloud Platform™, Xilinx™, and Cirrascale™ Examples of processors 2924 include Google's Tensor Processing Unit (TPU)™, rackmount solutions like GX4 Rackmount Series™, GX6 Rackmount Series™, NVIDIA DGX-1™, Microsoft's Stratix V FPGA™, Graphcore's Intelligent Processor Unit (IPU)™, Qualcomm's Zeroth Platform™ with Snapdragon Processors™, NVIDIA's Volta™, NVIDIA's DRIVE PX™, NVIDIA's JETSON TX1/TX2 MODULE™, Intel's Nirvana™, Movidius VPU™, Fujitsu DPI™, ARM's DynamicIQ™, IBM TrueNorth™, Lambda GPU Server with Testa V100s™, and others.

Memory subsystem 2904 used in the storage subsystem 2902 can include a number of memories including a main random-access memory (RAM) 2906 for storage of instructions and data during program execution and a read only memory (ROM) 2908 in which fixed instructions are stored. A file storage subsystem 2910 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 2910 in the storage subsystem 2902, or in other machines accessible by the processor.

Bus subsystem 2916 provides a mechanism for letting the various components and subsystems of computer system 2900 communicate with each other as intended. Although bus subsystem 2916 is shown schematically as a single bus, alternative implementations of the bus subsystem can use multiple buses.

Computer system 2900 itself can be of varying types including a personal computer, a portable computer, a workstation, a computer terminal, a network computer, a television, a mainframe, a server farm, a widely distributed set of loosely networked computers, or any other data processing system or user device. Due to the ever-changing nature of computers and networks, the description of computer system 2900 depicted in FIG. 29 is intended only as a specific example for the purpose of illustrating the preferred implementations of the present technology disclosed. Many other configurations of computer system 2900 are possible having more or fewer components than the computer system depicted in FIG. 29.

In various implementations, a learning system is provided. In some implementations, a feature vector is provided to a learning system. Based on the input features, the learning system generates one or more outputs. In some implementations, the output of the learning system is a feature vector. In some implementations, the learning system comprises an SVM. In other implementations, the learning system comprises an artificial neural network. In some implementations, the learning system is pre-trained using training data. In some implementations training data is retrospective data. In some implementations, the retrospective data is stored in a data store. In some implementations, the learning system may be additionally trained through manual curation of previously generated outputs.

In some implementations, an object detection pipeline is a trained classifier. In some implementations, the trained classifier is a random decision forest. However, it will be appreciated that a variety of other classifiers are suitable for use according to the present disclosure, including linear classifiers, support vector machines (SVM), or neural networks such as recurrent neural networks (RNN).

Suitable artificial neural networks include but are not limited to a feedforward neural network, a radial basis function network, a self-organizing map, learning vector quantization, a recurrent neural network, a Hopfield network, a Boltzmann machine, an echo state network, long short term memory, a bi-directional recurrent neural network, a hierarchical recurrent neural network, a stochastic neural network, a modular neural network, an associative neural network, a deep neural network, a deep belief network, a convolutional neural networks, a convolutional deep belief network, a large memory storage and retrieval neural network, a deep Boltzmann machine, a deep stacking network, a tensor deep stacking network, a spike and slab restricted Boltzmann machine, a compound hierarchical-deep model, a deep coding network, a multilayer kernel machine, or a deep Q-network.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer system/server may be described in the general context of computer system-executable instructions, such as program modules, being executed by a computer system. Generally, program modules may include routines, programs, objects, components, logic, data structures, and so on that perform particular tasks or implement particular abstract data types. Computer system/server may be practiced in distributed computing environments where tasks are performed by remote processing devices that are linked through a communications network. In a distributed computing environment, program modules may be located in both local and remote computer system storage media including memory storage devices.

As shown in FIG. 29, computer system/server in computing node is shown in the form of a general-purpose computing device. The components of computer system/server may include, but are not limited to, one or more processors or processing units, a system memory, and a bus that couples various system components including system memory to processor.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server typically includes a variety of computer system readable media. Such media may be any available media that is accessible by computer system/server, and it includes both volatile and non-volatile media, removable and non-removable media.

System memory can include computer system readable media in the form of volatile memory, such as random access memory (RAM) and/or cache memory. Algorithm Computer system/server may further include other removable/non-removable, volatile/non-volatile computer system storage media. By way of example only, storage system can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, memory may include at least one program product having a set (e.g., at least one) of program modules that are configured to carry out the functions of embodiments of the disclosure.

Program/utility, having a set (at least one) of program modules, may be stored in memory by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of embodiments as described herein.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

The following detailed description is made with reference to the figures. Example implementations are described to illustrate the technology disclosed, not to limit its scope, which is defined by the claims. Those of ordinary skill in the art will recognize a variety of equivalent variations on the description that follows. Reference will now be made in detail to the exemplary implementations of the present disclosure, examples of which are illustrated in the accompanying drawings. Wherever possible, the same reference numbers will be used throughout the drawings to refer to the same or like parts.

The following discussion is presented to enable any person skilled in the art to make and use the technology disclosed and is provided in the context of a particular application and its requirements. Various modifications to the disclosed implementations will be readily apparent to those skilled in the art, and the general principles defined herein may be applied to other implementations and applications without departing from the spirit and scope of the technology disclosed. Thus, the technology disclosed is not intended to be limited to the implementations shown but is to be accorded the widest scope consistent with the principles and features disclosed herein.

The systems, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these devices, systems, or methods unless specifically designated as mandatory.

Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

The detailed description of various implementations will be better understood when read in conjunction with the appended drawings. To the extent that the figures illustrate diagrams of the functional blocks of the various implementations, the functional blocks are not necessarily indicative of the division between hardware circuitry. Thus, for example, one or more of the functional blocks (e.g., modules, processors, or memories) may be implemented in a single piece of hardware (e.g., a general-purpose signal processor or a block of random-access memory, hard disk, or the like) or multiple pieces of hardware. Similarly, the programs may be stand-alone programs, may be incorporated as subroutines in an operating system, may be functions in an installed software package, and the like. It should be understood that the various implementations are not limited to the arrangements and instrumentality shown in the drawings.

The processing engines and databases of the figures, designated as modules, can be implemented in hardware or software, and need not be divided up in precisely the same blocks as shown in the figures. Some of the modules can also be implemented on different processors, computers, or servers, or spread among a number of different processors, computers, or servers. In addition, it will be appreciated that some of the modules can be combined, operated in parallel or in a different sequence than that shown in the figures without affecting the functions achieved. The modules in the figures can also be thought of as flowchart steps in a method. A module also need not necessarily have all its code disposed contiguously in memory; some parts of the code can be separated from other parts of the code with code from other modules or other functions disposed in between.

The technology disclosed can be practiced as a system, method, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

One or more implementations and clauses of the technology disclosed, or elements thereof can be implemented in the form of a computer product, including a non-transitory computer readable storage medium with computer usable program code for performing the method steps indicated. Furthermore, one or more implementations and clauses of the technology disclosed, or elements thereof can be implemented in the form of an apparatus including a memory and at least one processor that is coupled to the memory and operative to perform exemplary method steps. Yet further, in another aspect, one or more implementations and clauses of the technology disclosed or elements thereof can be implemented in the form of means for carrying out one or more of the method steps described herein; the means can include (i) hardware module(s), (ii) software module(s) executing on one or more hardware processors, or (iii) a combination of hardware and software modules; any of (i)-(iii) implement the specific techniques set forth herein, and the software modules are stored in a computer readable storage medium (or multiple such media).

The clauses described in this section can be combined as features. In the interest of conciseness, the combinations of features are not individually enumerated and are not repeated with each base set of features. The reader will understand how features identified in the clauses described in this section can readily be combined with sets of base features identified as implementations in other sections of this application. These clauses are not meant to be mutually exclusive, exhaustive, or restrictive; and the technology disclosed is not limited to these clauses but rather encompasses all possible combinations, modifications, and variations within the scope of the claimed technology and its equivalents.

Other implementations of the clauses described in this section can include a non-transitory computer readable storage medium storing instructions executable by a processor to perform any of the clauses described in this section. Yet another implementation of the clauses described in this section can include a system including memory and one or more processors operable to execute instructions, stored in the memory, to perform any of the clauses described in this section.

### CLAUSES

1. A computer-implemented method for capturing interaction traces of an artificial intelligence (AI) agent during execution of an automated task on a graphical user interface of a software application, the method comprising:
   capturing an observational record of interactions performed by the AI agent with the graphical user interface;
   generating, concurrently with the capturing of the observational record, a log of an internal decision-making process of the AI agent corresponding to the interactions; and
   associating the observational record and the log with an initiating event that initiated the execution.
2. The method of clause 1, wherein the capturing and the generating are temporally aligned at a segment level, each segment of the observational record corresponding to a segment of the log produced during a same portion of the execution.
3. The method of clause 1, wherein the log comprises, for a plurality of the interactions, a semantic interpretation generated by the AI agent of a user interface element involved in each interaction of the plurality, and a decision criterion applied by the AI agent to select the interaction from among alternative interactions available at the graphical user interface.
4. The method of clause 1, wherein the associating comprises generating a record that links the observational record and the log to the initiating event by a reference identifier, the reference identifier enabling retrieval of the observational record and the log from the initiating event.
5. The method of clause 1, wherein the capturing of the observational record comprises capturing from a rendered graphical output of the software application presented for interaction through the graphical user interface.
6. The method of clause 3, wherein the log further comprises, for the plurality of the interactions, a verification outcome indicating whether an action executed by the AI agent for the interaction produced a predicted interface state, and a fallback action evaluated by the AI agent in response to the verification outcome indicating that the action produced an interface state different from the predicted interface state.
7. The method of clause 1, wherein the generating of the log comprises recording, for each action performed by the AI agent, an output of a vision-language reasoning architecture of the AI agent, the vision-language reasoning architecture comprising a visual perception module configured to detect and classify, using computer vision, user interface elements rendered on the graphical user interface, a semantic interpretation module configured to generate, using a language model, textual interpretations of the detected user interface elements and associated labels, and an action selection module configured to determine the action based on outputs of the visual perception module and the semantic interpretation module.
8. The method of clause 7, wherein the semantic interpretation module generates, for each detected user interface element, a semantic interpretation record comprising a primary natural language description of an identity and a function of the detected user interface element, a classification confidence level for the primary natural language description, and at least one alternative interpretation of the detected user interface element together with a selection criterion under which the primary natural language description is selected from among the at least one alternative interpretation.
9. The method of clause 7, further comprising recording, in the log, a verification step performed by the AI agent following an action executed by the AI agent, the verification step comprising a predicted post-action interface state for the action, an actual post-action interface state detected by the visual perception module following the action, a determination of whether the actual post-action interface state matches the predicted post-action interface state, and, upon a determination that the actual post-action interface state and the predicted post-action interface state differ, a corrective action initiated by the AI agent.
10. The method of clause 1, further comprising storing the observational record and the log in a tamper-resistant logging repository as an immutable session record, the session record comprising metadata including a task identifier identifying the execution, a timestamp identifying initiation and completion of the execution, a target application identifier identifying the software application, a summary of actions performed by the AI agent, and an audit status of the execution.
11. The method of clause 1, wherein the initiating event comprises at least one of a security signal generated by a security monitoring system upon detection of a non-compliant configuration state or a policy anomaly in the software application, a policy-based instruction generated by a governance or compliance platform, the policy-based instruction specifying a corrective action, and an application-level automation event specifying a workflow step or a configuration change.
12. The method of clause 1, further comprising classifying the execution as a successful execution or a failed execution based on whether the AI agent achieved an intended outcome of the execution as determined from the observational record and the log, and providing the observational record and the log to a model training pipeline as labeled training samples for supervised fine-tuning of a machine learning model of the AI agent.
13. A system for capturing interaction traces of an artificial intelligence (AI) agent during execution of an automated task on a graphical user interface of a software application, the system comprising one or more processors and a memory storing instructions that, when executed by the one or more processors, cause the one or more processors to:
   capture an observational record of interactions performed by the AI agent with the graphical user interface;
   generate, concurrently with the capture of the observational record, a log of an internal decision-making process of the AI agent corresponding to the interactions; and
   associate the observational record and the log with an initiating event that initiated the execution.
14. The system of clause 13, wherein the capture and the generation are temporally aligned at a segment level, each segment of the observational record corresponding to a segment of the log produced during a same portion of the execution.
15. The system of clause 13, wherein the log comprises, for a plurality of the interactions, a semantic interpretation generated by the AI agent of a user interface element involved in each interaction of the plurality, and a decision criterion applied by the AI agent to select the interaction from among alternative interactions available at the graphical user interface.
16 The system of clause 13, wherein the instructions, when executed by the one or more processors, further cause the one or more processors to store the observational record and the log in a tamper-resistant logging repository as an immutable session record, the session record comprising metadata including a task identifier identifying the execution, a timestamp identifying initiation and completion of the execution, a target application identifier identifying the software application, a summary of actions performed by the AI agent, and an audit status of the execution.
17. The system of clause 13, wherein the generation of the log comprises recording, for each action performed by the AI agent, an output of a vision-language reasoning architecture of the AI agent, the vision-language reasoning architecture comprising a visual perception module configured to detect and classify, using computer vision, user interface elements rendered on the graphical user interface, a semantic interpretation module configured to generate, using a language model, textual interpretations of the detected user interface elements and associated labels, and an action selection module configured to determine the action based on outputs of the visual perception module and the semantic interpretation module.
18. The system of clause 13, wherein the initiating event comprises at least one of a security signal generated by a security monitoring system upon detection of a non-compliant configuration state or a policy anomaly in the software application, a policy-based instruction generated by a governance or compliance platform, the policy-based instruction specifying a corrective action, and an application-level automation event specifying a workflow step or a configuration change.
19. The system of clause 13, wherein the instructions, when executed by the one or more processors, further cause the one or more processors to classify the execution as a successful execution or a failed execution based on whether the AI agent achieved an intended outcome of the execution as determined from the observational record and the log, and to provide the observational record and the log to a model training pipeline as labeled training samples for supervised fine-tuning of a machine learning model of the AI agent.
20. A non-transitory computer-readable medium storing instructions that, when executed by one or more processors, cause the one or more processors to perform operations comprising:
   capturing an observational record of interactions performed by an artificial intelligence (AI) agent with a graphical user interface of a software application during execution of an automated task;
   generating, concurrently with the capturing of the observational record, a log of an internal decision-making process of the AI agent corresponding to the interactions; and
   associating the observational record and the log with an initiating event that initiated the execution.
21. A computer-implemented method for capturing interaction traces of an artificial intelligence (AI) agent during execution of an automated task on a graphical user interface of a software application, the method comprising:
   capturing, from a rendered graphical output of the software application presented for interaction through the graphical user interface, an observational record of interactions performed by the AI agent with the graphical user interface;
   generating, concurrently with the capturing of the observational record, a log of an internal decision-making process of the AI agent corresponding to the interactions, the capturing and the generating being temporally aligned at a segment level, each segment of the observational record corresponding to a segment of the log produced during a same portion of the execution, and the log comprising, for a plurality of the interactions, a semantic interpretation generated by the AI agent of a user interface element involved in each interaction of the plurality, and a decision criterion applied by the AI agent to select the interaction from among alternative interactions available at the graphical user interface; and
   associating the observational record and the log with an initiating event that initiated the execution, the associating comprising generating a record that links the observational record and the log to the initiating event by a reference identifier, the reference identifier enabling retrieval of the observational record and the log from the initiating event.
22. The method of clause 21, wherein the log further comprises, for the plurality of the interactions, a verification outcome indicating whether an action executed by the AI agent for the interaction produced a predicted interface state, and a fallback action evaluated by the AI agent in response to the verification outcome indicating that the action produced an interface state different from the predicted interface state.
23. The method of clause 21, wherein the capturing of the observational record continues across a change in the graphical user interface occurring during the execution, the change comprising at least one of a repositioning of an interface control, an update of a visual styling, a renaming of an element label, a dynamic loading of an interface section, and a rendering update produced by an application state transition.
24. The method of clause 21, further comprising storing the observational record and the log in a tamper-resistant logging repository as an immutable session record, the session record comprising metadata including a task identifier identifying the execution, a timestamp identifying initiation and completion of the execution, a target application identifier identifying the software application, a summary of actions performed by the AI agent, and an audit status of the execution.
25. The method of clause 21, wherein the generating of the log comprises recording, for each action performed by the AI agent, an output of a vision-language reasoning architecture of the AI agent, the vision-language reasoning architecture comprising a visual perception module configured to detect and classify, using computer vision, user interface elements rendered on the graphical user interface, a semantic interpretation module configured to generate, using a language model, textual interpretations of the detected user interface elements and associated labels, and an action selection module configured to determine the action based on outputs of the visual perception module and the semantic interpretation module.
26. The method of clause 25, wherein the semantic interpretation module generates, for each detected user interface element, a semantic interpretation record comprising a primary natural language description of an identity and a function of the detected user interface element, a classification confidence level for the primary natural language description, and at least one alternative interpretation of the detected user interface element together with a selection criterion under which the primary natural language description is selected from among the at least one alternative interpretation.
27. The method of clause 25, further comprising recording, in the log, a verification step performed by the AI agent following an action executed by the AI agent, the verification step comprising a predicted post-action interface state for the action, an actual post-action interface state detected by the visual perception module following the action, a determination of whether the actual post-action interface state matches the predicted post-action interface state, and, upon a determination that the actual post-action interface state and the predicted post-action interface state differ, a corrective action initiated by the AI agent.
28. The method of clause 21, wherein the capturing of the observational record comprises recording a rendered pixel output of the graphical user interface as the rendered pixel output is displayed on a display device, the observational record being derived from the rendered pixel output.
29. The method of clause 21, wherein the initiating event comprises at least one of a security signal generated by a security monitoring system upon detection of a non-compliant configuration state or a policy anomaly in the software application, a policy-based instruction generated by a governance or compliance platform, the policy-based instruction specifying a corrective action, and an application-level automation event specifying a workflow step or a configuration change.
30. The method of clause 21, wherein the record that links the observational record and the log to the initiating event comprises a session record, the session record comprising a task identifier identifying the execution, an originating system identifier identifying a system that generated the initiating event, a trigger classification identifying a type of the initiating event, a session initiation timestamp and a session completion timestamp, and a storage reference linking the task identifier to the observational record and to the log.
31. The method of clause 21, further comprising classifying the execution as a successful execution or a failed execution based on whether the AI agent achieved an intended outcome of the execution as determined from the observational record and the log, and providing the observational record and the log to a model training pipeline as labeled training samples for supervised fine-tuning of a machine learning model of the AI agent.
32. The method of clause 21, further comprising, in response to a request from an authorized entity, retrieving the observational record and the log, and presenting the retrieved observational record and the retrieved log to the authorized entity for compliance verification.
33. A system for capturing interaction traces of an artificial intelligence (AI) agent during execution of an automated task on a graphical user interface of a software application, the system comprising one or more processors and a memory storing instructions that, when executed by the one or more processors, cause the one or more processors to:
   capture, from a rendered graphical output of the software application presented for interaction through the graphical user interface, an observational record of interactions performed by the AI agent with the graphical user interface;
   generate, concurrently with the capture of the observational record, a log of an internal decision-making process of the AI agent corresponding to the interactions, the capture and the generation being temporally aligned at a segment level, each segment of the observational record corresponding to a segment of the log produced during a same portion of the execution, and the log comprising, for a plurality of the interactions, a semantic interpretation generated by the AI agent of a user interface element involved in each interaction of the plurality, and a decision criterion applied by the AI agent to select the interaction from among alternative interactions available at the graphical user interface; and
   associate the observational record and the log with an initiating event that initiated the execution, the association comprising generating a record that links the observational record and the log to the initiating event by a reference identifier, the reference identifier enabling retrieval of the observational record and the log from the initiating event.
34. The system of clause 33, wherein the log further comprises, for the plurality of the interactions, a verification outcome indicating whether an action executed by the AI agent for the interaction produced a predicted interface state, and a fallback action evaluated by the AI agent in response to the verification outcome indicating that the action produced an interface state different from the predicted interface state.
35. The system of clause 33, wherein the instructions, when executed by the one or more processors, further cause the one or more processors to store the observational record and the log in a tamper-resistant logging repository as an immutable session record, the session record comprising metadata including a task identifier identifying the execution, a timestamp identifying initiation and completion of the execution, a target application identifier identifying the software application, a summary of actions performed by the AI agent, and an audit status of the execution.
36. The system of clause 33, wherein the generation of the log comprises recording, for each action performed by the AI agent, an output of a vision-language reasoning architecture of the AI agent, the vision-language reasoning architecture comprising a visual perception module configured to detect and classify, using computer vision, user interface elements rendered on the graphical user interface, a semantic interpretation module configured to generate, using a language model, textual interpretations of the detected user interface elements and associated labels, and an action selection module configured to determine the action based on outputs of the visual perception module and the semantic interpretation module.
37. The system of clause 33, wherein the initiating event comprises at least one of a security signal generated by a security monitoring system upon detection of a non-compliant configuration state or a policy anomaly in the software application, a policy-based instruction generated by a governance or compliance platform, the policy-based instruction specifying a corrective action, and an application-level automation event specifying a workflow step or a configuration change.
38. The system of clause 33, wherein the instructions, when executed by the one or more processors, further cause the one or more processors to classify the execution as a successful execution or a failed execution based on whether the AI agent achieved an intended outcome of the execution as determined from the observational record and the log, and to provide the observational record and the log to a model training pipeline as labeled training samples for supervised fine-tuning of a machine learning model of the AI agent.
39. The system of clause 33, wherein the instructions, when executed by the one or more processors, further cause the one or more processors to, in response to a request from an authorized entity, retrieve the observational record and the log, and present the retrieved observational record and the retrieved log to the authorized entity for compliance verification.
40. A non-transitory computer-readable medium storing instructions that, when executed by one or more processors, cause the one or more processors to perform operations comprising:
   capturing, from a rendered graphical output of a software application presented for interaction through a graphical user interface of the software application, an observational record of interactions performed by an artificial intelligence (AI) agent with the graphical user interface during execution of an automated task;
   generating, concurrently with the capturing of the observational record, a log of an internal decision-making process of the AI agent corresponding to the interactions, the capturing and the generating being temporally aligned at a segment level, each segment of the observational record corresponding to a segment of the log produced during a same portion of the execution, and the log comprising, for a plurality of the interactions, a semantic interpretation generated by the AI agent of a user interface element involved in each interaction of the plurality, and a decision criterion applied by the AI agent to select the interaction from among alternative interactions available at the graphical user interface; and
   associating the observational record and the log with an initiating event that initiated the execution, the associating comprising generating a record that links the observational record and the log to the initiating event by a reference identifier, the reference identifier enabling retrieval of the observational record and the log from the initiating event.
41. A computer-implemented method for capturing interaction traces of an artificial intelligence (AI) agent during execution of an automated task on a graphical user interface of a software application, the method comprising:
   capturing, from a rendered graphical output of the software application presented for interaction through the graphical user interface, an observational record of interactions performed by the AI agent with the graphical user interface;
   generating, concurrently with the capturing of the observational record, a log of an internal decision-making process of the AI agent corresponding to the interactions, the capturing and the generating being temporally aligned at a segment level, each segment of the observational record corresponding to a segment of the log produced during a same portion of the execution, the log being produced by a vision-language reasoning architecture of the AI agent, the vision-language reasoning architecture comprising a visual perception module configured to detect and classify, using computer vision, user interface elements rendered on the graphical user interface, a semantic interpretation module configured to generate, using a language model, textual interpretations of the detected user interface elements and associated labels, and an action selection module configured to determine each action to be executed by the AI agent based on outputs of the visual perception module and the semantic interpretation module, and the log comprising, for a plurality of the interactions, a semantic interpretation generated by the semantic interpretation module of a user interface element involved in each interaction of the plurality, a decision criterion applied by the action selection module to select the interaction from among alternative interactions available at the graphical user interface, and a verification outcome indicating whether an action executed by the AI agent for the interaction produced a predicted interface state;
   associating the observational record and the log with an initiating event that initiated the execution, the associating comprising generating a session record that links the observational record and the log to the initiating event by a reference identifier, the reference identifier enabling retrieval of the observational record and the log from the initiating event, and the session record comprising metadata including a task identifier identifying the execution, a timestamp identifying initiation and completion of the execution, a target application identifier identifying the software application, a summary of actions performed by the AI agent, and an audit status of the execution; and
   storing the session record as an immutable record in a tamper-resistant logging repository.
42. The method of clause 41, wherein the log further comprises, for the plurality of the interactions, a fallback action evaluated by the AI agent in response to the verification outcome indicating that the action produced an interface state different from the predicted interface state, the fallback action being recorded in temporal alignment with a corresponding segment of the observational record.
43. The method of clause 41, wherein the visual perception module comprises a Vision Transformer model or a deep convolutional neural network configured to process screen images captured during the execution as sequences of image patches and to identify and classify the user interface elements, the user interface elements comprising at least one of a text input field, a toggle control, a dropdown menu, a navigation button, a configuration panel, a form submission control, and a modal dialog box.
44. The method of clause 41, wherein the semantic interpretation generated by the semantic interpretation module further comprises a primary natural language description of an identity and a function of the user interface element, a classification confidence level for the primary natural language description, and at least one alternative interpretation of the user interface element together with a selection criterion under which the primary natural language description is selected from among the at least one alternative interpretation.
45. The method of clause 41, wherein the verification outcome comprises a predicted post-action interface state for the action, an actual post-action interface state detected by the visual perception module following the action, a determination of whether the actual post-action interface state matches the predicted post-action interface state, and, upon a determination that the actual post-action interface state and the predicted post-action interface state differ, a corrective action initiated by the AI agent.
46. The method of clause 41, wherein the capturing of the observational record from the rendered graphical output comprises recording a rendered pixel output of the graphical user interface as the rendered pixel output is displayed on a display device, the observational record being derived from the rendered pixel output.
47. The method of clause 41, wherein the initiating event comprises at least one of a security signal generated by a security monitoring system upon detection of a non-compliant configuration state or a policy anomaly in the software application, a policy-based instruction generated by a governance or compliance platform, the policy-based instruction specifying a corrective action, and an application-level automation event specifying a workflow step or a configuration change.
48. The method of clause 41, wherein the metadata of the session record further comprises an originating system identifier identifying a system that generated the initiating event, and a trigger classification identifying a type of the initiating event, and the task identifier serves as a storage reference linking the observational record and the log to the initiating event, the observational record and the log being retrievable by querying the task identifier.
49. The method of clause 41, further comprising, for an execution of the automated task that spans a plurality of sequential agent sessions across a plurality of software applications, associating the observational records and the logs from the plurality of sequential agent sessions with the initiating event, and maintaining a causal chain that links the initiating event to each observational record and to each log of the plurality of sequential agent sessions.
50. The method of clause 41, further comprising classifying the execution as a successful execution or a failed execution based on whether the AI agent achieved an intended outcome of the execution as determined from the observational record and the log, and providing the observational record and the log to a model training pipeline as labeled training samples for supervised fine-tuning of a machine learning model of the AI agent.
51. The method of clause 50, wherein, for an execution classified as a failed execution, the log is analyzed to identify a reasoning step at which a semantic interpretation by the AI agent of a user interface element diverged from a correct semantic interpretation of the user interface element, and a training annotation is generated specifying the user interface element, the semantic interpretation by the AI agent, the correct semantic interpretation, and a corrective training signal for fine-tuning the machine learning model of the AI agent.
52. The method of clause 41, further comprising, in response to a request from an authorized entity, presenting the observational record and the log in a synchronized replay format in which the observational record is displayed as a time-indexed video replay of the execution and a textual annotation derived from the log is displayed in temporal alignment with a corresponding interface state in the observational record.
53. A system for capturing interaction traces of an artificial intelligence (AI) agent during execution of an automated task on a graphical user interface of a software application, the system comprising one or more processors and a memory storing instructions that, when executed by the one or more processors, cause the one or more processors to:
   capture, from a rendered graphical output of the software application presented for interaction through the graphical user interface, an observational record of interactions performed by the AI agent with the graphical user interface;
   generate, concurrently with the capture of the observational record, a log of an internal decision-making process of the AI agent corresponding to the interactions, the capture and the generation being temporally aligned at a segment level, each segment of the observational record corresponding to a segment of the log produced during a same portion of the execution, the log being produced by a vision-language reasoning architecture of the AI agent, the vision-language reasoning architecture comprising a visual perception module configured to detect and classify, using computer vision, user interface elements rendered on the graphical user interface, a semantic interpretation module configured to generate, using a language model, textual interpretations of the detected user interface elements and associated labels, and an action selection module configured to determine each action to be executed by the AI agent based on outputs of the visual perception module and the semantic interpretation module, and the log comprising, for a plurality of the interactions, a semantic interpretation generated by the semantic interpretation module of a user interface element involved in each interaction of the plurality, a decision criterion applied by the action selection module to select the interaction from among alternative interactions available at the graphical user interface, and a verification outcome indicating whether an action executed by the AI agent for the interaction produced a predicted interface state;
   associate the observational record and the log with an initiating event that initiated the execution, the association comprising generating a session record that links the observational record and the log to the initiating event by a reference identifier, the reference identifier enabling retrieval of the observational record and the log from the initiating event, and the session record comprising metadata including a task identifier identifying the execution, a timestamp identifying initiation and completion of the execution, a target application identifier identifying the software application, a summary of actions performed by the AI agent, and an audit status of the execution; and store the session record as an immutable record in a tamper-resistant logging repository.
54. The system of clause 53, wherein the visual perception module comprises a Vision Transformer model or a deep convolutional neural network configured to process screen images captured during the execution as sequences of image patches and to identify and classify the user interface elements, the user interface elements comprising at least one of a text input field, a toggle control, a dropdown menu, a navigation button, a configuration panel, a form submission control, and a modal dialog box.
55. The system of clause 53, wherein the semantic interpretation generated by the semantic interpretation module further comprises a primary natural language description of an identity and a function of the user interface element, a classification confidence level for the primary natural language description, and at least one alternative interpretation of the user interface element together with a selection criterion under which the primary natural language description is selected from among the at least one alternative interpretation.
56. The system of clause 53, wherein the capture of the observational record from the rendered graphical output comprises recording a rendered pixel output of the graphical user interface as the rendered pixel output is displayed on a display device, the observational record being derived from the rendered pixel output.
57. The system of clause 53, wherein the initiating event comprises at least one of a security signal generated by a security monitoring system upon detection of a non-compliant configuration state or a policy anomaly in the software application, a policy-based instruction generated by a governance or compliance platform, the policy-based instruction specifying a corrective action, and an application-level automation event specifying a workflow step or a configuration change.
58. The system of clause 53, wherein the instructions, when executed by the one or more processors, further cause the one or more processors to classify the execution as a successful execution or a failed execution based on whether the AI agent achieved an intended outcome of the execution as determined from the observational record and the log, and to provide the observational record and the log to a model training pipeline as labeled training samples for supervised fine-tuning of a machine learning model of the AI agent.
59. The system of clause 53, wherein the instructions, when executed by the one or more processors, further cause the one or more processors to, in response to a request from an authorized entity, present the observational record and the log in a synchronized replay format in which the observational record is displayed as a time-indexed video replay of the execution and a textual annotation derived from the log is displayed in temporal alignment with a corresponding interface state in the observational record.
60. A non-transitory computer-readable medium storing instructions that, when executed by one or more processors, cause the one or more processors to perform operations comprising:
   capturing, from a rendered graphical output of a software application presented for interaction through a graphical user interface of the software application, an observational record of interactions performed by an artificial intelligence (AI) agent with the graphical user interface during execution of an automated task;
   generating, concurrently with the capturing of the observational record, a log of an internal decision-making process of the AI agent corresponding to the interactions, the capturing and the generating being temporally aligned at a segment level, each segment of the observational record corresponding to a segment of the log produced during a same portion of the execution, the log being produced by a vision-language reasoning architecture of the AI agent, the vision-language reasoning architecture comprising a visual perception module configured to detect and classify, using computer vision, user interface elements rendered on the graphical user interface, a semantic interpretation module configured to generate, using a language model, textual interpretations of the detected user interface elements and associated labels, and an action selection module configured to determine each action to be executed by the AI agent based on outputs of the visual perception module and the semantic interpretation module, and the log comprising, for a plurality of the interactions, a semantic interpretation generated by the semantic interpretation module of a user interface element involved in each interaction of the plurality, a decision criterion applied by the action selection module to select the interaction from among alternative interactions available at the graphical user interface, and a verification outcome indicating whether an action executed by the AI agent for the interaction produced a predicted interface state;
   associating the observational record and the log with an initiating event that initiated the execution, the associating comprising generating a session record that links the observational record and the log to the initiating event by a reference identifier, the reference identifier enabling retrieval of the observational record and the log from the initiating event, and the session record comprising metadata including a task identifier identifying the execution, a timestamp identifying initiation and completion of the execution, a target application identifier identifying the software application, a summary of actions performed by the AI agent, and an audit status of the execution; and storing the session record as an immutable record in a tamper-resistant logging repository.
   The above-described hardware description is a non-limiting example of corresponding structure for performing the functionality described herein.

Numerous modifications and variations of the present disclosure are possible in light of the above teachings. It is therefore to be understood that the invention may be practiced otherwise than as specifically described herein.

1. A computer-implemented method for capturing interaction traces of an artificial intelligence (AI) agent during execution of an automated task on a graphical user interface of a software application, the method comprising:
capturing, from a rendered graphical output of the graphical user interface as the rendered graphical output is displayed on a display device, an observational record of interactions performed by the AI agent with the graphical user interface;
generating, concurrently with the capturing of the observational record, a log of an internal decision-making process of the AI agent corresponding to the interactions, the capturing and the generating being temporally aligned at a segment level, each segment of the observational record corresponding to a segment of the log produced during a same portion of the execution, the log comprising, for a plurality of the interactions, a semantic interpretation generated by the AI agent of a graphical user interface element involved in the interaction, a decision criterion applied by the AI agent to select the interaction from among alternative interactions available at the graphical user interface, and a verification outcome indicating whether an action executed by the AI agent for the interaction produced a predicted interface state; and
associating the observational record and the log with an initiating event that initiated the execution, the associating comprising tagging the observational record and the log with a task identifier identifying the execution, an initiation timestamp identifying initiation of the execution, and an originating system identifier identifying a system that generated the initiating event.

2. The method of claim 1, wherein the semantic interpretation generated by the AI agent for the graphical user interface element comprises a primary natural language description of an identity and a function of the graphical user interface element, a classification confidence level for the primary natural language description, and at least one alternative interpretation of the graphical user interface element together with a selection criterion under which the primary natural language description is selected from among the at least one alternative interpretation.

3. The method of claim 1, wherein the associating further comprises generating a session record that links the observational record and the log to the initiating event by the task identifier, the task identifier serving as a storage reference, the observational record and the log being retrievable by querying the task identifier.

4. The method of claim 1, wherein the log further comprises, for the plurality of the interactions, a fallback action evaluated by the AI agent in response to the verification outcome indicating that the action produced an interface state different from the predicted interface state.

5. The method of claim 1, wherein the capturing of the observational record continues across a change in the graphical user interface occurring during the execution, the change comprising at least one of a repositioning of an interface control, an update of a visual styling, a renaming of an element label, a dynamic loading of an interface section, and a rendering update produced by an application state transition.

6. The method of claim 1, further comprising storing the observational record and the log in a tamper-resistant logging repository as an immutable session record, the session record comprising metadata including the task identifier, the initiation timestamp, a completion timestamp identifying completion of the execution, a target application identifier identifying the software application, a summary of actions performed by the AI agent, and an audit status of the execution.

7. The method of claim 1, wherein the generating of the log comprises recording, for each action performed by the AI agent, an output of a vision-language reasoning architecture of the AI agent, the vision-language reasoning architecture comprising a visual perception module configured to detect and classify, using computer vision, graphical user interface elements rendered on the graphical user interface, a semantic interpretation module configured to generate, using a language model, textual interpretations of the detected graphical user interface elements and associated labels, and an action selection module configured to determine the action based on outputs of the visual perception module and the semantic interpretation module.

8. The method of claim 7, wherein the semantic interpretation module generates, for each detected graphical user interface element, the semantic interpretation, the classification confidence level, and the at least one alternative interpretation.

9. The method of claim 7, further comprising recording, in the log, a verification step performed by the AI agent following an action executed by the AI agent, the verification step comprising a predicted post-action interface state for the action, an actual post-action interface state detected by the visual perception module following the action, a determination of whether the actual post-action interface state matches the predicted post-action interface state, and, upon a determination that the actual post-action interface state and the predicted post-action interface state differ, a corrective action initiated by the AI agent.

10. The method of claim 1, wherein the initiating event comprises at least one of a security signal generated by a security monitoring system upon detection of a non-compliant configuration state or a policy anomaly in the software application, a policy-based instruction generated by a governance or compliance platform, the policy-based instruction specifying a corrective action, and an application-level automation event specifying a workflow step or a configuration change.

11. The method of claim 1, further comprising generating, from the observational record and the log, a composite audit artifact in which entries of the log structurally index segments of the observational record according to a temporal correspondence between the segments of the observational record and the entries of the log, the composite audit artifact providing, in response to a selection of an entry of the log by an authorized entity, a retrieval and a display of a segment of the observational record captured during a same portion of the execution as the selected entry of the log, and providing, in response to a navigation to a position within the observational record by the authorized entity, a retrieval and a display of one or more entries of the log produced during a same portion of the execution as the position within the observational record.

12. The method of claim 6, wherein the tamper-resistant logging repository comprises an integrity verification module that generates, for each segment pair comprising a segment of the observational record and a segment of the log produced during a same portion of the execution, a cryptographic hash value over combined contents of the segment pair, the cryptographic hash value being stored as part of the session record, the cryptographic hash value being recalculable from stored contents of the segment pair, a recalculated cryptographic hash value matching the stored cryptographic hash value indicating consistency of the stored contents with contents of the segment pair at a time of capture.

13. The method of claim 12, wherein the cryptographic hash value for each segment pair incorporates a cryptographic hash value of a preceding segment pair within the execution, producing a cryptographic chain across a temporal sequence of segment pairs of the execution.

14. The method of claim 1, wherein the capturing of the observational record continues across a pause period of the AI agent, the pause period comprising an initiation of the pause period by the AI agent upon a determination that an interaction on the graphical user interface is to be performed by a human operator, an interaction performed by the human operator on the graphical user interface during the pause period, and a termination of the pause period by the AI agent upon detection of an interface state change resulting from the interaction performed by the human operator, and wherein the log records, for the pause period, a semantic interpretation, by the AI agent, of an interface element corresponding to the initiation of the pause period, a decision criterion applied by the AI agent for the initiation of the pause period, and a resumption entry corresponding to the termination of the pause period.

15. A system for capturing interaction traces of an artificial intelligence (AI) agent during execution of an automated task on a graphical user interface of a software application, the system comprising one or more processors and a memory storing instructions that, when executed by the one or more processors, cause the one or more processors to:
capture, from a rendered graphical output of the graphical user interface as the rendered graphical output is displayed on a display device, an observational record of interactions performed by the AI agent with the graphical user interface;
generate, concurrently with the capture of the observational record, a log of an internal decision-making process of the AI agent corresponding to the interactions, the capture and the generation being temporally aligned at a segment level, each segment of the observational record corresponding to a segment of the log produced during a same portion of the execution, the log comprising, for a plurality of the interactions, a semantic interpretation generated by the AI agent of a graphical user interface element involved in the interaction, a decision criterion applied by the AI agent to select the interaction from among alternative interactions available at the graphical user interface, and a verification outcome indicating whether an action executed by the AI agent for the interaction produced a predicted interface state; and
associate the observational record and the log with an initiating event that initiated the execution, the association comprising tagging the observational record and the log with a task identifier identifying the execution, an initiation timestamp identifying initiation of the execution, and an originating system identifier identifying a system that generated the initiating event.

16. The system of claim 15, wherein the instructions, when executed by the one or more processors, further cause the one or more processors to store the observational record and the log in a tamper-resistant logging repository as an immutable session record, the session record comprising metadata including the task identifier, the initiation timestamp, a completion timestamp identifying completion of the execution, a target application identifier identifying the software application, a summary of actions performed by the AI agent, and an audit status of the execution.

17. The system of claim 15, wherein the instructions, when executed by the one or more processors, further cause the one or more processors to generate, from the observational record and the log, a composite audit artifact in which entries of the log structurally index segments of the observational record according to a temporal correspondence between the segments of the observational record and the entries of the log, the composite audit artifact providing, in response to a selection of an entry of the log by an authorized entity, a retrieval and a display of a segment of the observational record captured during a same portion of the execution as the selected entry of the log, and providing, in response to a navigation to a position within the observational record by the authorized entity, a retrieval and a display of one or more entries of the log produced during a same portion of the execution as the position within the observational record.

18. The system of claim 16, wherein the tamper-resistant logging repository comprises an integrity verification module that generates, for each segment pair comprising a segment of the observational record and a segment of the log produced during a same portion of the execution, a cryptographic hash value over combined contents of the segment pair, the cryptographic hash value being stored as part of the session record, and wherein the cryptographic hash value for each segment pair incorporates a cryptographic hash value of a preceding segment pair within the execution, producing a cryptographic chain across a temporal sequence of segment pairs of the execution.

19. The system of claim 15, wherein the capture of the observational record continues across a pause period of the AI agent, the pause period comprising an initiation of the pause period by the AI agent upon a determination that an interaction on the graphical user interface is to be performed by a human operator, an interaction performed by the human operator on the graphical user interface during the pause period, and a termination of the pause period by the AI agent upon detection of an interface state change resulting from the interaction performed by the human operator, and wherein the log records, for the pause period, a semantic interpretation, by the AI agent, of an interface element corresponding to the initiation of the pause period, a decision criterion applied by the AI agent for the initiation of the pause period, and a resumption entry corresponding to the termination of the pause period.

20. A non-transitory computer-readable medium storing instructions that, when executed by one or more processors, cause the one or more processors to perform operations comprising:
capturing, from a rendered graphical output of a graphical user interface of a software application as the rendered graphical output is displayed on a display device, an observational record of interactions performed by an artificial intelligence (AI) agent with the graphical user interface during execution of an automated task;
generating, concurrently with the capturing of the observational record, a log of an internal decision-making process of the AI agent corresponding to the interactions, the capturing and the generating being temporally aligned at a segment level, each segment of the observational record corresponding to a segment of the log produced during a same portion of the execution, the log comprising, for a plurality of the interactions, a semantic interpretation generated by the AI agent of a graphical user interface element involved in the interaction, a decision criterion applied by the AI agent to select the interaction from among alternative interactions available at the graphical user interface, and a verification outcome indicating whether an action executed by the AI agent for the interaction produced a predicted interface state; and
associating the observational record and the log with an initiating event that initiated the execution, the associating comprising tagging the observational record and the log with a task identifier identifying the execution, an initiation timestamp identifying initiation of the execution, and an originating system identifier identifying a system that generated the initiating event.
